(19) United States
(12) Patent Application Publication
(10) Pub. No.: US 2025/0242211 A1
(43) Pub. Date: Jul. 31, 2025

(54) METHODS AND SYSTEMS FOR MAKING GOLF EQUIPMENT

(71) Applicant: Cobra Golf Incorporated, Carlsbad, CA (US)

(72) Inventors: Jake T. Steinorth, San Diego, CA (US); Ryan L. Roach, Encinitas, CA (US)

(21) Appl. No.: 19/087,122

(22) Filed: Mar. 21, 2025

Related U.S. Application Data
(63) Continuation of application No. 18/139,294, filed on Apr. 25, 2023.
(60) Provisional application No. 63/441,550, filed on Jan. 27, 2023.

(51) Int. Cl. A63B 53/04; B33Y 50/00; B33Y 80/00; G06Q 30/0601

(52) U.S. Cl. CPC A63B 53/04; G06Q 30/0621; B33Y 50/00; B33Y 80/00

(57) ABSTRACT

A method for producing a golf club component includes the step of receiving a selection of at least one parameter from a user via a user interface, the at least one parameter being selected from a plurality of parameters. The method further includes the step of generating a design model of the golf club component based on the selected parameter, providing the design model of the golf club component to an additive manufacturing device, and forming the golf club component via the additive manufacturing device.

### CROSS REFERENCE TO RELATED APPLICATIONS

The present application is a continuation-in-part of U.S. application Ser. No. 18/139,294, filed on Apr. 25, 2023, which is herein incorporated by reference in its entirety. U.S. application Ser. No. 18/139,294 claims the benefit of and priority to U.S. Provisional Application No. 63/441,550, filed on Jan. 27, 2023, which is herein incorporated by reference in its entirety.

### REFERENCE REGARDING FEDERALLY SPONSORED RESEARCH OR DEVELOPMENT

Not applicable.

### SEQUENCE LISTING

Not applicable.

### BACKGROUND

### 1. Field of the Disclosure

The present disclosure relates to golf clubs, and more specifically to methods and systems for sales and production of golf clubs and golf club components.

### 2. Description of the Background

The object of the game of golf is to hit a golf ball into a golf hole using one or more golf clubs. In a typical golf competition, a golfer who completes one or more golf holes in the fewest number of golf ball hits, shots, or strokes wins over other competing golfers. The distance between a golfer's golf ball and a golf hole, weather conditions, terrain features, and a myriad of other situational factors may influence the golfer's determination of which golf club to use for a given hit of the golf ball. Given the variety of hitting situations, golfers often bring multiple types of clubs to play golf. As such, there exists a need to create improved golf clubs and other golf technology which enhance a golfer's ability to hit a golf ball in one or more hitting situations.

Golf clubs are formed through a variety of methods and include a golf club head, a golf club shaft coupled to the golf club head, and a grip arranged on the shaft. Commonly, a golf club head is forged or cast, and then machined or ground and polished to the requisite dimensions and desired aesthetic quality. The head is coupled with the golf club shaft, typically constructed from graphite or steel. Shafts are typically constructed from graphite or steel as a tapered cylindrical tube cut to a standard length with the grip on one end and an interface for the club head on the other. In order to reduce manufacturing costs to meet user price points, manufacturers commonly utilize a limited number of molds to produce most of their club heads. However, the utilized molds are not readily adjustable with respect to the particular characteristics of the golf club, or the player that will use them.

This conventional manufacturing process of golf club heads presents a problem due to the fact that not all golfers are built the same, and not all golfers have identical swings. Because of variations in golf swings, body size, and frequency of play, many golfers would benefit from an optimization of various club design parameters, including those associated with the golf club head. However, altering the manufacturing process to produce individualized clubs can dramatically increase the price of the clubs, so most golfers simply settle for “off the shelf” clubs. Additionally, obtaining individualized golf clubs often involves meeting with a fitter or other professional who is aware of the club options, and can help the golfer match their needs with particular components. Further, having a professional fitter alter stock clubs for individualized performance variations can present substantial increases in cost and can yield variations in quality, durability, and duration of service.

As such, there is a need for methods and systems of selling and providing golf clubs or components thereof that allow individualized design variations while maintaining efficiency and cost effectiveness. Ultimately, the incorporation of individual design variations into golf clubs may improve a golfer's performance with their golf clubs.

In addition to individual design variations, a golf club or the components thereof can be manufactured out of one or more materials that improve the performance characteristics of the golf club. As such, there remains an additional need to provide an optimized material which can be incorporated into a golf club to improve the club's characteristics and potentially lower a golfer's performance.

### SUMMARY

In accordance with some embodiments of the disclosed subject matter, systems, methods, and processes for providing golf club equipment are provided.

In some aspects, a method for producing a golf club component includes receiving a selection of at least one parameter from a user via a user interface. The at least one parameter is selected from a plurality of parameters. The method further includes generating a design model of the golf club component based on the selected parameter, providing the design model of the golf club component to an additive manufacturing device, and forming the golf club component via the additive manufacturing device.

In some aspects, a method for producing a golf club component includes outputting golf club options to a user via a user interface, receiving a selection of one or more of the golf club options from the user, and generating a design model of a golf club component based on the selection. The method can further include updating the design model of the golf club component based on performance data of the user, providing the updated design model of the golf club component to an additive manufacturing machine, and forming the golf club component via the additive manufacturing machine.

In some aspects, a system for producing golf club components includes a processor and a computer-readable storage medium containing instructions. The instructions contained within the computer-readable storage can, when executed by the processor, cause the system to: receive information from a user, compare the information to a database correlating information and golf club options, output golf club options to the user, receive golf club selections, and generate golf club design models based on golf club selections. The instructions can, when executed by the processor, cause the system further to: mint non-fungible tokens to a blockchain ledger that are associated with virtual objects and metadata, including golf club component design models, and output golf club component design models associated with non-fungible tokens.

In some aspects, a non-transitory computer-readable medium storing instructions for an additive manufacturing machine can, when executed by the additive manufacturing machine, cause the additive manufacturing machine to form a golf club head of a golf club. The golf club head can include a body and a lattice structure formed in an interior void of the body such that the lattice structure is entirely enclosed within the body.

In some aspects, a golf club component includes a first material, wherein the first material is a titanium alloy comprising titanium and one or more additional elements selected from the group consisting of molybdenum, vanadium, zirconium, niobium, aluminum, and combinations thereof.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 depicts a rear view of a golf club head in accordance with some embodiments of the present disclosure;

FIG. 2 is a top plan view of the golf club head of FIG. 1;

FIG. 3 is a side, cut-away view of the golf club head of FIG. 1;

FIG. 4 is a rear, cut-away view of the golf club head of FIG. 1;

FIG. 5 depicts a rear view of another golf club head in accordance with some embodiments of the present disclosure;

FIG. 6 is a rear view of the golf club head of FIG. 5 with a medallion partially removed;

FIG. 7 is a cross-sectional view taken along line 7-7 of FIG. 5;

FIG. 8 is a front view of the golf club head of FIG. 5 with a face member removed;

FIG. 9 depicts a rear view of an alternative embodiment of the golf club head of FIG. 6;

FIG. 10 is a rear view of the golf club head of FIG. 9 with a medallion partially removed;

FIG. 11 depicts a rear, cut-away view of another golf club head in accordance with some embodiments of the present disclosure;

FIG. 12 is a top plan view of the golf club head of FIG. 11;

FIG. 13 is a cross-sectional view taken along line 13-13 of FIG. 11;

FIG. 14 depicts a flowchart for an example method of providing a golf club component in accordance with some embodiments of the present disclosure;

FIG. 15 depicts an example of a flowchart for another method of providing a golf club component in accordance with some embodiments of the present disclosure;

FIG. 16 depicts a flowchart for yet another method of providing a golf club component in accordance with some embodiments of the present disclosure;

FIG. 17 depicts a flowchart for still another method of providing a golf club component in accordance with some embodiments of the present disclosure;

FIG. 18 depicts a schematic representation of a system for providing a golf club component in accordance with some embodiments of the present disclosure;

FIG. 19 depicts an example user display of the system to FIG. 18;

FIG. 20 depicts a flowchart for an example process of providing a golf club component in accordance with some embodiments of the present disclosure;

FIG. 21 depicts a schematic representation of another example system for providing a golf club component in accordance with some embodiments of the present disclosure;

FIG. 22 depicts a flowchart for another example method for providing a golf club component using the system of FIG. 21;

FIG. 23 depicts a perspective view of an embodiment of a tooling component for a golf club component;

FIG. 24 depicts a flowchart for an example process of forming a tooling component used for producing a physical component;

FIG. 25 depicts a schematic representation of an additive manufacturing system;

FIG. 26 depicts a schematic representation of a smart tag and a housing;

FIG. 27 depicts a diagram of an example manufacturing system for use with the smart tag of FIG. 26; and

FIG. 28 depicts a flowchart for an example investment casting process;

FIG. 29A depicts a first portion of a flowchart for an example process of formulating and testing a golf club or component thereof where a material is formulated and tested; and

FIG. 29B depicts a second portion of the flowchart of FIG. 29A where the material is modeled or manufactured into a golf club or component thereof, tested, and analyzed.

### DETAILED DESCRIPTION

The present disclosure is directed to methods and systems for selecting and fabricating individualized golf club equipment, golf clubs, or golf club components, such as, e.g., a golf club head, a golf club shaft, or components thereof. Using an interface, such as a website or smart phone application, a user can input information, such as his or her preferences or swing attributes, to a system. Alternatively or in addition, data can be gathered during a club fitting process with the user and can be provided to the system. The system can then design a golf club component based on the received information or data that is customized or optimized to the specific user. In some implementations, the user may be able to select one or more characteristics of the golf club component design produced by the system and the system can update the golf club component design accordingly.

As used herein, unless otherwise specified or limited, the term “about,” with respect to a reference value, refer to variations from the reference value of ±5% or less, inclusive of the endpoints of the range. Similarly, the term “substantially equal” as used herein with respect to a reference value refers to variations from the reference value of less than ±10% inclusive. Where specified, “substantially” can indicate a variation in one numerical direction relative to a reference value. For example, “substantially less” than a reference value indicates a value that is reduced from the reference value by 10% or more, and “substantially more” than a reference value indicates a value that is increased from the reference value by 10% or more.

Unless otherwise expressly specified, all numerical ranges, amounts, values and percentages, such as those for amounts of materials, moments of inertia, product of inertia values, center of gravity locations, loft and draft angles, and others in the following portion of the specification, may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Also as used herein, unless otherwise limited or defined, “substantially parallel” indicates a direction that is within ±5 degrees of a reference direction (e.g., within ±3 degrees), inclusive. For a path that is not linear, the path can be considered to be substantially parallel to a reference direction if a straight line between end-points of the path is substantially parallel to the reference direction or a mean derivative of the path within a common reference frame as the reference direction is substantially parallel to the reference direction. Likewise, unless otherwise limited or defined, “substantially perpendicular” as used herein indicates a direction that is within ±5 degrees of perpendicular a reference direction (e.g., within ±3 degrees), inclusive. For a path that is not linear, the path can be considered to be substantially perpendicular to a reference direction if a straight line between end-points of the path is substantially perpendicular to the reference direction or a mean derivative of the path within a common reference frame as the reference direction is substantially perpendicular to the reference direction.

Unless otherwise limited or defined, “integral” and derivatives thereof (e.g., “integrally”) as used herein describe elements that are manufactured as a single (i.e., monolithic) piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is integrally formed element. In contrast, an element formed from multiple pieces that are separately formed initially then later connected together, is not an integrally formed element.

Further, as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions or features may be used to discuss aspects of a particular example or figure, but do not necessarily require similar orientation or geometry in all installations or configurations.

Aspects of the present disclosure provide systems and methods for selecting and fabricating customized golf equipment utilizing additive manufacturing to form custom components of equipment at a reduced cost compared to traditional manufacturing processes, e.g., casting or forging processes requiring substantial tooling, of similar customized equipment or components thereof, thus allowing a larger population of golfers to benefit from individualized golf club components. In particular, systems and methods disclosed herein can allow a user, e.g., a golfer, to select various characteristics of a golf club head that may provide advantageous structural benefits to the user's particular swing and/or aesthetic attributes that appeal to the user. In some embodiments, the characteristics of the golf club head can be optimized based on data or the user's characteristics and/or the user's swing of a stock golf club at a testing facility.

Some portions of a golf club are easily modified for custom clubs. For example, shafts can be cut to just about any length by using simple tools, such as a hacksaw, or specialty tools such as a radial arm saw. Golf club grips also come in a wide variety of sizes, colors, and textures, allowing for easy personalization. In contrast, fabricating certain components, e.g., the club head, require specialty tools beyond the capabilities of most professional fitters. For example, cast golf club heads require an ability to prepare and manipulate molten metal. Furthermore, producing cast club heads with the precision demanded by high-end golfers requires expensive manufacturing equipment (e.g., molds) and highly-trained workers. For this reason, most custom clubs are based on a selection of more widely available heads provided by a handful of facilities producing golf club heads; however, even for custom fitted golf clubs, there are still one or more specifications of the golf clubs, especially the golf club heads, that are immutable through conventional custom club processes.

Aspects of the present disclosure involve forming or otherwise fabricating a customized golf club or golf club component (such as, e.g., a golf club head of a golf club) via an additive manufacturing technique or process, such as three-dimensional (3D) printing. For example, an additive manufacturing machine can receive a design file of a golf club component, such as a golf club head, that has been designed based on a user's inputs and can form the golf club component with one or more materials. To that end, a number of additive manufacturing processes may be implemented (such as, e.g., vat photopolymerization, material jetting, binder jetting, multi jet fusion, powder bed fusion, material extrusion, directed energy deposition, sheet lamination, selective laser melting, direct metal laser melting, electron beam melting, or sintering) to form one or more sub-components or structures of a golf club component of a number of materials, including metals (such as, e.g., aluminum, copper, iron, lead, or titanium), metal alloys (such as, e.g., steel, stainless steel, bronze, brass, tungsten, cobalt, aluminum alloys, titanium alloys, and chromium alloys), ceramics (such as, e.g., zirconia, alumina, or tricalcium phosphate), polymers (such as, e.g., acrylonitrile butadiene styrene (ABS), polylactic acid (PLA), polycarbonate (PC), polypropylene (PP), polyethylene terephthalate (PET), polyaryletherketones (PAEK), or polyetherimides (PEI)), or polymer composites (such as, e.g., carbon fiber or Kevlar). Further, one or more additive manufacturing processes may be implemented to form sub-components or structures of the golf club component having one or more properties (such as, e.g., color, surface finish, translucency, density, elasticity, hardness, or crystalline structure arrangement) that may differ from other portions of the golf club component or the golf club.

Example golf club and golf club head structures in accordance with this disclosure may relate to “iron-type” and “driver-type” golf clubs and golf club heads. However, this disclosure is not limited to such golf club types and the concepts of the present disclosure may be applied to any type of golf club or golf club head structure, including putters, hybrids, and the like. Further, example golf club and golf club head structures may relate to “wood-type” golf clubs and golf club heads, e.g., clubs and golf club heads typically used for drivers and fairway woods, as well as for “wood-type” utility or hybrid clubs, or the like. Although these golf club head structures may have little or no actual “wood” material, they still may be referred to conventionally in the art as “woods,” (e.g., “metal woods” or “fairway woods”).

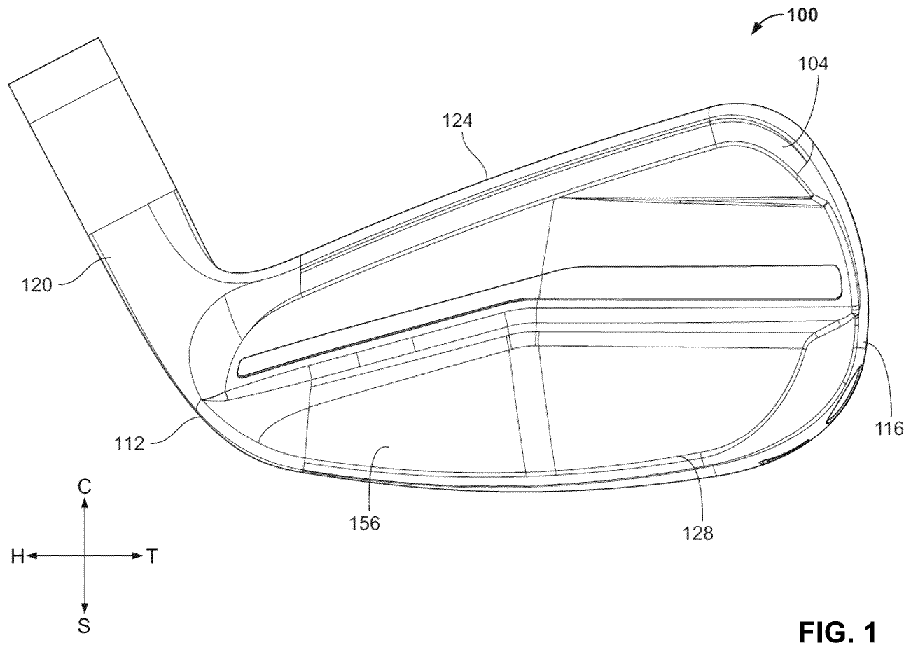

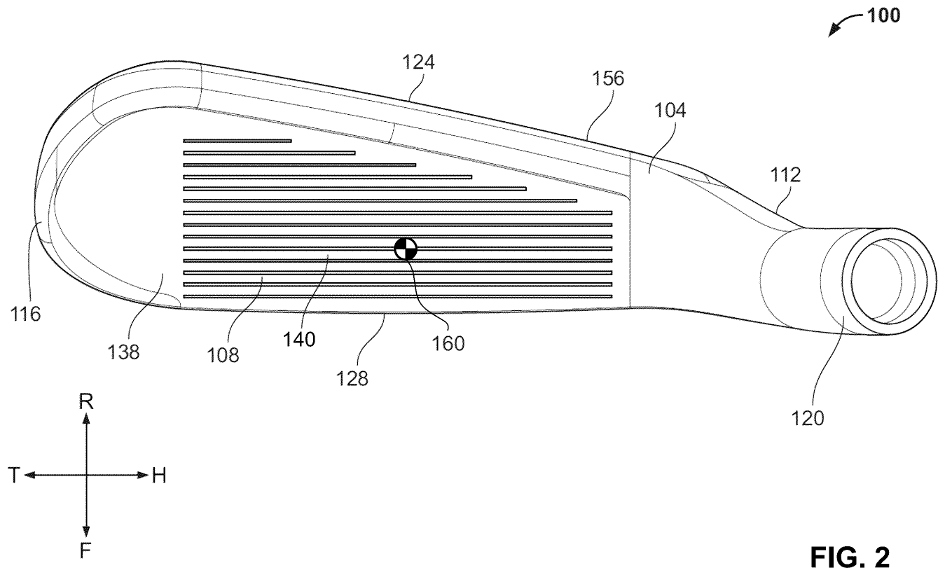

Turning now to FIG. 1, an embodiment of a golf club head 100 that may be custom manufactured and/or modified in accordance with the systems and methods described herein in shown. In the illustrated embodiment of FIG. 1, the golf club head 100 includes a body 104 and a face member or face insert 108 (see FIG. 2) extending between a heel end 112 and a toe end 116. A hosel 120 extends from the heel end 112 of the golf club head 100. In some embodiments, the hosel 120 is an adjustable hosel, such that the loft and lie angles may be adjusted by a user, among other configurations. The body 104 of the golf club head 100 includes a topline 124 that is opposite a sole 128. In some embodiments, the body 104 is a unitary component, such that the topline 124 and the sole 128 are integrally formed. In some embodiments, the body 104 is a multi-piece structure, such that the topline 124 and the sole 128 are separable and distinct components of the golf club head 100 which require assembly. Further, the face member 108 may be integrally formed with the body 104, or the face member 108 may be a separable and distinct component requiring assembly with the body 104 to form the golf club head 100. It will be appreciated that although the golf club head 100 resembles an-type golf club head, aspects of the golf club head 100 described herein, and the usage of the golf club head 100 with the methods and systems described herein, shall not be limited to such iron-type golf club heads. It is contemplated that the golf club head 100 may be a driver-type golf club head, a hybrid-type golf club head, a putter-type golf club head, or the like.

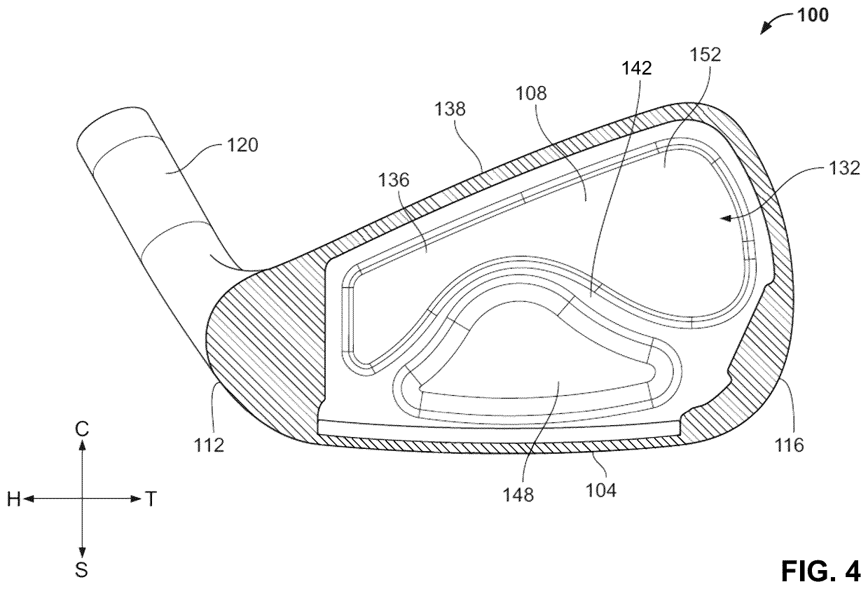

It will be appreciated that FIG. 4 is a rear, cut-away view of the golf club head 100 that includes an interior volume or internal void 132, such that the golf club head 100 is hollow. The internal void 132 may be defined by the face member 108 and the body 104, such that assembly or integral formation thereof encloses the internal void 132. In some embodiments, the internal void 132 is defined entirely by the body 104, or the face member 108 may define internal voids 132 therein. For illustrative purposes, a coordinate system is depicted in FIGS. 1-4 as including opposing heel H and toe T directions, opposing topline C and sole S directions, and opposing front F and rear R directions. For purposes of clarity, the topline and sole directions C, S may be referred to in combination as the topline-sole (C-S) direction or vertical direction, the heel and toc directions H, T may be referred to in combination as the heel-toe (H-T) direction or lateral direction, and the front and rear directions F, R may be referred to in combination as the front-rear (F-R) direction or longitudinal direction.

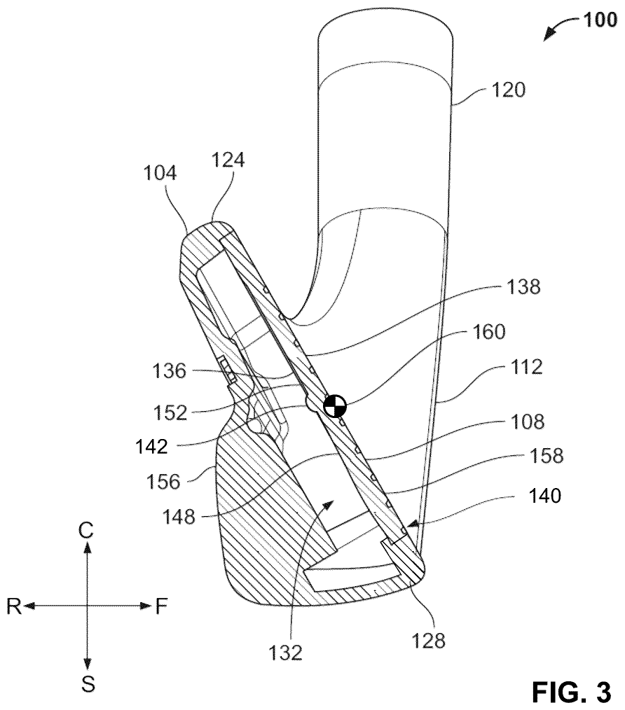

Referring still to FIG. 4, the face member 108 of the golf club head 100 includes a rear surface 136 that is opposite a front surface 138 (see FIG. 3), which is indicated by a dashed portion of the lead line extending around the golf club head 100. The front surface 138 at least partially defines the striking face that impacts a golf ball (not shown) during use and includes a plurality of grooves 140 (see FIGS. 2 and 3). In the illustrated embodiment, the rear surface 136 is configured to face the internal void 132 and includes a raised portion 142 and a plurality of recessed portions 148, 152. It will be appreciated that the raised portion 142 extends rearwardly along the front-rear direction, toward a rear side 156 (see FIG. 3) of the golf club head 100, which is opposite a front side 158 of the golf club head 100 where the face member 108 is positioned. In some embodiments, the raised portions 142 increase a thickness, i.e., a dimension measured in the front-rear direction, of the face member 108 relative to the front surface 138. Further, the recessed portions 148, 152 may decrease the thickness of the face member 108 relative to the front surface 138.

Using the systems and methods described herein, users may be offered the ability to customize the face member 108, such as by locating, arranging, sizing, and shaping the raised portion 142 and/or the recessed portions 148, 152 of the face member 108 of the golf club head 100. For instance, users may desire increased thickness in areas of the face member 108 corresponding with a custom impact point or location 160 (i.e., “sweet spot;” see FIG. 2), or other customized performance properties, i.e., coefficient of restitution, center of gravity location, moment of inertia, ball spin correction, among others. The impact point 160 may be determined through use of a fitting system to generate fit data, i.e., measured data associated with a particular user's golf swing and performance tendencies.

Fit data may include various body metrics by detecting the position and/or movement of a pelvis, ribcage, spine, arms, wrists, hands, shoulders, neck, head, eyes, legs, or feet. Further, the body metrics may include bend or frontal bend, body lines, joint angles, kinematic sequence, lateral tilt, lead arm, lift, side bend, sway, thrust, turn, or X-factor. Further, fit data may include ball data, such as, e.g., backspin, ball speed, carry, curve, descent or landing angle, flight time, launch angle, offline, peak height, roll distance, shot dispersion, side carry, side angle, side spin or spin axis, total distance, or total spin. Fit data may also include club data, such as, e.g., address lie, address loft, angle of attack, closure rate, club acceleration profile, club head speed, club path, club speed profile, dynamic lie, dynamic loft, efficiency, face angle relative to target, face center loft, face difference, face to path, grip roll, grip speed, horizontal swing plane, impact location, lie difference, loft difference, low point, path deflection, path deflection droop, path deflection ratio, ratio to grip, shaft kick, shaft lean address, shaft lean difference, shaft lean impact, spin loft, static lic, static loft, swing direction, swing plane, torque, or vertical swing plane. Fit data associated with putting, in particular, may include attack angle, backspin, backswing time, ball speed, break, closure rate, club path, club speed, distance, dynamic lie, effective stim, elevation, entry speed distance, face angle, face to path, face twist, forward swing time, horizontal launch direction, launch direction, roll percentage, roll speed, revolutions per minute (RPM), shaft angle, side spin, simp, skid distance, slope or rise percentage, impact ratio, speed drop, spin tilt, stroke length, surface interaction, temp, time to full roll, total spin, or vertical bounce. It will be appreciated that the fit data values may be average values, maximum values, minimum values, mode values, or other statistically significant values. In some instances, users may desire reduced thickness in areas of the face member 108 surrounding the impact point 160, such as near the heel end 112 and/or the toe end 116, to provide such customized performance properties, e.g., reducing weight near the toe end 116 to prevent opening the face during impact or to improve flexibility of the face member 108. Various fitting systems and launch monitors may be used to collect fit data, such as, e.g., TrackMan®, GCQuad®, FlightScope®, SkyTrak®, TopTracer®, GCHawk®, Quintic Ball Roll®, or the like.

In some embodiments, the Fit Data may be gathered by a sensor (not shown) that is attached to the golf club head 100, whether directly or indirectly. For example, a sensor may be coupled to a shaft (not shown) that is attached to the golf club head 100 for detecting information about a user's performance. Example sensors include Arccos® Smart Sensors, which may maintain a user performance profile based on data collected from usage over time. In some embodiments, users may customize the face member 108 to provide decreased thickness in areas corresponding with the impact point 160 to provide a trampoline effect, while the surrounding areas of the face member 108 are stiffened or reinforced with increased thickness to reduce or mitigate vibration. Accordingly, users can produce such customized face members 108 with the raised portion 142 and the recessed portions 148, 152 using the systems and methods described herein.

In some embodiments, the raised portions 142 may be provided in the form of ribs or ridges or beams or posts extending from and/or along the rear surface 136 of the face member 108. Further, the recessed portions 148, 152 may be formed along the rear surface 136 between or beneath the raised portion 142 formed as ribs. Further, the face member 108 may include a hollow interior between the front surface (not shown) and the rear surface 136 in which a lattice structure or stiffening members, e.g., ribs and ridges, may be formed.

Referring to FIGS. 1-4, various components of the example golf club head 100, including one or more sub-components or structures of the golf club head 100 (such as, e.g., the body 104 or the face member 108), may be formed through one or more of the additive manufacturing processes and of one or more of the materials described herein. Accordingly, one or more additive manufacturing processes may be implemented to form sub-components or structures of the golf club head 100 having one or more properties that may differ from other portions of the golf club head 100. For example, in some cases, the golf club head 100 as shown in FIGS. 1-4, including the body 104 and the face member 108, can be integrally formed as a single unitary piece via one or more additive manufacturing processes. In some examples, the body 104 may be formed via a conventional manufacturing process (e.g., forging or casting) while the face member 108 may be formed via one or more additive manufacturing processes, or vice versa, and later coupled with the body 104 to form the golf club head 100. In other examples, at least the face member 108 of the golf club head 100 may be integrally formed via a first manufacturing process, such as, e.g., an additive manufacturing process, among others, which is separate from and later coupled with the body 104 that is formed via a second manufacturing process, such as, e.g., an additive manufacturing process, among others, which may differ in one or more aspects from the first manufacturing process. In some examples, one or more portions, e.g., the face member 108, of the golf club head 100 may be formed with a first material and other portions, e.g., the body 104, may be formed with a second material having one or more properties that differ from the first material.

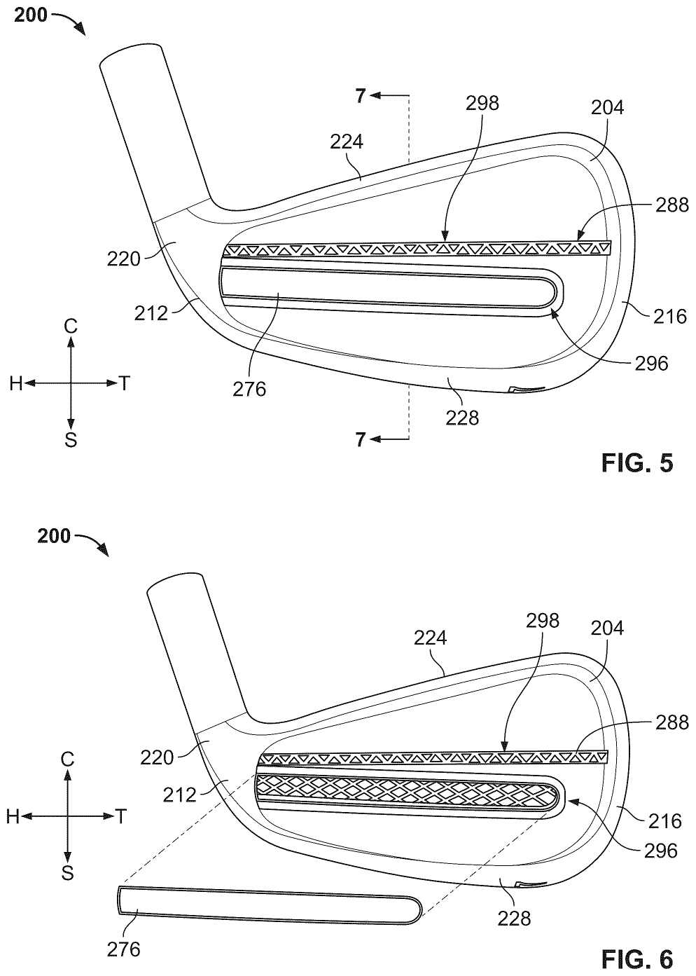

It is contemplated that a golf club head can be further customizable by a user when one or more portions of the golf club head are formed via an additive manufacturing process. In that regard, FIGS. 5-8 illustrate another embodiment of a golf club head 200 that may be custom manufactured and/or modified utilizing the systems and methods described herein. The golf club head 200 is generally similar to the golf club head 100 of FIGS. 1-4, and includes similar numbering for similar features. For illustrative purposes, a coordinate system of the C-S, H-T and F-R directions is depicted in FIGS. 5-8 that is similar to the coordinate system of FIGS. 1-4.

Referring specifically to FIG. 5, the golf club head 200 includes a body 204 and a face member or face insert 208 (see FIG. 7) extending between a heel end 212 and a toe end 216. A hosel 220 extends from the heel end 212 of the golf club head 200. In some embodiments, the hosel 220 is an adjustable hosel, such that the loft and lie angles may be adjusted among combinations thereof or independently of one another, among other configurations, by the user. The body 204 of the golf club head 200 includes a topline 224 that is opposite a sole 228. In some embodiments, the body 204 is a unitary component, such that the topline 224 and the sole 228 are integrally formed. In some embodiments, the body 204 is a multi-piece structure, such that the topline 224 and the sole 228 are separable and distinct components of the golf club head 200 which require assembly. Further, the face member 208 may be integrally formed with the body 204, or the face member 208 may be a separable and distinct component requiring assembly with the body 204 to form the golf club head 200. It will be appreciated that although the golf club head 200 resembles an iron-type golf club head, aspects of the golf club head 200 described herein, and the usage of the golf club head 200 with the methods and systems described herein, shall not be limited to such iron-type golf club heads. It is contemplated that the golf club head 200 may be a driver-type golf club head, a hybrid-type golf club head, a putter-type golf club head, or the like.

FIG. 7 depicts a cross-sectional view of the golf club head 200 taken along line 7-7 of FIG. 5. The golf club head 200 includes an interior volume or internal void 232, such that the golf club head 200 is hollow. The internal void 232 may be defined by the face member 208 and the body 204, such that assembly or integral formation thereof encloses the internal void 232. In some embodiments, the internal void 232 is defined entirely by the body 204, or the face member 208 may define internal voids 232 therein.

With continued reference to FIG. 7, the face member 208 is positioned along a front side 258 of the golf club head 200 opposite a rear side 256. The face member 208 has a face rear surface 236 that is opposite a face front surface 238. The face rear surface 236 faces inwardly toward the internal void 232. The face front surface 238 at least partially defines the striking face of the club head 200 that impacts a golf ball (not shown) during use and includes a plurality of grooves 240. In some embodiments, the face rear surface 236 can include one or more raised portions 242 and one or more recessed portions 248, 252 similar to the face member 108 of the golf club head 100 of FIGS. 1-4. In such embodiments, the raised portions 242 can extend rearwardly along the F-R direction toward the rear side 256 of the golf club head 200. In some embodiments, the raised portions 242 can increase a thickness, i.e., a dimension measured in the F-R direction, of the face member 208 relative to the face front surface 238. Further, the recessed portions 248, 252 may decrease the thickness of the face member 208 relative to the face front surface 238.

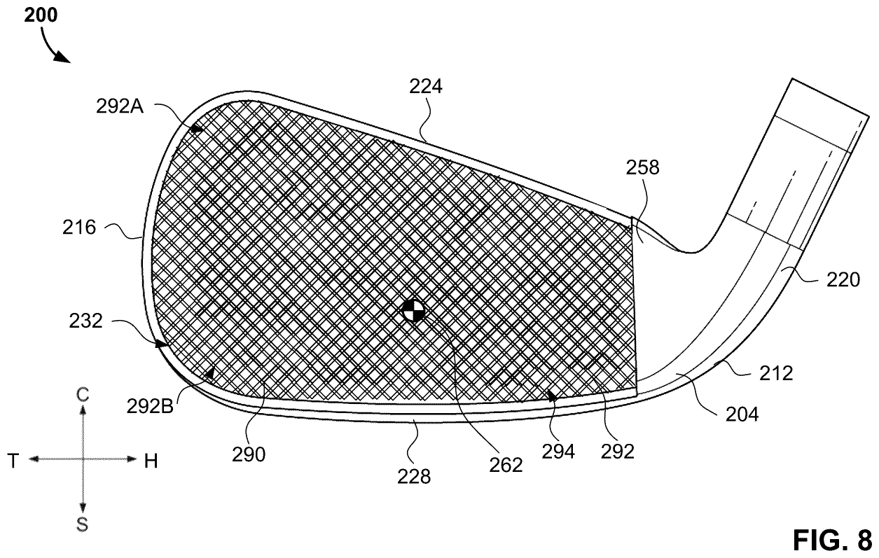

Referring to FIGS. 7 and 8, a lattice structure 290 can be formed at least partially within the internal void 232. In the illustrated embodiment, the lattice structure 290 extends in each of the C-S, H-T, and F-R directions between each of the internal surfaces of the internal void 232, including the face rear surface 236. The lattice structure 290 is formed of a plurality of lattice beams 292 that are interconnected such that a plurality of open spaces 294 is defined throughout the lattice structure 290. The arrangement of the plurality of lattice beams 292 can define a lattice open space volume of the plurality of open spaces 294 (i.e., a volume defined by the spatial arrangement of corresponding lattice beams 292 that define a particular open space 294) of the lattice structure 290 or one or more portions thereof. In addition to providing structural support between the body 204 and the face member 208, the lattice structure 290 can be utilized to reduce an overall weight of the golf club head 200 compared to solid structures formed or arranged within the internal void 232 (such as, e.g., inserts).

It should be appreciated that the lattice structure 290 of the golf club head 200 can be formed in a variety of arrangements that may differ from the illustrated embodiment in FIGS. 5-8. For example, in some embodiments, the lattice structure 290 can be formed in only a portion of the internal void 232. In such embodiments, the lattice structure 290 can be formed within the internal void 232 between the rear and front sides 256, 258 of the golf club head 200 and from the sole 228 to a distance from the topline 224. In some embodiments, the lattice structure 290 can be formed within the internal void 232 at a distance from one or more of: the face rear surface 236, the rear side 256, the toe end 216, the heel end 212, the topline 224, or the sole 228. In some embodiments, the plurality of open spaces 294 of the lattice structure 290 have a uniform lattice open space volume throughout. In some embodiments, a first portion, e.g., a section toward the toe end 216, of the lattice structure 290 has open spaces 294 with a lattice open space volume that is different than that of a second portion, e.g., a section toward the heel end 212, of the lattice structure 290. In some embodiments, a plurality of lattice structures 290 can be formed within the internal void 232. In some embodiments, the lattice structure 290 can have a simple cubic lattice structure arrangement, i.e., hollow cubes arranged side-by-side and on top and bottom of each other. In other embodiments, the lattice structure 290 can have one of a variety of lattice structure shapes, such as, e.g., face-centered cubic, body-centered cubic, or hexagonal closet packed. In some embodiments, the lattice structure 290 can have non-uniform or organic structure shapes.

Referring still to FIGS. 7 and 8, the lattice structure 290 can be formed of a variety of materials, such as, e.g., a metal, metal alloy, or polymer, via an additive manufacturing process. In some embodiments, the lattice structure 290 can be integrally formed with at least the body 204 of the golf club head 200 via an additive manufacturing process. In other embodiments, the lattice structure 290 can be assembled within the body 204 and the face member 208 can be assembled to the body 204. In some embodiments, the lattice structure 290, the body 204, and the face member 208 can be integrally formed as a unitary component via one or more additive manufacturing processes. In some embodiments, the lattice structure 290 can be formed of the same material as the body 204 and/or the face member 208. In other embodiments, the body 204 can be formed of a first material, the face member 208 can be formed of a second material that is different than the first material, and the lattice structure 290 can be formed of a third material that is different than each of the first and second materials. In some embodiments, a first plurality of lattice beams of the lattice structure 290 can be formed of a first material and a second plurality of lattice beams of the lattice structure 290 can be formed of a second material that is different than the first material. In some embodiments, a filler material (not shown), for example, a foam or a liquid polymer or a similar material, can be arranged within at least a portion of the internal void 232 and can surround the lattice structure 290. In some embodiments, the filler material can fill the entire internal void 232 including the plurality of open spaces 294 defined by the lattice structure 290.

It is contemplated that the plurality of lattice beams 292 of the lattice structure 290 can have varying structural characteristics that can be designed for performance optimization of the golf club head 200. For example, in some embodiments, a thickness of each of the plurality of lattice beams 292 can be varied in one or more directions or along one or more regions of the golf club head 200. Referring specifically to FIG. 8, the plurality of lattice beams 292 can include a first plurality of lattice beams 292A and a second plurality of lattice beams 292B. In the illustrated embodiment, the first plurality of lattice beams 292A can be disposed toward the topline 224 and the second plurality of lattice beams 292B can be disposed toward the sole 228. In some embodiments, the first plurality of lattice beams 292A can have a first thickness and the second plurality of lattice beams 292B can have a second thickness that is less than the first thickness. In such embodiments, the first plurality of lattice beams 292A having the first thickness can be more rigid than the second plurality of lattice beams 292B having the second thickness. In some embodiments, at least a portion of the lattice structure 290 (e.g., the second plurality of lattice beams 292B) can be configured to structurally react when the face member 208 contacts a golf ball (not shown). For example, in some embodiments, at least a portion of the lattice structure 290 (e.g., the second plurality of lattice beams 292B) can be formed of a material having elastomeric properties such that, the lattice beams 292 are elastically deformable when the face member 208 bends or deflects inwardly into the internal void 232 in response to contact with the golf ball. In such embodiments, some of the lattice beams 292 can increase in length while other lattice beams 292 simultaneously decrease in length when the face member 208 moves inwardly in the F-R direction.

Referring to FIGS. 5-7, in the illustrated embodiment, the body 204 defines a first body opening 296 that extends along the rear side 256 of the golf club head 200 and through the rear side 256 into the internal void 232. A body opening cover or medallion 276 can be received within the first body opening 296 to prevent undesired substances from entering the internal void 232. In some embodiments, the medallion 276 can be fixedly attached to the body 204. In other embodiments, the medallion 276 can removably attached to the body 204 such that a portion of the lattice structure 290 is visible from an outside of the golf club head 200 through the first body opening 296 when the medallion 276 is removed. In some embodiments, the medallion 276 can be integrally formed with the body 204. In some embodiments, the first body opening 296 can be disposed along one or more of: the rear side 256, the sole 228, or the topline 224.

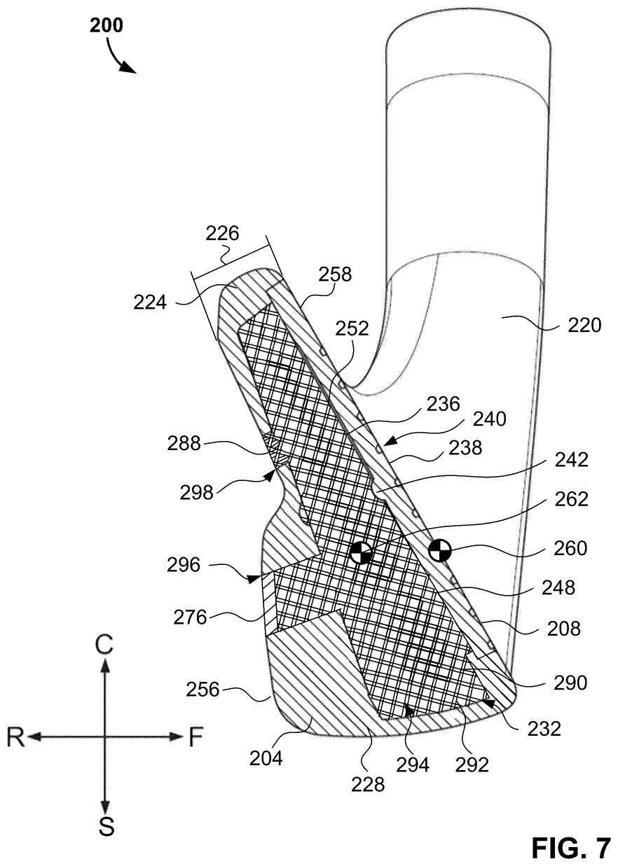

Referring specifically to FIGS. 5 and 6, in the illustrated embodiment, an external lattice portion 288 of the lattice structure 290 extends outwardly from the internal void 232 to the rear side 256 of the golf club head 200 through a second body opening 298 such that the external lattice portion 288 is visible from an outside of the golf club head 200. The external lattice portion 288 can be formed such that one or more of the first and second body openings 296, 298 can be closed without a cover (such as, e.g., the medallion 276) and prevent undesired substances from entering the internal void 232. For example, in the illustrated embodiment, the external lattice portion 288 which has one or more rows of open spaces 294 filled with a material, as illustrated in FIG. 7. In some embodiments, the external lattice portion 288 can be integrally formed with the body 204. In some embodiments, the golf club head 200 can include a plurality of external lattice portions 288 extending along one or more of the: the rear side 256, the sole 228, the topline 224, or the face member 208.

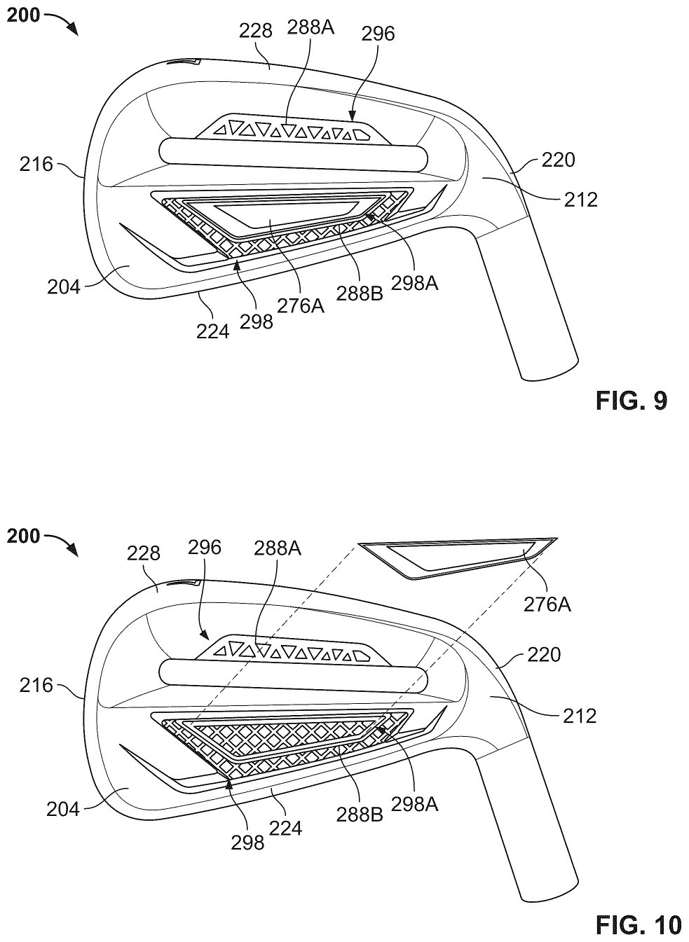

It is contemplated that the external lattice portions 288 can define one or more body openings of the body 204 of the golf club head 200. For example, FIGS. 9 and 10 illustrate an alternative embodiment of the golf club head 200. In the illustrated embodiment of FIGS. 9 and 10, the golf club head includes a first external lattice portion 288A disposed toward the sole 228 and a second external lattice portion 288B disposed toward the topline 224. In particular, the first external lattice portion 288A extends through the first body opening 296 and is structurally similar to the external lattice portion 288 of FIGS. 5 and 6. On the other hand, in the illustrated embodiment, the second external lattice portion 288B defines a third body opening 298A that receives a medallion 276A that is similar in some aspects to the medallion 276 of FIGS. 5 and 6.

Referring again to FIGS. 7 and 8, the golf club head 200 has an impact point or location 260 (see FIG. 7), i.e., a “sweet spot,” that results in optimal trajectory of a golf ball (not shown) when struck by the striking surface, i.e., the face front surface 238, of the face member 208. Further, the golf club head 200 has a center of gravity point or location 262, i.e., a point at which a total weight or mass of the golf club head 200 is evenly dispersed and all sides of the golf club head 200 are balanced about the point. In the illustrated embodiment, the center of gravity 262 and the impact point 260 are aligned in F-R direction. In some embodiments, the center of gravity 262 can be offset from the impact point 260 in the F-R direction. In some embodiments, the center of gravity 262 can be aligned with a striking face direction that is normal to the face front surface 238 of the face member 208.

Using the systems and methods described herein, users may be offered the ability to customize various performance attributes of the golf club head 200 by varying structural characteristics of the body 204, the face member 208, and/or the lattice structure 290 of the golf club head 200. For example, one or more of the following performance attributes of the golf club head 200 can be customized for a particular user: offset, topline thickness 226 (see FIG. 7), sole bounce angle, sole width, sole design, scoring areas width, leading edge radius of curvature, blade length, blade shape, location of the impact point 260, location of the center of gravity 262, moment of inertia value, face thickness, face angle, impact sound, impact feel, or hosel length. This wide range of customizable performance attributes of the golf club head 200 can be beneficial to a user in numerous aspects.

In particular, by varying the structural characteristics of golf club head 200 (e.g., the body 204 and/or the lattice structure 290) the location of the center of gravity 262 of the golf club head 200 can be moved to optimize preferred flight characteristics of a golf ball struck by the golf club head 200. For a user that desires more ball speed and thus increased distance of the golf ball, the location of the center of gravity 262 can be moved in line with the impact point 260 (as illustrated in FIGS. 7 and 8). Further, the lattice structure 290 can be designed structurally flexible, e.g., by forming the lattice structure 290 of a more flexible material or arranging the lattice structure 290 to be more flexible in one or more directions, in addition to moving the location of the center of gravity 262 in line with the impact point 260 to provide further increased ball speed as the face member 208 can flex with the lattice structure 290. On the other hand, for a user that desires a higher launch height of the golf ball, the location of the center of gravity 262 can be moved offset from the impact point 260 closer to the sole 228. In some cases, the entire golf club head 200 can be designed structurally stronger, e.g., by forming the lattice structure 290 of a more rigid material or arranging the lattice structure 290 to be more rigid in one or more directions, in addition to moving the location of the center of gravity 262 closer to the sole 228.

In addition, one or more of the performance characteristics of the golf club head 200 can be customized to make the golf club head 200 easier to manipulate by a particular user. In some instances, the location of the center of gravity 262 of the golf club head 200 can be moved toward the heel end 212 to make the golf club head 200 easier to close during the user's swing, which may counteract a sliced shot. On the other hand, the location of the center of gravity 262 of the golf club head 200 can be moved toward the toe end 216 to benefit a user's swing prone to hooking the golf ball.

Further, the lattice structure 290 may be configured as a cartridge insert that is removable and replaceable on the golf club head 200. In this way, the lattice structure 290 can be re-designed and replaced to meet the dynamic needs of a golfer over time. For example, a youth golfer may benefit from the golf club head 200 having a first lattice structure that yields a lower center of gravity and a lower coefficient of restitution (COR) for increased forgiveness. Then, as the youth golfer matures into an adult golfer, the swing mechanics and performance needs change, such that the adult golfer benefits more from the golf club head 200 having a second lattice structure that yields a higher center of gravity and faster COR to provide more precise control and faster ball speeds after impact. Instead of replacing the entire golf club head 200, which can be expensive and unnecessary due to the durability of the material used, the first lattice structure can simply be replaced with the second lattice structure. Further lattice structures can be fine-tuned and designed based on golfer-specific data or FitData or performance data, thereby allowing the golfer to continue enhancing and adapting the golf club head 200 to his or her dynamic needs over time and in response to various conditions.

Referring again to FIGS. 7 and 8, the lattice structure 290 can be formed in various structural configurations to provide one or more customized performance characteristics of the golf club head 200. For example, one or more regions of the lattice structure 290 can be varied to move the center of gravity 262 or alter the moment of inertia of the golf club head 200, such as, e.g., by varying thickness and/or length of the lattice beams 292 in a particular region of the lattice structure 290 or by varying the lattice open space volume in the particular region of the lattice structure 290. In some embodiments, users may customize the lattice structure 290 to provide less rigid support, i.e., more flexible and forgiving support, to the face member 208 in areas corresponding with the impact point 260 to provide a trampoline effect, while the surrounding areas of the face member 208 are supported by more rigid portions of the lattice structure 290 to reduce or mitigate vibration.

In addition, the design of the body 204 can also be formed in various structural configurations to provide one or more customized performance characteristics of the golf club head 200. For example, the material comprising one or more portions of the body 204 can be varied or the dimensions of body 204, such as, e.g., the volume of the internal void 232, the topline thickness, among others, to vary the golf club head weight, moment of inertia value, or location of the center of gravity 262. In instances in which a user desires a lighter weight golf club head, the volume of the internal void 232 can be increased while the structural strength of the golf club head 200 can be maintained by design of the lattice structure 290. Further, the design of the sole 228 (such as, e.g., shape, thickness, material or the like) of the body 204 can be customized according to the user's desire.

Referring still to FIGS. 7 and 8, the face member 208 can also be customized by locating, arranging, sizing, and shaping the raised portion 242 and/or the recessed portions 248, 252 of the face member 208 of the golf club head 200. More specifically, in some instances, users may desire increased thickness in areas of the face member 208 corresponding with a customized location of the impact point 260 (see FIG. 7), or other customized performance properties, i.e., coefficient of restitution, moment of inertia, ball spin correction, among others. The impact point 260 may be determined through use of a fitting system to generate fit data, i.e., measured data associated with a particular user's golf swing and performance tendencies. In some instances, users may desire reduced thickness in areas of the face member 208 surrounding the impact point 260, such as near the heel end 212 and/or the toe end 216, to provide such customized performance properties, e.g., reducing weight near the toe end 216 to prevent opening the face during impact or to improve flexibility of the face member 208. In some embodiments, users may customize the face member 208 to provide decreased thickness in areas corresponding with the impact point 260 to provide a trampoline effect, while the surrounding areas of the face member 208 are stiffened or reinforced with increased thickness to reduce or mitigate vibration. In some embodiments, the raised portions 242 of the face member 208 may be provided in the form of ribs or ridges or beams or posts extending from and/or along the rear surface 236 of the face member 208. Further, the recessed portions 248, 252 of the face member 208 may be formed along the face rear surface 236 between or beneath the raised portion 242 formed as ribs. Further, the face member 208 may include a hollow interior between the face rear and front surfaces 236, 238. In such embodiments, a face member lattice structure or stiffening members, e.g., ribs and ridges, may be formed within the hollow interior of the face member 208.

Further, an impact sound and/or an impact feel produced by the golf club head 200, such as during or after striking a golf ball, can be customized by varying one or more characteristics of the body 204, the face member 208, and/or the lattice structure 290. For example, the impact sound and/or feel can be varied by the material comprising the body 204, face member 208, and/or lattice structure 290 having softer or harder characteristics, thickness of the face member 208, arrangement and design of the lattice structure 290, e.g., location, density, beam thickness, etc., or type of filler material, if any, disposed in the internal void 232.

Still further, in some examples, mass properties of the golf club head 200 can be further varied by the user after the golf club head 200 is formed by maximizing discretionary weight receptacles provided along or within the golf club head 200 when the golf club head 200 or components thereof, e.g., the body 204, are formed via one or more additive manufacturing processes. In particular, additive manufacturing processes utilized to form the golf club head 200 or components thereof may enable a greater number of discretionary weight receptacles in different locations to be provided on the golf club head 200 compared to conventional manufacturing processes. In some embodiments, a plurality of receptacles, such as, e.g., the third body opening 298A shown in FIGS. 9 and 10, can be formed along the body 204 of the golf club head 200 and can be configured to receive one of a plurality of bodies, e.g., weights, plugs, and/or the medallion 276A also shown in FIGS. 9 and 10. Such bodies can be formed of a heavier or more dense material, e.g., tungsten, than that of the body 204. Additionally or alternatively, one or more of the receptacles may receive a plug having a mass that is smaller than each of the plurality of bodies. In such embodiments, the user can further adjust or tune the mass properties of the golf club head 200 by selectively attaching one of the plurality of bodies to one or more of the plurality of receptacles to move the center of gravity 262 relative to the impact point 260.

In some embodiments, users may be offered the ability to customize various performance attributes of each golf club of a golf club set. For example, the golf club head 200 can correspond to a single golf club of a golf club set, for example, a short iron. Using the methods and systems described herein, a user may be able to design one or more other golf clubs of the set to have different performance characteristics than other golf clubs of the set, such as the golf club having the golf club head 200. For example, a long iron having the golf club head 200 of a golf club set can have a different location of center of gravity 262 and/or impact point 260 than other golf clubs in the set. This customization of individual golf clubs within a golf club set can provide even further benefits to a user in that types of clubs within his/her golf club set can be individually customized based on the user's swing characteristics for that particular type of golf club (e.g., long irons versus short irons or drivers versus woods).

Referring to FIGS. 5-10, various components of the example golf club head 200, including one or more sub-components or structures of the golf club head 200 (such as, e.g., the body 204, the face member 208, or the lattice structure 290), may be formed through one or more of the additive manufacturing processes and of one or more of the materials described herein to provide one or more of the various customizable performance characteristics of the golf club head 200. Accordingly, one or more additive manufacturing processes may be implemented to form sub-components or structures of the golf club head 200 having one or more properties that may differ from other portions of the golf club head 200. For example, in some cases, the golf club head 200 as shown in FIGS. 5-9, including the body 204, the face member 208, and the lattice structure 290, can be integrally formed as a single unitary piece via one or more additive manufacturing processes. In some examples, the face member 208 may be formed via a conventional manufacturing process, e.g., forging or casting, while the body 204 may be formed via one or more additive manufacturing processes and later coupled with the face member 208 to form the golf club head 200. In other examples, at least the face member 208 of the golf club head 200 may be integrally formed via a first manufacturing process, such as, e.g., an additive manufacturing process, among others, which is separate from and later coupled with the body 204 having the lattice structure 290 formed via a second manufacturing process, such as, e.g., an additive manufacturing process, among others, which may differ in one or more aspects from the first manufacturing process. In some examples, a first portion, e.g., the face member 208, of the golf club head 200 may be formed with a first material and a second portion, e.g., the body 204, may be formed with a second material having one or more properties that differ from the first material. In some examples, a third portion, e.g., the lattice structure 290, of the golf club head 200 may be formed of a third material having one or more properties that differ from each of the first and second materials.

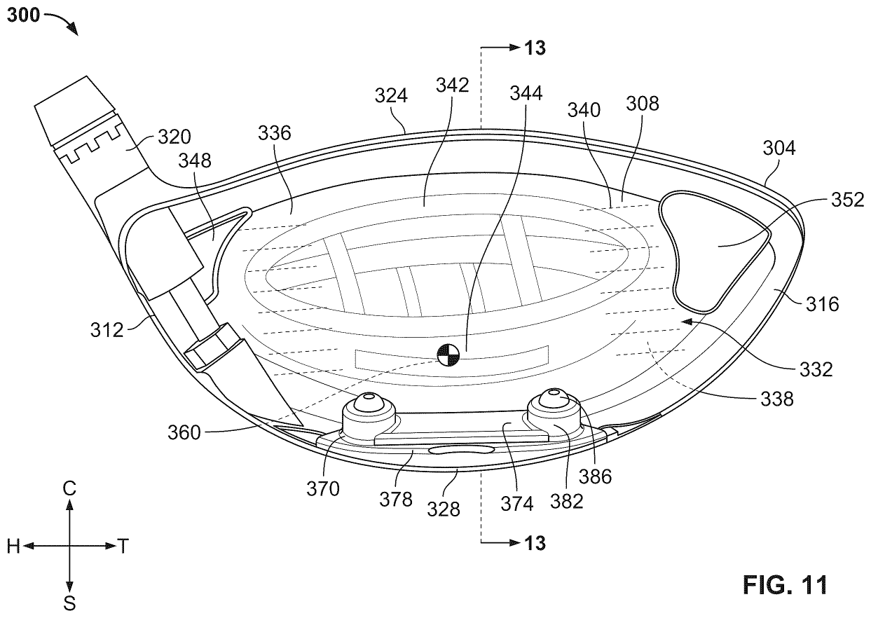

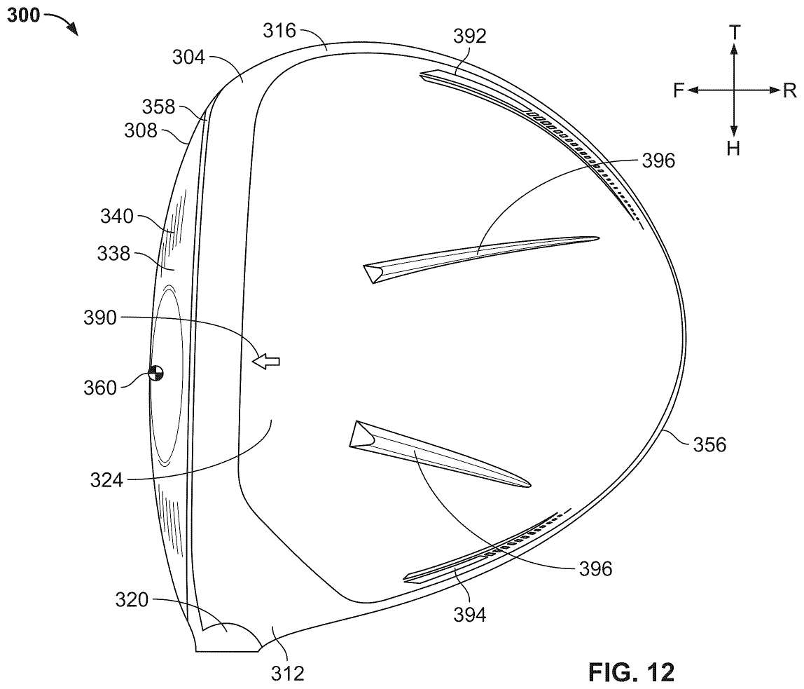

It should be appreciated that several aspects of the golf club head 200 may also be utilized in golf club heads of types other than iron-type golf club heads. In this regard, FIGS. 11-13 illustrate another embodiment of a golf club head 300 that may be custom manufactured and/or modified utilizing the systems and methods described herein. The golf club head 300 is generally similar to the golf club head 100 of FIGS. 1-4 and, thus, similar numbering is used to indicate similar features. Referring specifically to FIGS. 11 and 12, the golf club head 300 includes a body 304 and a face member or face insert 308 extending between a heel end 312 and a toe end 316. A hosel 320 extends from the heel end 312 of the golf club head 300. In some embodiments, the hosel 320 is an adjustable hosel, such that the loft and lie angles may be adjusted, among other configurations, by the user. The body 304 of the golf club head 300 includes a crown 324 that is opposite a sole 328 (see FIG. 11). In some embodiments, the body 304 is a unitary component, such that the crown 324 and the sole 328 are integrally formed. In some embodiments, the body 304 is a multi-piece structure, such that the crown 324 and the sole 328 are separable and distinct components of the golf club head 300 which require assembly. Further, the face member 308 may be integrally formed with the body 304, or the face member 308 may be a separable and distinct component requiring assembly with the body 304 to form the golf club head 300.

It will be appreciated that FIG. 11 is a rear, cut-away view of the golf club head 300 that includes an interior volume or internal void 332, such that the golf club head 300 is hollow. The internal void 332 may be defined by the face member 308 and the body 304, such that assembly or integral formation thereof encloses the internal void 332. In some embodiments, the internal void 332 is defined entirely by the body 304, or the face member 308 may define internal voids 332 therein. For illustrative purposes, a coordinate system is depicted in FIGS. 11-13 that is similar to the coordinate system of FIGS. 1-4.

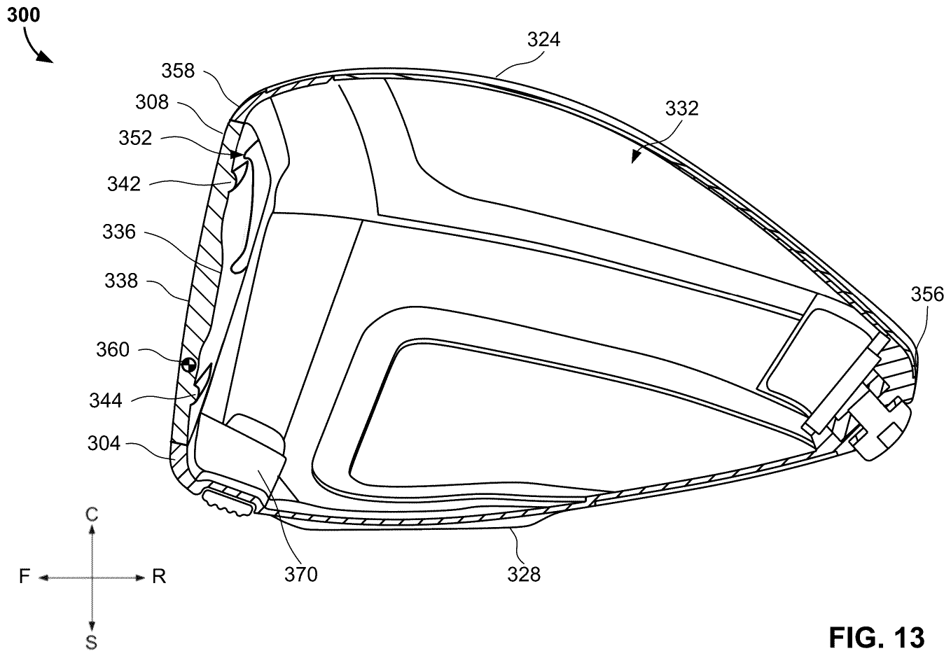

Referring specifically to FIGS. 11 and 13, the face member 308 of the golf club head 300 includes a rear surface 336 (see FIG. 13) that is opposite a front surface 338. The front surface 338 at least partially defines the striking face that impacts a golf ball during use and includes a plurality of grooves 340. In the illustrated embodiment, the rear surface 336 is configured to face the internal void 332 (see FIG. 13) and includes a plurality of raised portions 342, 344 and a plurality of recessed portions 348, 352 (see recessed portion 348 in FIG. 11). It will be appreciated that the plurality of raised portions 342, 344 extend rearwardly along the front-rear direction, toward a rear side 356 (see FIG. 13) of the golf club head 300, which is opposite a front side 358 of the golf club head 300 where the face member 308 is positioned. In some embodiments, the plurality of raised portions 342, 344 increase a thickness, i.e., a dimension measured in the front-rear direction, of the face member 308 relative to the front surface 338. Further, the plurality of recessed portions 348, 352 may decrease the thickness of the face member 308 relative to the front surface 338.

Using the production systems and methods described herein, users may be offered the ability to customize the face member 308, such as by locating, arranging, sizing, and shaping the raised portions 342, 344 and/or the recessed portions 348, 352 of the face member 308. For instance, users may desire increased thickness in areas of the face member 308 corresponding with a custom impact point or location 360 to provide customized performance properties, i.e., coefficient of restitution, center of gravity location, moment of inertia, ball spin correction, among others. The impact point 360 may be determined through use of a fitting system to generate fit data, i.e., measured data associated with a particular user's golf swing and performance tendencies. In some instances, users may desire reduced thickness in areas of the face member 308 surrounding the impact point 360, such as near the heel end 312 and/or the toe end 316, to provide such customized performance properties, e.g., reducing weight near the toe end 316 to prevent opening the face during impact or to improve flexibility of the face member 308. In some embodiments, users may customize the face member 308 to provide decreased thickness in areas corresponding with the impact point 360 to provide a trampoline effect, while the surrounding areas of the face member 308 are stiffened or reinforced with increased thickness to reduce or mitigate vibration. Accordingly, users can produce such customized face members 308 with raised portions 342, 344 and recessed portions 348, 352 using the systems and methods described herein.

In some embodiments, the raised portions 342, 344 may be provided in the form of ribs or ridges or beams or posts extending from and/or along the rear surface 336 of the face member 308. Further, the recessed portions 348, 352 may be formed along the rear surface 336 between or beneath the raised portions 342, 344 formed as ribs. Further, the face member 308 may include a hollow interior between the front surface (not shown) and the rear surface 336 in which a face member lattice structure or stiffening members, e.g., ribs and ridges, may be formed.

With continued reference to FIGS. 11 and 13, the golf club head 300 includes an insert 370 disposed within the internal void 332. In the illustrated embodiment, the insert 370 includes an upper rib 374 and a lower rib 378 spanning between a set of posts 382 (see FIG. 11), and the insert 370 is attached to the body 304 by a set of fasteners 386. The insert 370 may be provided in the internal void 332 of the golf club head 300 for customization of various performance properties, e.g., the center of gravity, moment of inertia, sound performance, feel, among others. In some embodiments, the insert 370 is attached to the face member 308 or to another portion of the body 304, e.g., the crown 324, the heel end 312, the toe end 316, or some combination thereof, in addition or alternatively to being attached to the sole 328. In some embodiments, the insert 370 is attached to the body 304 or the face member 308 by an interference fit, or by fusion, welding, adhesive, or compression. In some embodiments, the insert 370 is sized and shaped differently than shown, such that the insert 370 may be a lattice structure, a plurality of ribs or posts, thickened areas, or the like. The insert 370 may be shaped to resemble a sphere, a square or cube, a rectangle or box, a triangle or triangular-shaped prism, a polygon or polygon-shaped prism, a bridge or truss, an alphanumeric symbol, irregular shapes, or a series or array or pattern of shapes. The insert 370 may be integrally formed and then attached to the golf club head 300, or the insert 370 may be formed of multiple separable components that are pre-assembled before being attached or inserted into the golf club head 300.

Referring again to FIG. 12, the golf club head 300 may be manufactured to include a plurality of markings thereon, including a first marking 390 positioned adjacent a front side 358 and located substantially centrally between the heel end 312 and the toc end 316, a second marking 392 positioned adjacent the toe end 316, and a third marking 394 positioned adjacent the heel end 312. In the illustrated embodiment, the first marking 390 is depicted as a logo or emblem, although the first marking 390 may be any symbol, code, cipher, indicia, or the like. The first marking 390 may be provided to aid a user in aligning the golf club head 300 with a golf ball (not shown) at address. The second and third markings 392, 394 are depicted as indicia comprising curved stripes or bars, which are mirrored relative to each other. The markings 390, 392, 394 are depicted as being provided on the crown 324, although other configurations are possible. In some embodiments, the crown 324 may be provided with the markings 390, 392, 394 through implementation of the systems described herein, such that the markings 390, 392, 394 are integrally formed with the crown 324. Additionally, the crown 324 may be provided or formed with aerodynamic features 396 that may affect a coefficient of restitution of the golf club head 300. In the illustrated embodiment, the aerodynamic features 396 are ribs extending outwardly from the crown 324. In other embodiments, the aerodynamic features 396 can be a variety of shapes and formed in a variety of arrangements.

Referring to FIGS. 11-13, various components of the example golf club head 300, including one or more sub-components or structures of the golf club head 300 (such as, e.g., the body 304 or the face member 308), may be formed through one or more of the additive manufacturing processes and of one or more of the materials described herein. Accordingly, one or more additive manufacturing processes may be implemented to form sub-components or structures of the golf club head 300 having one or more properties that may differ from other portions of the golf club head 300. For example, in some cases, the golf club head 300 as shown in FIGS. 11 and 12, including the body 304 and the face member 308, can be integrally formed as a single unitary piece via one or more additive manufacturing processes. In other examples, at least the face member 308 of the golf club head 300 may be integrally formed via an (e.g., a first) additive manufacturing process (or other manufacturing process) separate from and later coupled with the body 304 formed via a different (e.g., a second) additive manufacturing process (or other manufacturing process). In some examples, a first portion (e.g., the face member 308) of the golf club head 300 may be formed with a first material and a second portion (e.g., the body 304) may be formed with a second material having one or more properties that differ from the first material.

Aspects of the present disclosure includes systems and methods for providing an inventory of golf club equipment, such as golf clubs or components thereof, with more varying characteristics that are selectable by a user compared to currently available golf club equipment. For example, a golf club manufacturer can provide golf club sets with golf club components, such a golf club head, that can be produced based on a user's selection of predetermined ranges of golf club head specifications. By limiting the provided predetermined ranges of golf club head specifications made available to the user, the golf club manufacturer can more easily form the selected golf club head via an additive manufacturing process while providing a larger range of customizable golf club characteristics to the user than currently available golf club heads that are formed using traditional manufacturing methods.

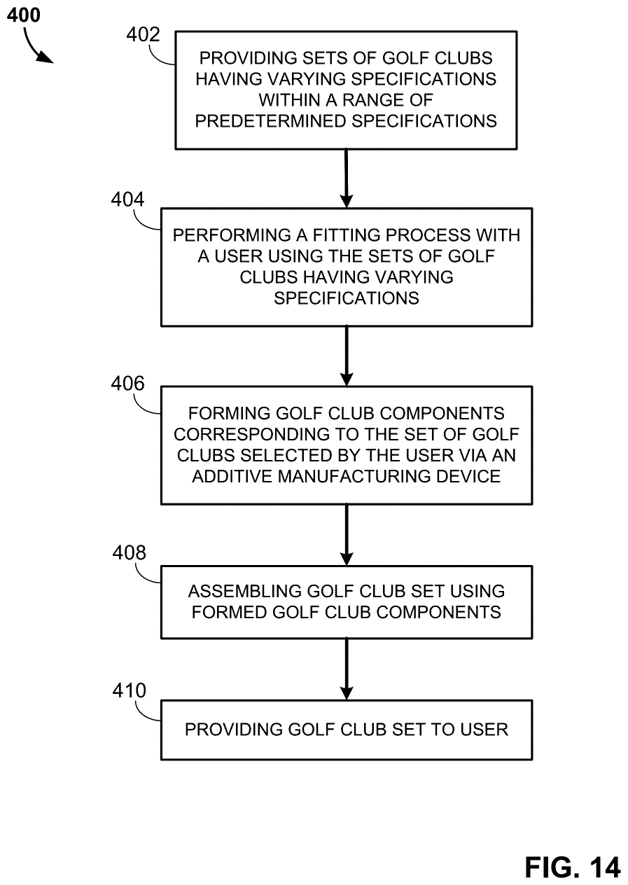

Turning now to FIG. 14, a method 400 of providing golf club sets according to an embodiment of the present disclosure is shown, which includes fewer or more steps than depicted. Further, the following steps may be performed in any order or sequence and may further include pauses or spans of time in between. The following steps may be performed by a single entity, a single device or system, multiple entities, or multiple devices or systems. Beginning at block 402, sets of golf clubs having varying specifications within a range of predetermined specifications are provided. For example, the sets of golf clubs can have golf club components, such as golf club heads, that have varying specifications within each set of golf clubs. Golf club component specifications of the provided golf club sets that can be varied within a predetermined range of specifications can include any one or more of the following: club type, club shaft type, club shaft length, club shaft stiffness, club shaft material (e.g., steel, graphite, composite, or combinations thereof), club shaft shape (e.g., cylindrical, elliptical or ovular, tapered, single bend, double bend, etc.), club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head center of gravity location, club head moment of inertia value, club head product of inertia values, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto (e.g., number of weight receptacles, arrangement of weight receptacles, size of weight receptacles and corresponding weight members, weight member material, weight member density, etc.), club head weight members, club head finish type (e.g., anodized, painted, plated, physical vapor deposition (PVD), etc.), club head insignia, club head medallion design, club price, number of clubs of the golf club set, and manufacturing information.

The sets of golf clubs provided in block 402 can be provided to a golf club fitter that can use the sets of golf clubs in a fitting process for a user. Accordingly, block 404 includes performing a fitting process with a user using the sets of golf clubs having varying specifications. The fitting process of block 404 can include a wide range of fitting steps or methods. The user can test the sets of golf clubs and determine, with the assistance of the fitter, which particular specifications provided in a particular golf club set of the provided varying golf club sets is ideal for the user's swing characteristics. In some embodiments, the fitting process of block 404 can utilize a golf simulator.

Block 406 of method 400 includes forming golf club components corresponding to the set of golf clubs selected by the user via an additive manufacturing device. For example, block 406 can include forming golf club heads having specifications that correspond to the specifications of the golf club heads of the selected golf club set by the user. In some embodiments, the method 400 can include one or more additional steps before golf club components are formed in block 406. For example, in such embodiments, the method 400 can further include preparing design files corresponding to the golf club components for printing via the additive manufacturing device, which can include adding polishing to stock items, machining material from stock items (such as, e.g., on a face of an iron-type club head), adding material to stock items (such as, e.g., to areas where additive manufacturing build supports will be placed during printing), among others.

With the golf club components formed in block 406, block 408 of method 400 includes assembling the golf club set using the formed golf club components. For example, block 408 can include assembling a golf club shaft and grip with the formed golf club heads to produce the user selected golf club set, which can be provided to the user as in block 410.

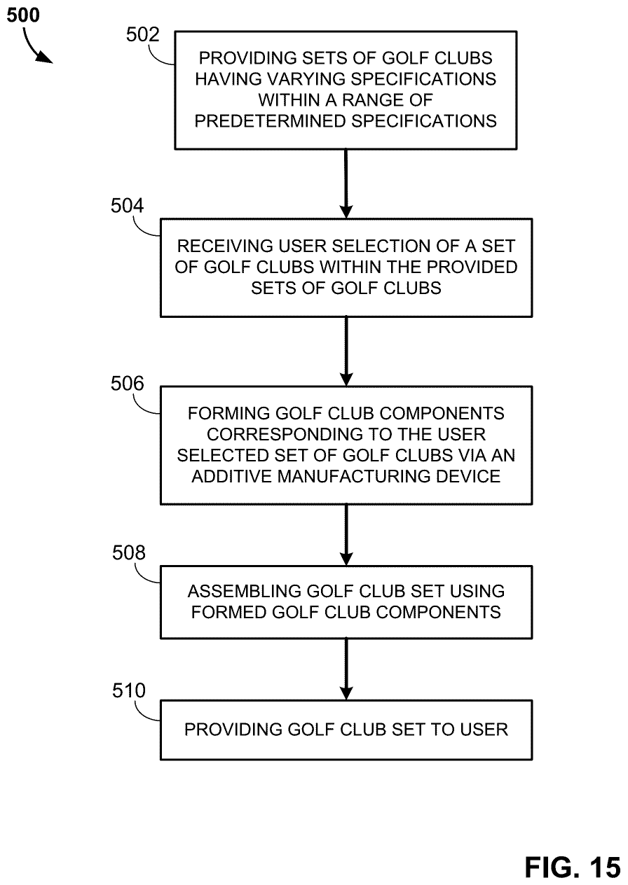

It is contemplated that in some embodiments a user may select a golf club set from provided sets of golf clubs having varying specifications without visiting a fitter. Accordingly, FIG. 15 illustrates another method 500 of providing golf club sets according to an embodiment of the present disclosure, which includes fewer or more steps than depicted. Further, the following steps may be performed in any order or sequence and may further include pauses or spans of time in between. The following steps may be performed by a single entity, a single device or system, multiple entities, or multiple devices or systems. Beginning at block 502, sets of golf clubs having varying specifications within a range of predetermined specifications are provided. The provided sets of golf clubs in block 502 can have varying specifications as described with reference to block 402 of method 400. The provided sets of golf clubs in block 502 can be provided to a user in physical form or can be otherwise listed for a user to select, such as on a website, a catalogue, etc.

Block 504 includes receiving a user selection of a set of golf clubs within the provided sets of golf clubs in block 502. For example, block 504 can include receiving an order from the user for a particular set of golf clubs such as an online order. Block 506 of method 500 includes forming golf club components corresponding to the set of golf clubs selected by the user via an additive manufacturing device. For example, block 506 can include forming golf club heads having specifications that correspond to the specifications of the golf club heads of the selected golf club set by the user. In some embodiments, the method 500 can include one or more additional steps before golf club components are formed in block 506. For example, in such embodiments, the method 500 can further include preparing design files corresponding to the golf club components for printing via the additive manufacturing device, which can include adding polishing to stock items, machining material from stock items (such as, e.g., on a face of an iron-type club head), adding material to stock items (such as, e.g., to areas where additive manufacturing build supports will be placed during printing), among others.

With the golf club components formed in block 506, block 508 of method 500 includes assembling the golf club set using the formed golf club components. For example, block 508 can include assembling a golf club shaft and grip with the formed golf club heads to produce the user selected golf club set, which can be provided to the user as in block 510.

Aspects of the present disclosure further includes systems and methods for selecting and fabricating golf club equipment, such as golf clubs or components thereof. A user, e.g., a golfer, can utilize such systems to design and have fabricated a wide variety of golf equipment ranging from a specifically-constructed golf club head to a full set of golf clubs with combinations of desired components common throughout the set. In some aspects, systems of the present disclosure can allow novice or average golfers to experience the benefits of professional fitting and custom clubs commonly used by professional golfers. In particular, the user can select various characteristics of the golf club head that may be optimal for his or her swing characteristics or level of skill. In some embodiments, systems of the present disclosure can include fabrication equipment, such as an additive manufacturing machine, used to form customized components golf clubs. In other embodiments, systems of the present disclosure result in the output of design parameters or a design model that can be used by an additive manufacturing machine to produce the desired golf club components.

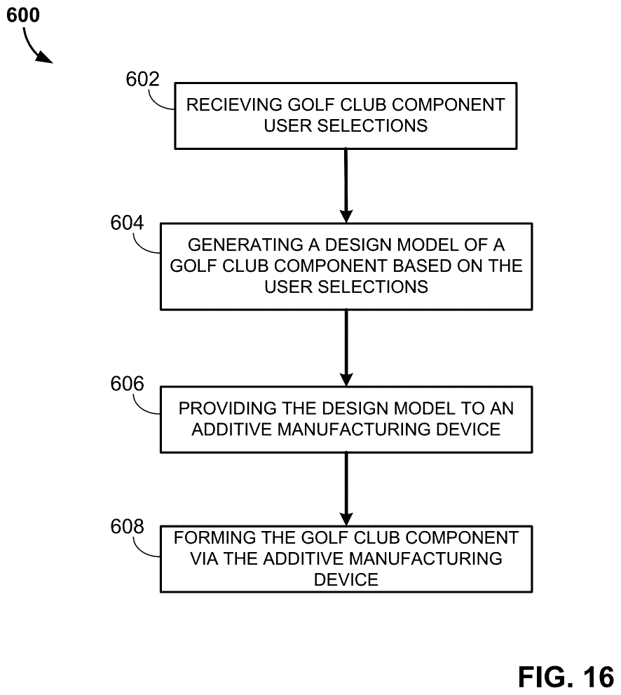

Turning now to FIG. 16, a method 600 for providing golf club components according to an embodiment of the present disclosure is shown, which includes fewer or more steps than depicted. Further, the following steps may be performed in any order or sequence and may further include pauses or spans of time in between. The following steps may be performed by a single entity, a single device or system, multiple entities, or multiple devices or systems. Beginning at block 602 golf club component selections are received by a user. A user may be the end user of the golf components, e.g., a golfer, or the user may be a professional fitter or other golf professional. Golf club component selections can be selected by a user and can include any one or more of the following: club type, club shaft type, club shaft length, club shaft stiffness, club shaft material (e.g., steel, graphite, composite, or combinations thereof), club shaft shape (e.g., cylindrical, elliptical or ovular, tapered, single bend, double bend, etc.), club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head center of gravity location, club head moment of inertia value, club head product of inertia values, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto (e.g., number of weight receptacles, arrangement of weight receptacles, size of weight receptacles and corresponding weight members, weight member material, weight member density, etc.), club head weight members, club head finish type (e.g., anodized, painted, plated, physical vapor deposition (PVD), etc.), club head insignia, club head medallion design, club price, number of clubs of the golf club set, and manufacturing information.

At block 604, a design model of a golf club component can be generated based on the user selections received at block 602. As discussed in greater detail below, the design model can be a virtual object or a set of parameters of the golf club component. In some embodiments, the design model can be a set of instructions for an additive manufacturing machine to form a physical object of a virtual object or set of parameters. In some embodiments, the design model can be displayed to the user (via, for example, a display screen) and updated in real-time while the user makes the golf club component selections prior to block 602. In some embodiments, the golf club component can be one or more of a golf club head, such as, e.g., an iron-type head or driver-type head, a golf club shaft, or a golf club grip.

At block 606, the design model generated in block 604 is provided to an additive manufacturing machine or system. The additive manufacturing machine can be any machine configured to perform any of the additive manufacturing processes described herein. In some embodiments, the design model can be provided directly to the additive manufacturing machine. In some embodiments, the additive manufacturing machine is connected to a network and the design model is provided to the additive manufacturing machine via the network. In some embodiments, the design model can be provided to a user and the user can provide the design model to the additive manufacturing machine. It is contemplated that the additive manufacturing network may include a plurality of additive manufacturing systems distributed across a geographical area and selected based on proximity to a shipping address provided by the user in connection with the design model. In some embodiments, the additive manufacturing system is selected based on availability as determined by a software program or algorithm considering various production factors, e.g., geographic location, materials required, production time, surface finish, and/or quantity.

At block 608, the golf club component is formed via the additive manufacturing machine. The golf club component can be formed via any one or more of the additive manufacturing processes and any one or more of the materials described herein. In some embodiments, the additive manufacturing machine can be part of a manufacturing system that can include other machines that perform other manufacturing processes to form or finish the golf club component. In some embodiments, one or more components of the golf club component can be additively manufactured and assembled with other components to form the golf club component. In some embodiments, the golf club component can be a golf club head and a lattice structure can be formed integrally with the golf club head (such as, e.g., the lattice structure 290 of the golf club head 200 of FIGS. 5-8).

It should be appreciated that the method 600 can include additional steps corresponding to a user's determination of the golf club component selections in block 602. For example, in some embodiments, a user conducts a fitting session and data obtained during the fitting session can be used to generate recommended golf club component selections for the user to select. In some embodiments, the user's golf club component selections can be referenced with one or more databases before the design model is generated. In some embodiments, the method 600 can further include, before the golf club component is formed in block 608, preparing design files corresponding to the golf club components for printing via the additive manufacturing device, which can include adding polishing to stock items, machining material from stock items (such as, e.g., on a face of an iron-type club head), adding material to stock items (such as, e.g., to areas where additive manufacturing build supports will be placed during printing), among others.

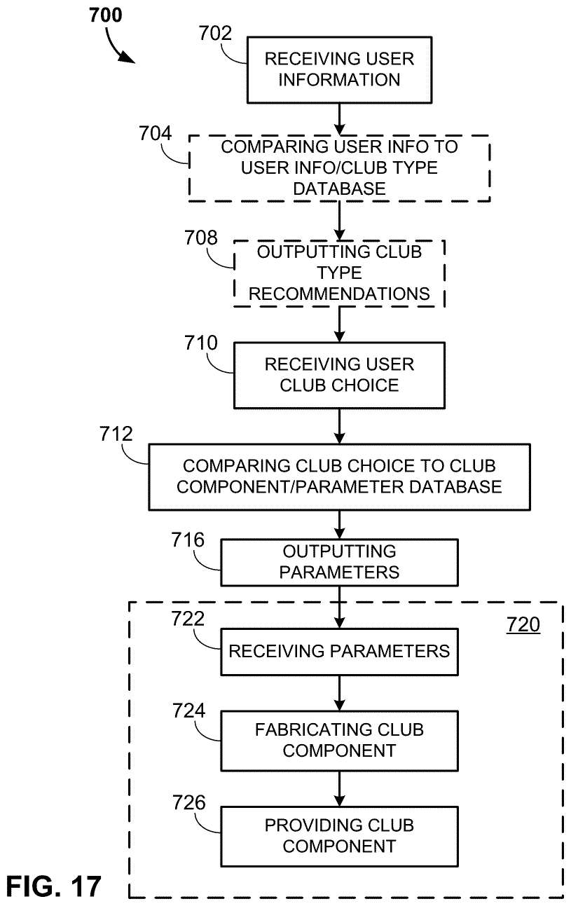

Referring now to FIG. 17, a flowchart of a method 700 for selecting golf club components according to an embodiment of the present disclosure is shown, which includes fewer or more steps than depicted. Further, the following steps may be performed in any order or sequence and may further include pauses or spans of time in between. The following steps may be performed by a single entity, a single device or system, multiple entities, or multiple devices or systems. Beginning at block 702 information is received from a user. A user may be the end user of the golf components, e.g., a golfer, or the user may be a professional fitter or other golf professional. The user may enter any of the below-listed information, as it would be helpful in determining the best golf club component for the user or assuring that the selected golf club components are to the user's liking and delivered to the user (or a third party) in a timely manner. The information may be selected from: name, address, height, weight, sex, handedness, age, geographic location, golf score handicap, physical limitations, annual income, frequency of play, frequency of airline travel, favorite color, alma matter, current clubs or any combination thereof. A user may input additional information relevant to a selection of golf club components, such as a preference for any of the following: club type, club shaft type, club shaft length, club shaft stiffness, club shaft material (e.g., steel, graphite, composite, or combinations thereof), club shaft shape (e.g., cylindrical, elliptical or ovular, tapered, single bend, double bend, etc.), club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head center of gravity location, club head moment of inertia value, club head product of inertia values, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto (e.g., number of weight receptacles, arrangement of weight receptacles, size of weight receptacles and corresponding weight members, weight member material, weight member density, etc.), club head weight members, club head finish type (e.g., anodized, painted, plated, physical vapor deposition (PVD), etc.), club head insignia, club head medallion design, club price, number of clubs of the golf club set, and manufacturing information.

In some embodiments, the user may input swing metrics relevant to a selection of golf club components, such as any of the following: swing speed, club head angle of attack, face closure rate, consistency of impact, swing path relative to target, angle of head rotation prior to impact, club head acceleration curve, average impact location, among others. In such embodiments, swing metrics can be recorded and calculated during a fitting process (such as, e.g., via launch monitors) or entered by the user if already known. In some embodiments, a user may upload still or moving images of a golf swing, e.g., a video of the user swinging a golf club. The user may provide information about ball trajectories or flight distances. In some embodiments, the ball trajectory information may be provided by an optical, IR, or ultrasonic camera, or from a pressure pad, e.g., information from a golf simulator. In some embodiments that receive images or flight data, additional components of the system (not shown) may analyze the images or flight data to produce metrics used in subsequent steps of method 700 to output club type recommendations. For example, in some embodiments, a standard club (i.e., a control club) can be swung by the user during a fitting process and recordings/data from the fitting process can be provided to a computer (e.g., an algorithm operated by the computer) that is configured to analyze the recordings/data and provide recommendations that help guide the user to club selections that may maximize their performance.

At block 704 the information provided by the user is compared to a database relating player information and golf club components (i.e., a user info and club type database). Based upon the comparison in block 704, one or more golf clubs, or golf club components, are output to the user at block 708. Blocks 704 and 708 are optional, however, as the method 700 may simply require the user to input information which is received at block 702 and then the method 700 proceeds to block 710 where a user club choice is received, as described in greater detail below. In some embodiments, the user info and club type database in block 704 may include club types or golf club sets with a predetermined range of varying specifications, similar to block 402 of method 400 and to block 502 of method 500.

The user info and club type database in block 704 provides club component options based upon information provided by the user. A variety of user info and club type databases may be used with method 700 of the present disclosure. For example, the user info and club type database in block 704 may be as simple as a look-up table relating shaft length to golfer height. In other instances, the user info and club type database in block 704 may correlate different styles of club heads with user information about age and golf score handicap. In some embodiments, the user info and club type database in block 704 may comprise algorithms that suggest particular types of club components based upon combinations of user information. For example, values of height, weight, age, sex, handedness, and handicap may be combined to produce a value for comparison to the user info and club type database.

At block 710, user choices of golf clubs or golf club components are received. The choices may be selected from the recommendations output in block 708, or club component choices may be received independently of the recommendations from the user. The user choices may include any of the following: club type, club shaft type, club shaft length, club shaft stiffness, club shaft material (e.g., steel, graphite, composite, or combinations thereof), club shaft shape (e.g., cylindrical, elliptical or ovular, tapered, single bend, double bend, etc.), club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head center of gravity location, club head moment of inertia value, club head product of inertia values, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto (e.g., number of weight receptacles, arrangement of weight receptacles, size of weight receptacles and corresponding weight members, weight member material, weight member density, etc.), club head weight members, club head finish type (e.g., anodized, painted, plated, physical vapor deposition (PVD), etc.), club head insignia, club head medallion design, number of clubs of the golf club set, and manufacturing information.

Additionally, a software interface can allow the user to edit aspects of the golf club or component thereof, e.g., club head design, specifications, shape, etc., based on user preferences. For example, in some embodiments, golf club component design files generated based on user choices received in block 710 can be updated by a human using software (or an interface thereof) at the direction of the user (i.e., a consumer or a fitter) in real-time. An algorithm can then compute the expected mass properties of the golf club head and advises the user of end results. Also, the algorithm may highlight areas to add material (or volume), and areas to remove material to achieve desired characteristics. Starting templates can be utilized to help quickly shape the club. Virtual construction lines can be used to graphically illustrate dimensional limits, or boundaries for preventing the user from creating non-conforming clubs according to the United States Golf Association (USGA) rules, as well as exceeding traditional design guidelines with respect to head weight. Personalization features can be graphically incorporated and erased. Digital renderings can be utilized to give realistic feedback of the final product. In some embodiments, the final product can be produced as a virtual object to be viewed by the user.

At block 712, the golf club component selections are compared to a database correlating club components to a parameter database (i.e., a club component and parameter database). The parameters may include specific information about golf club components or entire clubs. For example, the club component and parameter database in block 712 may include combinations of stock components (such as, e.g., shafts, grips, club heads, ferrules, hosels or hosel adapters, etc.) that can be assembled to produce a golf club of the user's choosing. Thus, a user selection of a golf club can be correlated with specific components and instructions needed to construct the club. In some embodiments, the club component and parameter database in block 712 may include club types or golf club sets with a predetermined range of varying specifications, similar to block 402 of method 400 and to block 502 of method 500. In some embodiments, the parameters include schematics, for example, a design file such as computer-aided drafting (CAD) files, that can be used to fabricate, form, or construct golf clubs or golf club components. The parameters may include specific materials, tolerances, etc. to accompany the schematics. The parameters may include instructions or computer code for controlling machines used to fabricate clubs or club components, for example additive manufacturing machines. In some embodiments, the design files include specifications for forming a golf club head or components thereof using an additive manufacturing machine.

In some embodiments of the method 700, parameters regarding the golf club or golf club components, e.g., design files, are output at block 716. In some embodiments, the parameters will not be output to the user, but rather they will be retained for order fulfillment or sent to a third party, such as a fabricator, manufacturer, or assembler. In other embodiments, the parameters output at block 716 can be provided directly to a user and the user can fabricate the golf club component and assemble a golf club with the component. For example, in some embodiments, the user can form the golf club head using an additive manufacturing machine and can assemble the golf club using other components obtained by the user, such as, the shaft and grip.

In some embodiments, the output parameters are sent to a fabricator 720, as indicated by dashed box, where the golf club or golf club components will be fabricated. In some embodiments, the fabricator is owned by the owner of the system, i.e., the entity that controls the servers used to perform the recited methods as discussed below. In other embodiments, the fabricator is independent of the owner of the system, but the actions of the fabricator are controlled by the owner of the system, either by contract or because the fabricator is acting as an agent of the owner of the system. In some embodiments, the fabricator is the user that purchases the golf club (i.e., the parameters or design files of the golf club) and fabricates the golf club or components thereof using a machine owned by the user, such as an additive manufacturing machine. Thus, the method 700 is illustrated to include blocks 722, 724, and 726 in dashed box 720 even when the fabricator is geographically or legally separate from the owner of the method 700.

At block 722, the fabricator receives parameters of the golf clubs or golf club components that were selected by the user. Using the parameters, the fabricator then fabricates the golf clubs or components thereof at block 724. The fabrication process may include casting, forging, bending, stamping, cutting, milling, polishing, plating, grinding, welding, drilling, gluing, extruding, injecting, or sintering. For example, in some embodiments, the fabricating block 780 includes forming a golf club head via one or more additive manufacturing process such as, e.g., any of the additive manufacturing processes using any of the materials described herein. Using such additive manufacturing processes, a wide variety of club shapes and configurations can be constructed, even shapes that are not attainable using conventional machine tools. For example, using additive manufacturing processes, it is possible to form a club head having a void with a lattice structure formed therein. Additive manufacturing processes may be used in combination with other processes, for example cutting, welding, or polishing, etc. Components of clubs that are specially fabricated for the user via an additive manufacturing process or otherwise may be combined with other components that are “off the shelf,” for example, a commercially available golf club grip.

In some embodiments, method 700 can include one or more additional steps after the fabricator receives the parameters, as in block 722, and before the golf clubs or components are fabricated, as in block 724. For example, in such embodiments, method 700 can further include preparing design files for printing, which can include adding polishing to stock items, machining material from stock items, such as, e.g., on a face of an iron-type club head, adding material to stock items, such as, e.g., to areas where additive manufacturing build supports will be placed during printing, among others.

Once the fabrication process is complete, the club component is provided in block 726. The component may be provided to the user directly, e.g., via direct shipping, or the component may be provided to an assembler who will combine the fabricated component with other fabricated components or other commercially available components to achieve the user club choice. In some instances, the provided component may be packed, e.g., in a box, and labeled for delivery. In some embodiments, the method 700 may not include block 726 in instances in which the user is the fabricator.

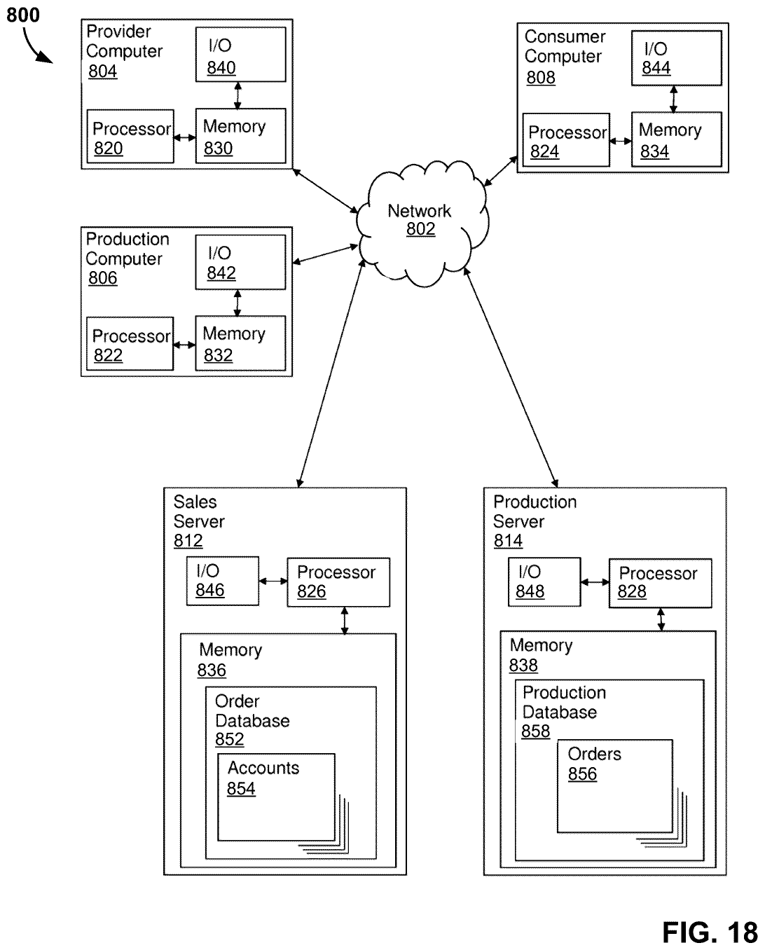

A system of the present disclosure can include at least a processor and a computer readable medium having instructions for the processor to carry out tasks according to methods of the present disclosure. However, in practice, a system of the present disclosure will typically include other components such as graphical interfaces, input/output devices, transitory computer readable media, and a network. Systems of the present disclosure may additionally include fabrication equipment, such as an additive manufacturing machine. FIG. 18 shows components in an exemplary system for selecting customized golf clubs or golf club components. As shown in FIG. 18, system 800 generally includes one or more computers, communicably coupled via a network 802. Systems and methods of the present disclosure may generally be implemented through the use of one or more computers such as any combination of a provider computer 804, a production computer 806, and a user computer 808 along with, for example, a sales server 812 and a production server 814. A computer generally includes a processor (e.g., 820, 822, 824, 826, 828) operably coupled to a memory (e.g., 830, 832, 834, 836, 838) and configured to send or receive information via an input-output device (e.g., 840, 842, 844, 846, 848).

One of skill in the art will recognize that a processor may be provided by one or more processors including, for example, one or more of a single core or multi-core processors. In certain embodiments, any of provider computer 804, production computer 806, or user computer 808 may be a desktop or laptop computer, tablet, or mobile device. Input-output devices generally includes one or a combination of monitor, keyboard, mouse, data jack (e.g., Ethernet port, modem jack, HDMI port, mini-HDMI port, USB port), Wi-Fi card, touchscreen (e.g., CRT, LCD, LED, AMOLED, Super AMOLED), pointing device, track pad, microphone, speaker, light (e.g., LED), or light/image projection device.

In certain embodiments, a user's selection of options is received via the user's use of user computer 808 and the selection is received at sales server 812 and stored in memory 836. Sales server 812 uses a network card for input/output 846 to received data. Sales server 812 maintains order database 852 which may include accounts 854 where user information is stored (e.g., for payment and delivery information). After orders are received and ready for production, digital files can be transferred via input/output 846 from sales server 812 to production server 814 via input/output 848, which may also be a network card or other data transfer mechanism. Order information (e.g., orders 856) is stored in production database 858 in memory 838. Processor 828 executes computer program instructions stored in memory 838 to perform order batching and to initiate production.

A production facility may be equipped with a production computer 806 which either automatically coordinates the operation of machines or provides information to production employees, e.g., via input/output 842, which could include, for example, a monitor or laser printer. The production computer 806 may also be directly connected to fabrication equipment, such as an additive manufacturing machine.

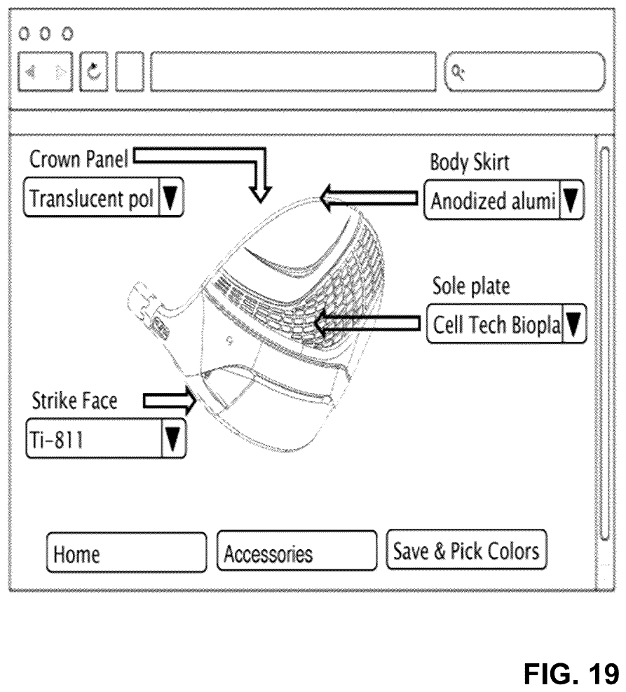

Many of the steps and functions described herein can be planned or coordinated by a provider personnel using provider computer 804. For example, engineers or sales personnel can prepare and upload information (e.g., digital files) that, for example, lists options for features for user selection. That is, in certain embodiments, provider personnel use provider computer 804 to “set up” what options are available, for example, within a display such as the one shown in FIG. 19. Such uploaded information may be saved in memory 836 on sales server 812 and can be used, for example, by processor 826 to cause a display to be rendered such as that shown in FIG. 19 on input/output 844 on consumer computer 808. Input/output 844 can include a monitor displaying a view of a web browser. A user's selection of options can be stored in one of accounts 854 in order database 852 by writing a file in memory 836.

Memory generally refers to one or more storage devices for storing data or carrying information, e.g., semiconductor, magnetic, magneto-optical disks, or optical disks. Information carriers for a memory suitable for embodying computer program instructions and data include any suitable form of memory that is tangible, non-transitory, non-volatile, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); magneto-optical disks; and optical disks (e.g., CD and DVD disks). Memory may also be external to the device and reside on a server or disk in an alternative location, i.e., “the cloud.” The processor and the memory can be supplemented by, or incorporated in, special purpose logic circuitry.

The subject matter described herein can be implemented in a computing system that includes a back-end component (e.g., sales server 812 or production server 814), a middleware component (e.g., an application server or sales sever 812), or a front-end component (e.g., consumer computer 808 having a graphical user interface or a web browser through which a user can interact with an implementation of the subject matter described herein), or any combination of such back-end, middleware, and front-end components. The components of the system can be interconnected through network 802 by any form or medium of digital data communication, e.g., a communication network. Examples of communication networks include cell network (e.g., 4G or 5G), a local area network (LAN), and a wide area network (WAN), e.g., the Internet.

The subject matter described herein can be implemented as one or more computer program products, such as one or more computer programs tangibly embodied in an information carrier (e.g., in a non-transitory computer-readable medium) for execution by, or to control the operation of, data processing apparatus (e.g., a programmable processor, a computer, or multiple computers). A computer program (also known as a program, software, software application, app, macro, or code) can be written in any form of programming language, including compiled or interpreted languages (e.g., C, C++, etc.), and it can be deployed in any form, including as a stand-alone program or as a module, component, subroutine, or other unit suitable for use in a computing environment. Systems and methods of the invention can include instructions written in any suitable programming language known in the art. In certain embodiments, systems and methods of the invention are implemented through the use of a mobile app. As used herein, mobile app generally refers to a standalone program capable of being installed or run on a smartphone platform such as Android, IOS, etc. Functionality of the invention can be implemented by a mobile app or a software application or computer program in other formats included scripts, shell scripts, and functional modules created in development environments.

A computer program does not necessarily correspond to a file. A program can be stored in a portion of a file that holds other programs or data, in a single file dedicated to the program in question, or in multiple coordinated files (e.g., files that store one or more modules, subprograms, or portions of code). A computer program can be deployed to be executed on one computer or on multiple computers at one site or distributed across multiple sites and interconnected by a communication network.

A file can be a digital file, for example, stored on a hard drive, SSD, CD, or other tangible, non-transitory medium. A file can be sent from one device to another over network 802 (e.g., as packets being sent between a server and a client, for example, through a Network Interface Card, modem, wireless card, or similar). Writing a file according to the invention involves transforming a tangible, non-transitory computer-readable medium, for example, by adding, removing, or rearranging particles (e.g., with a net charge or dipole moment into patterns of magnetization by read/write heads), the patterns then representing new collocations of information about objective physical phenomena desired by, and useful to, the user (e.g., a physical arrangement of particles that indicates that a specific, new club head is to be constructed from a certain set of multiple components and sent to a user). In some embodiments, writing involves a physical transformation of material in tangible, non-transitory computer readable media (e.g., with certain optical properties so that optical read/write devices can then read the new and useful collocation of information, e.g., burning a CD-ROM). In some embodiments, writing a file includes transforming a physical flash memory apparatus such as NANO flash memory device and storing information by transforming physical elements in an array of memory cells made from floating-gate transistors. Methods of writing a file can be invoked manually or automatically by a program or by a save command from software or a write command from a programming language.

An embodiment for a user interface 870 for a system of the invention (such as, e.g., input-output 844 of system 800 of FIG. 18) is shown in FIG. 19. The interface 870 may be a website, a smart phone or tablet application. Using the interface 870, a user can select properties of a customized head that will be fabricated and provided to the user or assembled into a golf club. The interface 870 can include options for multiple features that are available with a club head. The interface 870 can receive selections from a user of various options and then retrieve suitable design parameters for fabricating the customized head. FIG. 19 generally shows an exemplary display as could be shown on a screen, for example, of a computer or smartphone, discussed in more detail below. In certain embodiments, FIG. 19 represents a display rendered in a web browser (e.g., a web page).

As shown in FIG. 19, the interface 870 can include elements such as pull-down menus for choosing options. Any method of offering options and receiving selections is included, such as, for example, point-and-click selection, keyboard entry, radio buttons, and confirmation of suggested options. A selection of an option can include selecting a given option from a set of possibilities and it can also include selecting whether or not to include a certain feature at all. For example, a user can be offered whether or not they would like a removable crown panel on their club head and, if they choose so, they can then be offered a list. Options can be offered and selections received for any aspect of a club head including all of those discussed herein. For example, the choices of crown panel materials in FIG. 19 could include clear plastic, translucent plastic, composite, carbon fiber, titanium, aluminum, or other alloys. Although the interface 870 of FIG. 19 depicts a wood-type club head, it will be appreciated that the system 800 and interface 870 are not limited to a particular type of club head and, thus, can be used in connection with any club head type, including iron-type club heads (see FIGS. 1-10) and putter-type club heads.

The same or other interfaces will provide the user with a variety of design choices with respect to a number of components (such as, e.g., club shaft, club grip, club head). A plurality of interfaces may be used to design a set of clubs or a single interface can be used to select, e.g., shaft and grip, and then a plurality of nested interfaces or pop-ups can be used to select individual club heads for the set. A user could be offered choices of bodies and body materials. Choices of certain bodies may govern the availability of certain other choices. For example, some bodies may have a forward member for supporting a strike face and a body skirt member upon which a crown panel and sole plate are to be installed. Where a user chooses such a body, they may then be offered a choice of sole plate (e.g., with choice of style, material, color, etc.). Other features a user could choose include overall finish of surface (e.g., anodized, painted, decal set, plated, PVD, etc.), strike face, removable/interchangeable weight members, reconfigurable shaft, setting indicator window, user-uploaded photo printed on surface (e.g., as uploaded digitally), number of club heads (e.g., user orders entire set or matching clubs/sets for whole families), etc.

As shown in FIG. 19, receiving user options can be done via a series of related screens. For example, a user can choose materials for parts in a first screen, choose optional accessories in another screen, and save their choices and pick colors in another screen. However, in other embodiments, all choices are made on a single screen or a different combination of screens. In certain embodiments, choices are offered based upon input information such as height, weight, and age, as discussed above. In certain embodiments, choices are suggested based on inferences made according to computer program rules about a user's likely preference. For example, if a user orders a shaft in a given color (e.g., orange), a club head can be shown and suggested with a given matching or complementary color (e.g., orange main material with blue contrast finish details, or all green panels).

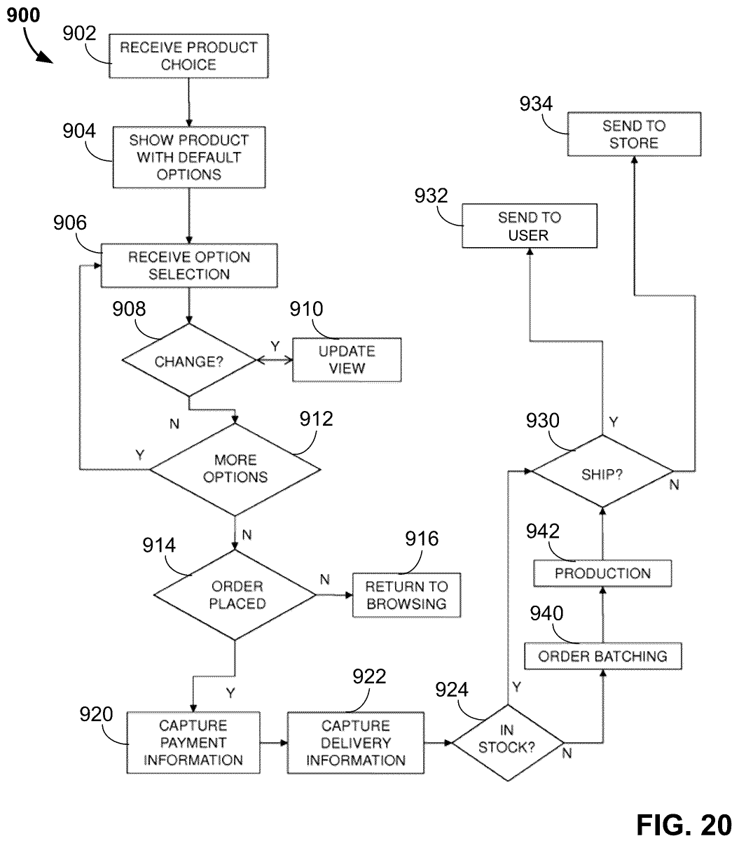

Given the variety of options a user may choose and the variety of numbers a user may order, this disclosure provides methods of receiving and preparing customized orders. Referring now to FIG. 20, a flowchart of a process 900 of providing a customized club head according to certain embodiments of the disclosure is illustrated, which includes fewer or more steps than depicted. Further, the following steps may be performed in any order or sequence and may further include pauses or spans of time in between. The following steps may be performed by a single entity, a single device or system, multiple entities, or multiple devices or systems. The process 900 can include receiving a user's choice of a product (e.g., product line driver club head), as in block 902, and showing the user a product example (such as, e.g., a virtual object displayed on the display screen of FIG. 19), as in block 904. A user's selections of an option are received in block 906 and can be saved in a memory (e.g., one or more of the memory 830, 832, 834, 836, 838 of FIG. 18). At decision block 908, if the selection reflects a change from what was previously shown (e.g., one or more customized features that different from the product with default options shown in block 904 or one or more new selections by user in block 906), the displayed product view can be updated to show what the user has chosen, as in block 910, or the user can be shown more options, as in decision block 912. If the user selects new features at decision block 912, the process 900 can return to block 906, and this can be repeated for as many features as are customizable or as many features as the user chooses to select options for in block 912.

Once the user is satisfied with the selected options (i.e., block 912=NO), the process 900 can move to decision block 914, where the user decides whether to place an order of the customized product selected in block 906. In some embodiments, the user may decide to first purchase a physical prototype or proof of the customized product that is configured for assessment and feedback, after which the user can vary any of the selected options before proceeding to decision block 914. In some embodiments, the user may purchase a virtual prototype, such as an interactive digital model that can be engaged using augmented reality (AR) devices or virtual reality (VR) devices. For example, the user may conduct a functional simulation of the prototype in a virtual golf simulator or using a simulation joystick that provides haptic feedback tuned to reflect the specifications of the customized product. After such virtual simulation, the user may vary any of the selected options before proceeding to decision block 914. If the user ends up not placing an order (i.e., block 914=NO), the user can be returned to browsing (e.g., shown a web page home screen or another product screen), as in block 916, and the user's choices can be saved and displayed to them at a later web page visit.

If the user places an order (i.e., block 914=YES), the process 900 can move to block 920, which can include capturing information from the user about how they will pay for the product, and then to block 922, which can include capturing information from the user about how the user will receive the purchased product. For example, a user can provide a credit card number over a computer network (e.g., by typing into a payment web page) in block 920, and then choose direct shipping and provide their home address in block 922. Or, alternatively, a user can indicate that they wish to use a corporate account (e.g., they are purchasing a dozen club heads that are printed with a corporate logo for which they have uploaded an image file such as a TIFF) in block 920 and they can specify delivery to some site in block 922. A user can also choose in-store pickup in block 922. In certain embodiments, the process 900 of providing a customized club head is operable in conjunction with a special event, and block 922 of the process 900 can include capturing delivery information about providing the club heads at the special event.

After delivery information is captured in block 922, the process 900 can proceed to decision block 924, in which it is determined whether the ordered item is already in stock, as-ordered. If the ordered item in in stock (i.e., block 924=YES), the process 900 can proceed to decision block 930, in which the ordered item is shipped or prepared for delivery according to the user's delivery information. For example, if the user chooses in block 922 that the product be delivered directly to them (i.e., block 930=YES), the purchased item can be sent to the user, as in block 932. On the other hand, if the user chooses in block 922 that the product be picked up in store (i.e., block 930=NO), the purchased item can be sent to a store closest to the user, as in block 934.

If the ordered item is not in stock (i.e., block 924=NO), the process 900 can proceed to block 940, in which the order is batched. After order batching in block 940, order information (e.g., information regarding batches, production schedules, and individual orders of club heads, including design files thereof) is transmitted to a production system or facility, and the ordered club heads are produced (such as, e.g., by an additive manufacturing machine or system or by the fabricator 720 of FIG. 17), as in block 942. In some embodiments in which an additive manufacturing machine or system are utilized, the process 900 can include one or more additional steps after order batching, as in block 940, and before club heads are produced, as in block 942. For example, in such embodiments, the process 900 can further include preparing design files for printing, which can include adding polishing to stock items, machining material from stock items (such as, e.g., on a face of an iron-type club head), adding material to stock items (such as, e.g., to areas where additive manufacturing build supports will be placed during printing), among others. In some instances, a recording device, e.g., a camera or webcam, captures a recording of steps of the production system during the production of the component being produced, such as the club head.

After production is complete in block 942, the process 900 can proceed to decision block 930, in which the produced club heads are sent to the user according to the user's choice in block 922. If a user has ordered a club to be shipped to their home in block 922, the club is sent to the user directly, as in block 932. If a user has requested in-store pickup in block 922, the club is sent to the store, as in block 934. If a user has requested another delivery option in block 922, it is so initiated. In some embodiments, the produced club heads may be shipped to another facility where they are assembled into clubs, or the club heads may be assembled into clubs on site. In some embodiments, block 922 can include options for delivery of a digital design model of the purchased golf club head in block 920 to the user. In such embodiments, the user can produce the purchased golf club head in block 920 via an additive manufacturing machine or system that receives the digital design model the golf club head. Further, the recording or a link (e.g., a URL) to the recording of the production of the component, e.g., the purchased club head, may be provided to the user via digital delivery, e.g., by email or text message.

It is contemplated that a design model of a customized golf club or golf club component produced by systems and methods described herein (such as, e.g., at block 404 of method 400 of FIG. 14, at block 516 of method 500 of FIG. 15, block 608 of method 600 of FIG. 16, or block 724 of method 700 of FIG. 17) can be provided to a user or fabricator to form the golf club or golf club component, such as, e.g., with an additive manufacturing machine that receives the design model and forms the component. Thus, it may be beneficial, both for a user and for a producer of the design model, to provide a means to track the dissemination of the design model and to verify that a tangible fabricated golf club component corresponds to a particular design model.

Accordingly, some embodiments of systems and methods of the present disclosure can include or utilize mechanisms (e.g., systems, methods, and media) for generating digital assets authorized by cryptographic tokens, e.g., non-fungible tokens (NFTs), and which correspond to physical objects (such as, e.g., golf clubs, golf club components, articles of apparel, or articles of footwear), or which are associated with a golf club fitting process or system. In some embodiments, this disclosure relates to cryptographic digital assets for articles or objects that may be tangible objects (such as, e.g., golf clubs, golf bags, footwear, apparel, headgear, or sporting gear, among other products) or intangible objects (such as, e.g., graphic designs, virtual avatars or characters, graphic user interfaces (GUIs), or other forms of digital communication).

Further, aspects of this disclosure can create or utilize cryptographic digital assets associated with golf club fitting processes and systems, and methods for provisioning of such cryptographic digital assets and articles, and decentralized computing systems with attendant blockchain control logic for mining, exchanging, collaborating, modifying, combining, and/or blending blockchain-enabled digital assets and articles. The presently described technology relies on the trust established in and by blockchain technology to enable a company to control the creation, distribution, expression, and use of digital objects that represent their brand. Unlike typical digital assets that are freely reproducible without loss of content or quality, the use of discrete recordation of ownership via blockchain technology eliminates the ability for simple digital reproductions of the digital objects. In doing so, the manufacturer has the ability to control or limit the overall supply of the digital objects or traits/aspects thereof and may create a controlled scarcity if so desired. The present disclosure contemplates that, in some examples, the digital object may be representative of a physical object offered for sale, a two-dimensional (2D) or 3D design rendering or design file that may be suitable for subsequent physical production, a virtual representation of an object that is not presently intended for subsequent physical production, or other such objects. Further, some embodiments of the present disclosure can include or utilize mechanisms for generating cryptographic tokens using virtual reality (VR), augmented reality (AR), and/or GUIs on computing devices.

Aspects of the present disclosure can further include or utilize mechanisms that bridge the divide between the physical world and the digital realm. For example, according to some embodiments of the present disclosure, individuals can customize a digital product, mint an NFT of the digital product, and receive a physical product corresponding to both the digital product and the NFT. In some examples, individuals purchase a physical product, receive a digital product corresponding with the physical product, and an NFT is minted of the digital product. As another example, users may participate in a golf club fitting process that uses a fitting system, and the users may receive an NFT that is minted with metadata based on data collected throughout the fitting process.

Further, in some embodiments, users can develop a personal user account that is registered with the original manufacturer of the tangible golf clubs, e.g., a Cobra Fam account, which is linked to the user's cryptographic wallet and allows the user access to a platform for viewing, purchasing, forming, selling, trading, minting, and burning digital assets and associated cryptographic tokens that may or may not be linked to or representative of tangible goods.

As used herein, “cryptographic digital assets,” or simply “digital assets” may refer to any computer-generated virtual object, including digital clubs, club sets, golfing gear, footwear, apparel, headgear, avatars, art, collectables, tickets, coins, creatures, or sub-elements thereof, etc., among other virtual objects, that have a unique, non-fungible tokenized code or “token” registered on and validated by a blockchain platform or otherwise registered in an immutable database. Further, the digital asset may be a digital-art version of a tangible, physical object or an object disassociated with tangible, physical objects. For example, the digital asset may be a digital-art version of physical golf clubs having the same or substantially the same appearance. Alternatively, the digital asset may be digital golf clubs generated within the physical realm and without being connected to or representative of physical golf clubs. Further, the digital asset may become physical through various techniques, such as by manufacturing methods based on aspects of the digital golf clubs that are taken as inputs to create the physical golf clubs.

Some embodiments of the present disclosure can produce or utilize computer-generated virtual or digital collectables or assets, such as digital golf clubs or golf club components, or digital articles of apparel (such as, e.g., jackets, shirts, pants, shorts, hats, necklaces, or watches). According to some embodiments, the digital collectables may be secured and/or uniquely identified by a cryptographic token (e.g., an NFT). The digital asset may be linked and/or distributed with real-world, physical products, such as tangible golf clubs and/or tangible articles of apparel. The digital assets may be linked or distributed with a 2D or 3D design file such as a computer-aided design (CAD) model, graphical rendering, image, or drawings package from which a physical product may be formed, constructed, or otherwise represented.

In some embodiments, an authenticated golf club component, golf club, or golf club set is created and assigned a UPID. Upon purchase by a consumer, the UPID may be used to unlock a cryptographic digital asset composed of a collectable golf club component, golf club, or golf club set and a unique NFT operating on a block-chain based distributed computing platform. In general, a consumer must have or procure a blockchain wallet address (e.g., an Ethereum hardware wallet) to purchase, unlock, or acquire a cryptographic asset. The blockchain wallet may be used to store a private key belonging to the cryptographic asset and may be linked to a personal account that is registered with the original manufacturer of the physical golf club component, golf club, or golf club set.

In some embodiments, the data associated with the user may include physical attributes, e.g., height, weight, arm length, and the like, or preferences, e.g., right hand or left hand dominance, or performance parameters, e.g., swing speed, club head location control, or other data associated with a golf club or a game of golf.

In some embodiments, the data associated with a physical or digital product includes, e.g., data associated with a golf club. For example, in some examples, the data associated with the golf club can include: club type, club shaft type, club shaft length, club shaft stiffness, club shaft material (e.g., steel, graphite, composite, or combinations thereof), club shaft shape (e.g., cylindrical, elliptical or ovular, tapered, single bend, double bend, etc.), club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head center of gravity location, club head moment of inertia value, club head product of inertia values, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto (e.g., number of weight receptacles, arrangement of weight receptacles, size of weight receptacles and corresponding weight members, weight member material, weight member density, etc.), club head weight members, club head finish type (e.g., anodized, painted, plated, physical vapor deposition (PVD), etc.), club head insignia, club head medallion design, club price, number of clubs of the golf club set, and manufacturing information.

In some embodiments, the golf club NFT may be a digital asset stored in the blockchain network. The golf club NFT may include metadata corresponding to a digital golf club (e.g., a 2D representation or model, or a 3D representation or model of a virtual golf club), and a golf club token ID. The golf club token ID may be a 32-bit, 64-bit, or 128-bit alphanumeric code that is sectioned into individual segments. For example, the alphanumeric code may be sectioned into 2 segments, 4 segments, 8 segments, 16 segments, or 32 segments. One or more of the code segments may correspond to common attributes between the digital golf club and a physical golf club corresponding to the digital golf club. Additionally, or alternatively, the one or more code segments may correspond to attributes of solely the physical golf club, or solely the digital golf club. For instance, the golf club NFT and token can be built in accordance with contemporary and relevant standards, such as, e.g., ERC-721 or ERC-1155 standards, among other relevant standards and as appropriate for the particular blockchain network and applications used therewith.

For example, the code segments may include metadata corresponding to one or more attributes from the group of: a golf club image, golf club handing (i.e., left hand or right hand orientation), golf club size, golf club type, golf club fit, golf club color, golf club model, manufacturing information (e.g., location of manufacture, date of manufacture, etc.), or date of purchase. Additional combinations of the above-listed attributes should be recognized by those of ordinary skill in the art.

The attribute golf club type may comprise metadata corresponding to a putter, iron, fairway or wood, hybrid, or driver. The attribute golf club handing may comprise metadata corresponding to left hand or right hand. The golf club size may comprise metadata corresponding to shaft length in U.S. Men's sizes. It should be understood that metadata may correspond to similar sizes in Women's sizes, children's sizes, unisex sizes, and shaft length measurements of foreign countries. The attribute golf club model may comprise metadata corresponding to a subset or species of the type of golf club type. For example, the golf club model may comprise metadata corresponding to a 1-wood, 3-wood, 5-wood, 7-wood, and so on. The golf club model may comprise metadata corresponding to a 1-iron, 2-iron, 3-iron, 4-iron, 5-iron, 6-iron, 7-iron, 8-iron, 9-iron, pitching wedge, approach wedge, gap wedge, sand wedge, or a lob wedge. The golf club color segment may comprise metadata corresponding to Black, Gray, Brown, Blue, Green, Orange, Tan, Yellow, Red, White, Multi-Colored, or Pink. The golf club fit segment may comprise metadata corresponding to various fit and performance measurements.

A golf club NFT according to aspects of the present disclosure may be formed, minted, stored, accessed, or otherwise provided by any of the systems or methods described in U.S. patent application Ser. Nos. 17/747,226 and 17/891,481, which are all commonly assigned to Cobra Golf, Inc. and incorporated by reference herein in their entireties.

Generally, by incorporating, i.e., providing and linking, metadata into the NFT that corresponds to attributes of a physical golf club, the digital golf club corresponding to the NFT will be linked to the physical golf club. For example, the digital golf club may appear to be the same size, color, and material on a display screen as a corresponding physical golf club. In some embodiments, the metadata includes reference to a UPID that corresponds to the physical code, or a version thereof, associated with the physical golf club, thereby linking the golf club NFT to the physical golf club in a one-to-one fashion. In some embodiments, the golf club NFT may be provided as a collection or family of golf club NFTs having, e.g., variations or permutations in attributes or appearance or underlying metadata, but with each golf club NFT in the collection being linked to the same physical golf club by way of reference to the UPID in the metadata. In this way, one common physical golf club can be linked across multiple golf club NFTs that are generated as a collection of golf club NFTs each containing unique digital golf club. The golf club NFTs can, therefore, be a collection of two (2) or more, such as, e.g., a collection of 3, 4, 5, 6, 7, 8, 9, 10, 11, 12, or more, a collection of 20 or more, a collection of 50 or more, a collection of 100 or more, a collection of 250 or more, or a collection of 500 or more.

It is contemplated that the methods and systems described herein can utilize a golf club fitting system, and corresponding fitting data, such as any of the systems or methods described in U.S. patent application Ser. No. 17/747,226 which is commonly assigned to Cobra Golf, Inc. and incorporated by reference herein in its entirety.

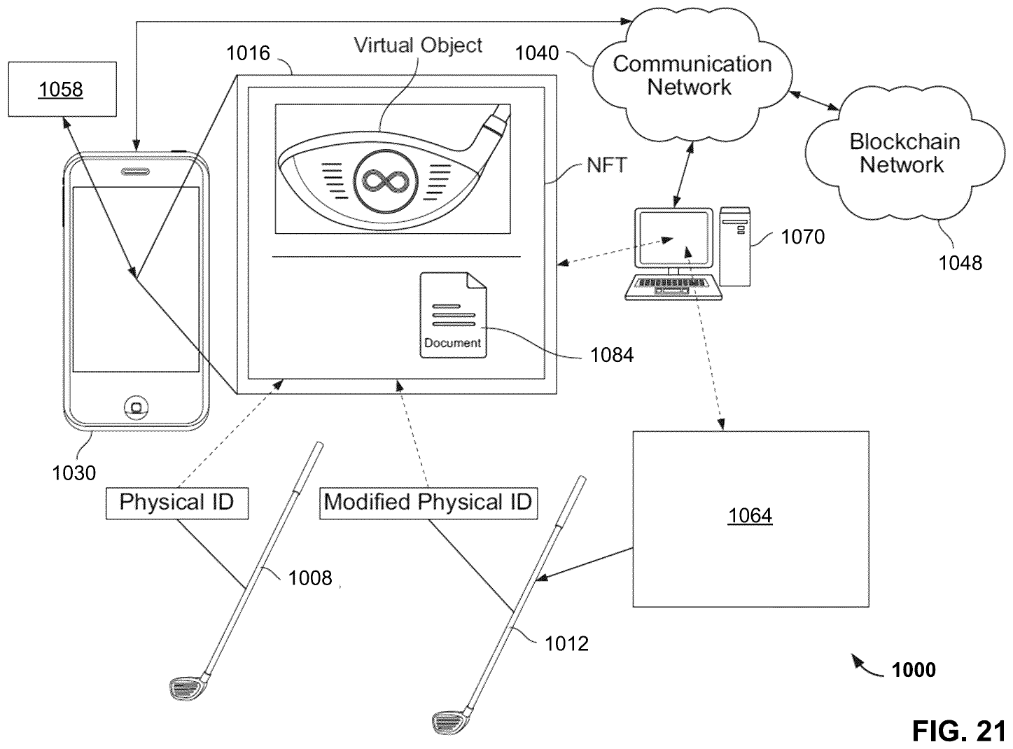

Turning to FIG. 21, a production system 1000 may be provided that allows custom modifications to the physical golf club to be recorded as data, e.g., modifying or adding segments to the physical ID, which is capable of being updated in the metadata of the NFT. For example, a Brand may offer a stock or base model of a physical golf club 1008 having a corresponding physical ID. The Brand can also offer customization services, such as, e.g., shaft length adjustment, engraving or embossing initials on the club head, exchanging a weight insert or a face insert, weight distribution and/or center of gravity customization, or other modifications. Each customization service may be associated with a unique ID that can be included with the physical ID of the physical golf club, such that the physical ID of the physical golf club is modified to correspond to the modification of the customization service, resulting in a modified physical ID associated with a modified or customized golf club 1012. In some embodiments, multiple customization services may be performed on the physical golf club and, thus, multiple unique IDs may be included with the physical ID. After the physical ID is updated with the unique ID of the customization service, the updated physical ID of the physical golf club or the unique ID alone may be communicated to a digital platform 1016 through the user device 1030 to update the metadata of the NFT or the metadata of the digital asset associated with the NFT, linked to the physical golf club 1008. The user device 1030 is in communication with the digital platform 1016 via a communication network 1040. A blockchain network 1048 and a digital wallet 1058 are accessible through the communication network 1040. In the illustrated embodiments, the user device 1030 is configured to display the digital platform 1016 where the NFT can be accessed. In some embodiments, the NFT can be viewed from a different platform or program than the digital platform 1016.

The production system 1000 includes a manufacturing system 1064, which may include one or more additive manufacturing machines or systems, such as a 3D printer capable of working with one or more materials, for example, any of the materials described herein. Further, the manufacturing system 1064 can be configured to perform a variety of manufacturing techniques, such as computer numerical control (CNC) machining, fused filament fabrication (FFF), direct metal laser sintering (DMLS), atomic diffusion additive manufacturing (ADAM), cold spray additive manufacturing (CSAM), metal injection molding (MIM), binder jetting (BJ), multi jet fusion (MJF), powder bed fusion (PBF), material extrusion, directed energy deposition (DED), sheet lamination, selective laser melting (SLM), electron beam melting (EBM), sintering, or the like. The manufacturing system 1064 is in communication with a computing device 1070 that is connected to the communication network 1040. Accordingly, the manufacturing system 1064 is configured to communicate with the digital platform 1016 via the computing device 1070. The manufacturing system 1064 used to modify or manufacture the golf club 1012 or components thereof, such as the golf club head or the shaft, can include any of the systems or methods described in U.S. patent application Ser. Nos. 16/852,327, 16/852,330, 16/933,129, 16/815,303, 16/852,332, and 16/852,324, which are all commonly assigned to Cobra Golf, Inc. and incorporated by reference herein in their entireties. Additionally, the manufacturing system 1064 may be used to modify or manufacture other articles, such as a headcover for a golf club, and may include the systems and methods described in U.S. application Ser. No. 17/012,837, which is assigned to Cobra Golf, Inc. and incorporated by reference herein in its entirety.

The NFT can represent a digital asset that includes a virtual object 1080 and a design model 1084. The design model 1084 may be a computer aided design (CAD) file, which may be converted to a stereo lithography (.stl) file that can instruct the manufacturing system 1064 for processing. Additionally or alternatively, a variety of CAD file formats may be used, such as, e.g., STEP, QIF, JT, 3D PDF, IGES, ACIS, Parasolid, among other suitable file formats for communicating with the manufacturing system 1064. The NFT represents a digital asset that includes the design model and metadata associated with the design model. The design model may be hosted off-chain on a server or computing device and accessible through the NFT via a URL. Further, metadata of the NFT or associated digital assets can include attributes or properties that are hosted off-chain on a server or computing device and accessible through the NFT via a URL. The attributes or properties may be editable or mutable by authorized users, such as employees or affiliates of the Brand, or certain third-parties, or purchasers of the NFT. The design model is configured to represent the golf club with specifications that are unique to the user, or which are capable of being edited and customized to become unique to the user. That is, by accessing the attributes of the metadata, or by accessing the design model itself, the user may customize the golf club represented by the design model. To that end, the Brand may provide access to the digital platform 1016 that is configured to display the NFT.

In the illustrated embodiment, the NFT held by the user, such as in the digital wallet 1058, includes the design model 1084 and is integrated with or accessible through the digital platform 1016. In some instances, the user may select certain customization services to be performed on the stock golf club 1008. In some examples, the user has possession of the stock golf club 1008 and must then ship or deliver the stock golf club 1008 to the Brand; alternatively, the Brand may pull the stock golf club 1008 from their inventory upon receiving a request to perform a customization service. The virtual object 1080 of the NFT may be a virtual representation of the stock physical golf club 1008, or the virtual object 1080 may be an artistic rendering of a golf club, or any item or object corresponding to the physical item being customized in the production system 1000. The design model 1084 may be used to generate the virtual object 1080, or the virtual object 1080 may be generated and stored separately from the design model 1084. The virtual object 1080 may be modifiable, such that customizations to the stock physical golf club 1008 are reflected in the virtual object 1080.

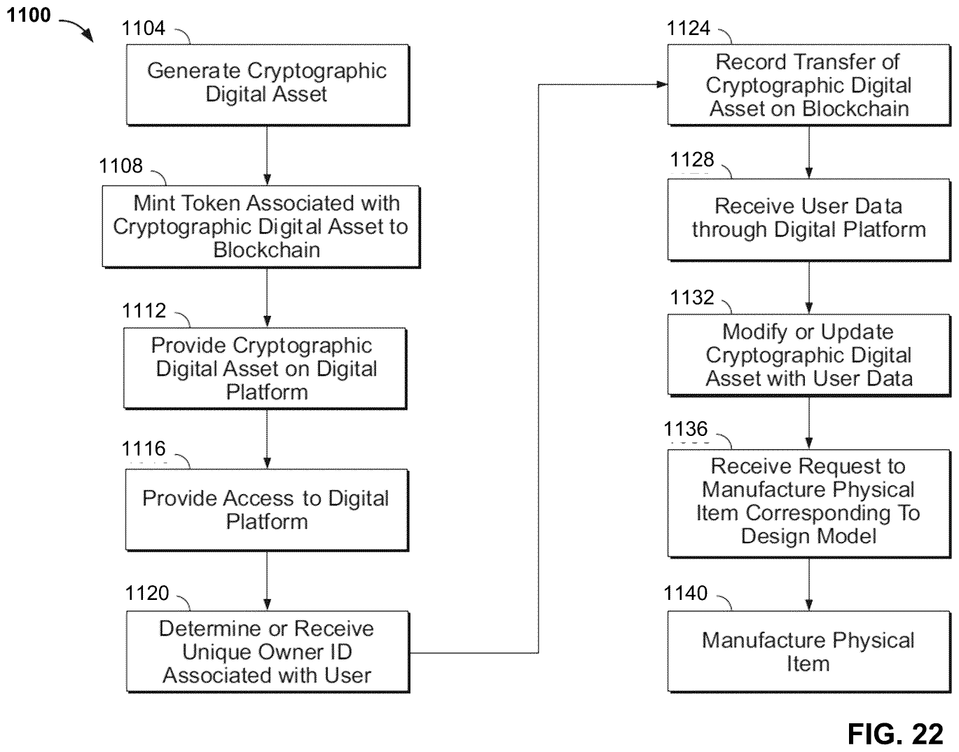

With reference to FIG. 22, a process 1100 of using the production system 1000 of FIG. 21 may include several steps, which may be sequenced or arranged in a variety of ways. In block 1104, the Brand generates a cryptographic digital asset, to include the virtual object 1080 and metadata. The digital asset may include the design model 1084 in the metadata, or the design model may be included with the virtual object 1080. In block 1108, the Brand mints an NFT to the blockchain network 1048, thereby recording the creation date and transaction data associated with the NFT and design model. The NFT can then be used to authenticate the cryptographic digital asset, which can, for example, include the virtual object 1080, the design model 1084, and any associated metadata. In block 1112, the Brand provides access to the digital platform 1016 through which users may access, view, and conduct transactions with the NFT. The digital platform 1016 may require users to enter login information or to register an account to access the digital platform 1016 for access or use, as in block 1116. Then, the Brand can determine or receive a unique owner ID associated with that particular user upon registration to the digital platform 1016, as in block 1120. Such registration may require the user to link their digital wallet 1058 to the digital platform 1016 to conduct transactions and authenticate the unique owner ID.

After the user has linked the digital wallet 1058 to the digital platform 1016, the user can access the NFTs that authenticate the design models. That is, the NFTs are offered for purchase on the digital platform 1016 by registered users. Accordingly, as in block 1124, users may select the NFT and initiate a transaction to transfer the NFT to the linked digital wallet 1058, and such transaction is recorded on the blockchain network and the NFT is stored in the user's digital wallet 1058. In block 1128, the digital platform may receive user data or information for customization of the stock golf club 1008, or for the custom manufacture of an entire golf club or clubs. Accordingly, the user may select various editable customization features to build the customized golf club or clubs.

The editable customization features may be selected from a menu of predetermined settings or styles or features or aspects. For example, in some embodiments, the editable customization features can include: club type, club shaft type, club shaft length, club shaft stiffness, club shaft material (e.g., steel, graphite, composite, or combinations thereof), club shaft shape (e.g., cylindrical, elliptical or ovular, tapered, single bend, double bend, etc.), club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head center of gravity location, club head moment of inertia value, club head product of inertia values, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto (e.g., number of weight receptacles, arrangement of weight receptacles, size of weight receptacles and corresponding weight members, weight member material, weight member density, etc.), club head weight members, club head finish type (e.g., anodized, painted, plated, physical vapor deposition (PVD), etc.), club head insignia, club head medallion design, club price, number of clubs of the golf club set, and manufacturing information.

In some embodiments, additional aspects of the golf club may be selected and configured based on user input, such as, e.g., color, finish, club head materials, center of gravity, impact location, sensor type, sensor configuration, embossing or engraving, location and/or configuration of machine-readable identifiers, and the like. In this way, the digital platform 1016 offers users the ability to build the customized golf club or clubs 1012. Accordingly, users having greater experience and knowledge of the game of golf and golf clubs will be capable of specifying the features and aspects to build their golf club or clubs. In some embodiments, the digital platform 1016 offers a customization guide that receives information in the form of a selection of predetermined criteria specific to the user's age, height, weight, sex, right or left handedness, skill level, and preferences to generate a set of options or recommendations of customized golf clubs built for the user to select from. In this way, the digital platform 1016 builds the customized golf club or clubs 1012 to suit the user′ preferences. Accordingly, users with less experience and knowledge of golf and golf clubs will prefer the customization guide, which provides user's the option to answer more basic, personalized questions about themselves and their experience and allow the digital platform 1016 to build the golf club or clubs to suit their needs.

During or after the user data is received through the digital platform 1016, the design model and/or attributes of the metadata of the digital asset secured by the NFT associated with the design model are updated based on the user data, as in block 1132. That is, the design model 1084 is updated to represent the customized golf club or clubs 1012 based on the aspects and features selected by the user or based on the selected options or recommendations provided by the customization guide. Upon finalization of the customized golf club 1012, the digital platform 1016 may receive a request to manufacture the physical customized golf club or clubs 1012 corresponding to the design model 1084 specifications of the customized golf club authenticated by the NFT, as in block 1136. In some embodiments, the request includes the unique owner ID of the user for verification. In some embodiments, a transaction is recorded on the blockchain network to represent the request to manufacture the customized golf club. For example, the request may include the user transferring the NFT to the Brand to initiate the manufacture of the customized golf club or clubs. In some embodiments, the request may be a separate transaction that is linked to the NFT or the associated digital asset, such that the metadata, which may be the attributes, are updated based on the transaction. Then, in block 1140, the Brand utilizes the manufacturing system 1064 to manufacture the physical golf club or clubs corresponding to the design model 1084 authenticated by the NFT. In some embodiments, the design model 1084 may contain software instructions associated with the customized golf club or clubs for use with the manufacturing system 1064. In some embodiments, the design model 1084 can be provided to the user and the user can utilize the manufacturing system 1064 to manufacture the physical golf club or components thereof corresponding to the design model 1084 authenticated by the NFT.

In some embodiments, the Brand or the user can initiate the communication of the updated physical ID or unique ID to the digital platform 1016 to update the metadata of the digital asset secured by the NFT. In some embodiments, the base model of the physical golf club and the NFT are pre-linked, prior to purchase, and offered by the Brand as a package. Thus, the NFT already includes the physical ID of the physical golf club 1008 or 1012. In some embodiments, the NFT may be linked to a set of physical golf clubs, or to a golf ball, or to other articles, such as, e.g., footwear, a golf bag, headcovers, apparel, or the like.

The Brand may use the production system 1000 to offer custom manufactured golf clubs to select users or to a select echelon of users holding certain digital assets. To that end, the Brand generates digital assets in the form of NFTs that authenticate design models, such as the design model 1084, that are configured provide instructions readable by an additive manufacturing system or machine, such as the manufacturing system 1064, for manufacturing a customized physical golf club or a component thereof (such as, e.g., golf club heads 100, 200 of FIGS. 1-10) represented by the design model. The design model may correspond to a single golf club, such that users may purchase multiple NFTs with design models to accumulate a full set of clubs. In some embodiments, one design model may be inclusive of multiple golf clubs or a full set of clubs. The Brand may mint the NFT to a decentralized ledger, such as a blockchain network 1048. The blockchain network may be a permissionless, public ledger, such as Ethereum. In some embodiments, the blockchain network is private and requires authentication and permission for only authorized users. In such instances, the Brand may be the corporate host or administrator of the private blockchain network and, thus, the Brand may determine which individuals or entities can be authorized users.

It is contemplated that tangible golf clubs, or components thereof (such as, e.g., golf club heads 100, 200, 300 of FIGS. 1-12) formed or fabricated via any of the method or processes described herein may include markings that correspond to the digital file utilized to form the golf club component. For example, referring again to the golf club head 200 of FIGS. 5-8, the fabricated golf club head 200 can include a plurality of markings (not shown) provided on the exterior of the body 204, such as, e.g., on the topline 224 or the face 208. In some embodiments, the fabricated golf club head 200 can include a plurality of markings provided portions of the lattice structure 290, such as, e.g., the external lattice portion 288. The plurality of markings of the club head 200 may contain a code or identifier, such as, e.g., a machine-readable identifier. The code can be used to authenticate the golf club head 200, such that the code is associated with a serial number or unique ID, or a token or key, which can be scanned by, e.g., the user device 1030, which may be a smartphone or special purpose scanning device, such as those employing near field communication (NFC) technologies, or the like. The code may correspond to encoding parameters stored in a remote host system, such as a Brand host system or the digital platform 1016, and the encoding parameters can include a manufacturing date, manufacturing location, identification of the manufacturer, serial number or unique ID, numbers associated with modifications or customized features, aspects of the golf club head, such as model and type, materials, numbers associated with the quantity of items produced, such as for limited edition products, among others. Further, the code may require the user device 1030 or scanning device to implement symmetric or asymmetric encoding algorithms or methods, such as, e.g., advanced Encryption Standard (AES), Rivest-Shamir-Adleman (RSA), Triple Date Encryption Standard (DES), Twofish, or any other suitable encryption method. In some instances, the code may be compatible with hashing functions or algorithms implemented by the user device 1030 or scanning device, such as, e.g., Secure Hash Algorithms (SHA) published by the National Institute of Standards and Technology (NIST), or equivalents. It is contemplated the user device 1030 or the scanning device must run particular operating systems or applications to implement such methods for reading the code, although in some instances the code may be pre-programmed to, upon detection by a sensor or camera, automatically initialize a browser to search a web address (e.g., a URL) for accessing the necessary software to read the code.

The code of the golf club head 200 may resemble a barcode, a QR code, or a cipher containing unique symbols or unique combinations of symbols, or colors, or the like. In some instances, the golf club head 200 includes a portion, e.g., the topline 224, that is formed with programmable particles, such as, e.g., embedded ferromagnetic elements or ferrimagnetic elements, which are arranged to form magnetic zones having discrete, predetermined magnetic property values, e.g., magnetic flux density values, such that a magnetometer, e.g., a gaussmeter or teslameter, may be used to measure the magnetic property values that, in combination, correspond to the serial number or unique ID associated with the golf club head 200. It will be appreciated that programmable particles may include a variety of materials, such as, e.g., a rare earth element, including ceramic or ceramic-like materials, which may include Neodymium. When scanned, the code may enable access, via the user device 1030, to the digital platform 1016, or to a secured website or address or application that is hosted remotely having at least part of a cryptographic key or token, such as the ModToken or private key, which corresponds to or unlocks a digital asset secured by an NFT, which includes the corresponding design model (such as, e.g., design model 1084 of FIG. 21) or the unique ID or serial number associated with the golf club head 200. In this way, the golf club head 200 may be authenticated by the user for assurance that the golf club head 200 is manufactured by the Brand. Further, the code may provide authentication of the custom features of the golf club head 200. Additionally, the face member 208 may include similar machine-readable identifiers, such as in the grooves 240 formed on the face front surface 238, as illustrated in FIG. 7.

In some embodiments, the code of the golf club head 200 is readable by authorized third-parties for tracking purposes. For example, entities throughout the supply chain, such as shipping companies, may scan the code for tracking purposes. In some instances, the code may be used for inventory tracking purposes, such that wholesalers, retailers, and fitting professionals may scan the code to update an inventory management system. In some examples, the web address or digital platform 1016 may be capable of tracking and recording the identity, such as the device ID or product ID, of each entity that has obtained access. Further, the user may be given the ability to access the web address prior to receipt of the golf club head 200, such as via an email or secure notification through or on the digital platform 1016. In this way, the code may assist the user in locating the golf club head 200 in the event of loss or theft, or to identify unauthorized access by, e.g., counterfeiters.

It should be appreciated that other types of golf club heads that are different than golf club head 200 of FIGS. 5-10 (or golf club head 100 of FIGS. 1-4) can be fabricated with similar markings for similar purposes as described above. For example, referring again to the golf club head 300 of FIGS. 11 and 12, the customized face member 308 may be represented by the virtual object 1680 and authenticated by the NFT. In this way, users are afforded a visual depiction of the customized face member 308, particularly the customized pattern or arrangement on the face rear surface 336 that is often concealed and inaccessible to users without permanent deformation of the golf club head 300. Further, users may store data associated with their customized face member 308, such as the relative or geometric locations of the impact point 360 and/or the center of gravity, in the metadata of the digital asset secured by the NFT for authentication of a user's arrangement or “fingerprint” on the golf club head 300.

Additionally, the customized insert 370 may be represented by the virtual object 1680 and authenticated by the NFT. In this way, users are afforded a visual depiction of the customized insert 370 that is often concealed and inaccessible to users without permanent deformation of the golf club head 300. Further, users may store data associated with their customized insert 370 in the metadata of the NFT for authentication of the user's arrangement or “fingerprint” on the golf club head 300. For example, in some embodiments, data associated with the customized insert in metadata of an NFT can include: club type, club shaft type, club shaft length, club shaft stiffness, club shaft material, club shaft shape, club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head center of gravity location, club head moment of inertia value, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto, club head weight members, club head finish type, club head insignia, club head medallion design, club price, number of clubs of the golf club set, and manufacturing information.

Further, at least one of the markings 390, 392, 394 may contain a code or identifier, such as, e.g., a machine-readable identifier. The code can be used to authenticate the golf club head 300, such that the code is associated with a serial number or unique ID, or a token or key, which can be scanned by, e.g., the user device 1030, which may be a smartphone or special purpose scanning device, such as those employing near field communication (NFC) technologies, or the like. The code may correspond to encoding parameters stored in a remote host system, such as the Brand host system or the digital platform 1016, and the encoding parameters can include a manufacturing date, manufacturing location, identification of the manufacturer, serial number or unique ID, numbers associated with modifications or customized features, aspects of the golf club head, such as model and type, materials, numbers associated with the quantity of items produced, such as for limited edition products, among others. Further, the code may require the user device 1030 or scanning device to implement symmetric or asymmetric encoding algorithms or methods, such as, e.g., advanced Encryption Standard (AES), Rivest-Shamir-Adleman (RSA), Triple Date Encryption Standard (DES), Twofish, or any other suitable encryption method. In some instances, the code may be compatible with hashing functions or algorithms implemented by the user device 1030 or scanning device, such as, e.g., Secure Hash Algorithms (SHA) published by the National Institute of Standards and Technology (NIST), or equivalents. It is contemplated the user device 1030 or the scanning device must run particular operating systems or applications to implement such methods for reading the code, although in some instances the code may be pre-programmed to, upon detection by a sensor or camera, automatically initialize a browser to search a web address (e.g., a URL) for accessing the necessary software to read the code.

The code of golf club head 300 may resemble a barcode, a QR code, or a cipher containing unique symbols or unique combinations of symbols, or colors, or the like. As illustrated in FIG. 12, the second and third markings 392, 394 include indicia comprising stripes and bars which can be printed on the crown 324 in accordance with the encoding algorithm that determines the appropriate identifying aspects of the indicia, such as the size, color, shape, and arrangement of the strips and bars, to store and communicate information. In some embodiments, the markings 390, 392, 394 may be formed with conductive ink or ferromagnetic elements comprising the code. For example, the markings 390, 392, 394 may include conductive ink arranged to comprise electrical resistance values in discrete, predetermined locations, such that the combination of such values corresponds to a serial number or unique ID associated with the golf club head 300. In some instances, the crown 324 is formed with embedded ferromagnetic elements or ferrimagnetic elements which are arranged to form magnetic zones having discrete, predetermined magnetic property values, e.g., magnetic flux density values, such that a magnetometer, e.g., a gaussmeter or teslameter, may be used to measure the magnetic property values that, in combination, correspond to the serial number or unique ID associated with the golf club head 300. When scanned, the code may enable access, via the user device 1030, to the digital platform 1016, or to a secured website or address or application that is hosted remotely having at least part of a cryptographic key or token, such as the ModToken or private key, which corresponds to or unlocks a digital asset secured by an NFT, which includes the design model 1084 or the unique ID or serial number associated with the golf club head 300. In this way, the golf club head 300 may be authenticated by the user for assurance that the golf club head 300 is manufactured by the Brand. Further, the code may provide authentication of the custom features of the golf club head 300. Additionally, the crown 324 may be provided or formed with the aerodynamic features 396 (see FIG. 12) that may form a topology that can comprise the code or part of the code that is scanned. Additionally, the face member 308 may include similar machine-readable identifiers, such as in grooves 340 formed on the face front surface 338, as illustrated in FIG. 12.

In some embodiments, the code of the golf club head 300 is readable by authorized third-parties for tracking purposes. For example, entities throughout the supply chain, such as shipping companies, may scan the code for tracking purposes. In some instances, the code may be used for inventory tracking purposes, such that wholesalers, retailers, and fitting professionals may scan the code to update an inventory management system. In some examples, the web address or digital platform 1016 may be capable of tracking and recording the identity, such as the device ID or product ID, of each entity that has obtained access. Further, the user may be given the ability to access the web address prior to receipt of the golf club head 300, such as via an email or secure notification through or on the digital platform 1016. In this way, the code may assist the user in locating the golf club head 300 in the event of loss or theft, or to identify unauthorized access by, e.g., counterfeiters.

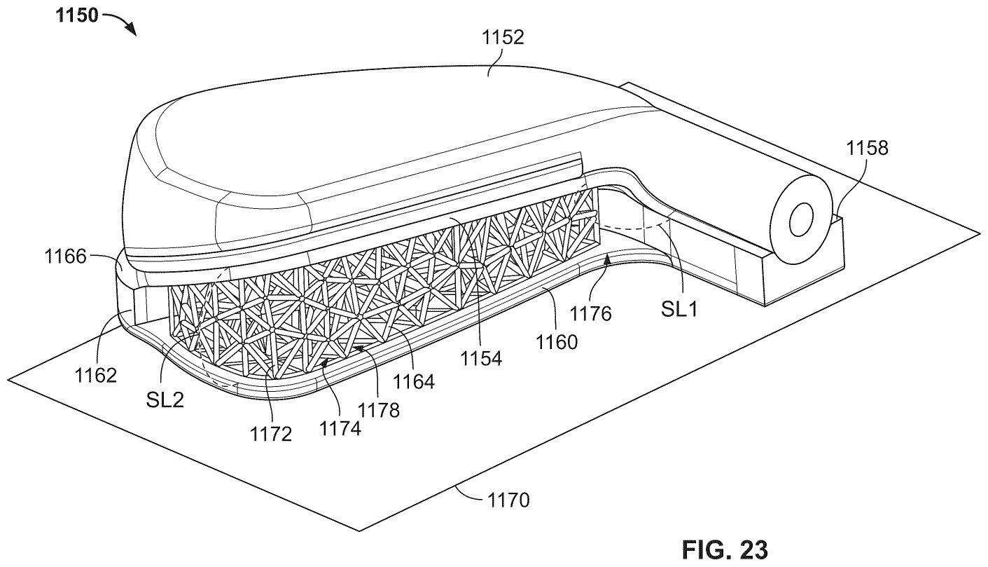

A golf club component may be required to be sintered as a step in an additive manufacturing process. In these embodiments, a support structure or fixture may be required to aid in maintaining orientation and shape of the green part during sintering. Referring to FIG. 23, an embodiment of a tooling component or support structure 1150 is illustrated that may be used to support a golf club component, such as an iron-type golf club head 1152, during sintering. The support structure 1150 was made by additive manufacturing, such as any of the systems or methods described herein. The support structure 1150 includes a face member 1154 and a hosel member 1158, a base member 1160, a sidewall 1162, and a lattice structure or scaffold 1164. The hosel member 1158 may extend from one side of the face member 1154 at a setter lie angle SL1 that corresponds with the desired lie angle of the golf club head 1152. The face member 1154 and hosel member 1158 together form an upper portion 1166 that is supported by the sidewall 1162 and the scaffold 1164 extending from the base member 1160. The face member 1154 extends at a support loft angle SL2 relative to the base member 1160, which corresponds with the desired loft angle of the golf club head 1152. Although the support structure 1150 may be formed using a variety of manufacturing methods, additive manufacturing the support structure 1150 is preferable due to the ability to produce components rapidly and accurately with complex geometry.

In the illustrated embodiment, the base member 1160 is a continuous, planar wall. In some embodiments, the base member 1160 is formed by discrete regions of the scaffold 1164 or the sidewall 1162, or combinations thereof. For example, the base member 1160 may be formed only along the sidewall 1162 or along the scaffold 1164. The base member 1160 rests on a platform 1170 that may be sized and shaped to receive multiple support structures. The platform 1170 may be a removable component, e.g., a tray, that is placed into a sintering furnace (not shown). In some embodiments, the sintering furnace includes a conveyor belt that receives the platform 1170 on which multiple support structures 1150 are arranged.

The support structure 1150 is configured to support the green part, such as the golf club head 1152 in the illustrated embodiment, during sintering. Generally, the sintering process involves the application of heat, which may include varying levels of heat, to the green part for certain time periods, whether intermittently or continuously. It is an object of the support structure 1150 to maintain the desired shape of the green part as heat is applied during sintering, thereby preventing unintended deformation or warping due to the malleability of the heated material. In some embodiments, the support structure 1150 is configured to shrink congruently with the green part. To that end, at least the upper portion 1166 of the support structure 1150 is sized and shaped to have initial dimensions corresponding to the green part and to have final dimensions corresponding to brown part, i.e., the part after the sintering process is completed. In this way, the support structure 1150 is configured to precisely correspond with the desired dimensions and shape of the finished part, which can reduce the need for sacrificial supports and, thus, reduce the amount of post-processing steps required. In some instances, the support structure 1150 and sintering process are designed to accommodate deliberate or predetermined deformation, such as controlled deviations in shrinkage relative to the green part or removal of binders. In some embodiments, the support structure 1150 or portions thereof are configured to be reusable and, thus, are not configured to shrink congruently with the green part during sintering or as the result of exposure to heat.

Further, the scaffold 1164 can be printed via additive manufacturing to include a plurality of ribs 1172 and a plurality of voids 1174 in particular locations, geometries, and arrangements along the support structure 1150 to provide structural support, thermal conductivity, flexure or rigidity, fluid or air flow control, weight distribution, and electrical resistance or conductivity. For instance, due to the arrangement of the scaffold 1164, the support structure 1150 can be configured to reduce or eliminate potential cold spots or temperature sinks that could cause uneven temperature gradients in the green part during sintering. In the illustrated embodiment, the support structure 1150 includes a recess 1176 that is formed between the base member 1160 and the upper portion 1166, such that the support structure 1150 is at least partially hollow. In particular, the recess 1176 is formed beneath the face member 1154 and the scaffold 1164 is disposed within the recess 1176 to structurally support the face member 1154 by connection with the base member 1160. For example, the plurality of ribs 1172 of the scaffold 1164 may be arranged to minimize the surface area along which the connection is made to the face member 1154 to afford the underside of the face member 1154 with exposure to air flow through the plurality of voids 1174 in the recess 1176. As enabled by the additive manufacturing techniques described herein, the scaffold 1164 includes the plurality of voids 1174 such that the mass of the scaffold 1164 occupies a fraction of a total volume of the recess 1176. For example, the scaffold 1164 can be arranged to minimize the amount of material beneath the face member 1154 by arranging the plurality of ribs 1172 and the plurality of voids 1174 to occupy the minimum amount of the total volume of the recess. Accordingly, this permits the face member 1154 to be formed of a substantially uniform thickness, which can result in increased uniformity or consistency of the temperature gradient therealong. In addition, minimizing the amount of material used to form the support structure 1150 also reduces the amount of mass that the sintering furnace is required to heat, thereby reducing the energy needed to operate the sintering furnace. For similar reasons, the scaffold 1164 and recess 1176 of the support structure 1150 are advantageous when cooling the green part during or after the sintering process. Further, the plurality of ribs 1172 and the plurality of voids 1174 of the scaffold 1164 define unit cells 1178 that can vary in size, shape, density, and location.

It is contemplated that the upper portion 1166 of the support structure 1150 may be removable and/or replaceable as a cartridge. For example, the upper portion 1166 may define a particular combination of support loft angle SL2 and support lie angle SL1 for use in manufacturing the golf club head 1152 according to the specifications thereof. Accordingly, the upper portion 1166 may be supported on the base member 1160 via the sidewall 1162 and scaffold 1164 for use in a production cycle. After the production cycle, the upper portion 1166 may be detached from the base member 1160 for recycling or disposal. To that end, the upper portion 1166 may be a cartridge that is removably attached to the base member 1160 using a variety of methods, such as, e.g., fasteners or interlocking surfaces. While the upper portion 1166 forming the cartridge is configured to shrink congruently with the green part during sintering, the base member 1160, scaffold 1164, and sidewall 1162 may not shrink and, thus, may be re-used in several cycles by attaching to different cartridges.

It is further contemplated that the upper portion 1166 may be provided with a coating or plating of material to provide the upper portion 1166 with a predetermined surface roughness, thermal management, hardness, electrical conductivity or resistance, abrasion resistance, or other properties. For example, a ceramic, graphite, tungsten or other material may be applied to the upper portion 1166, or any surface of the support structure 1150. As these materials and coatings can be relatively expensive when compared with metal or metal alloys or composites, cost savings may be realized by reducing the amount, e.g., mass, of such materials used to make the support structure 1150. Further, such materials may only have certain favorable properties, such as abrasion resistance, while other properties, such as density, may be less favorable and, therefore, reducing the amount, e.g., mass, of such materials used to make up the support structure 1150 can also provide performance benefits, including weight savings, thermal management, durability, and the like. Although the foregoing description relates to support structures for a sintering process, it will be appreciated that similar features and methods may be used in connection with molding components, such as, e.g., molds for casting, forging, injection molding, and the like. It is also contemplated that the tooling component, such as the support structure 1150, can include sacrificial portions or binders that are configured to be disposable or destroyed through the production cycle, conduit channels or piping for receiving a flow of cooling or heating media, indicia or markings for identification and organization purposes or for imparting a design upon the production component during production, and embedded particles for authentication purposes, such as ferromagnetic particles indicating a source of the tooling component and/or for exclusive interaction with corresponding anti-counterfeit devices or particles provided on a sintering furnace or the production component.

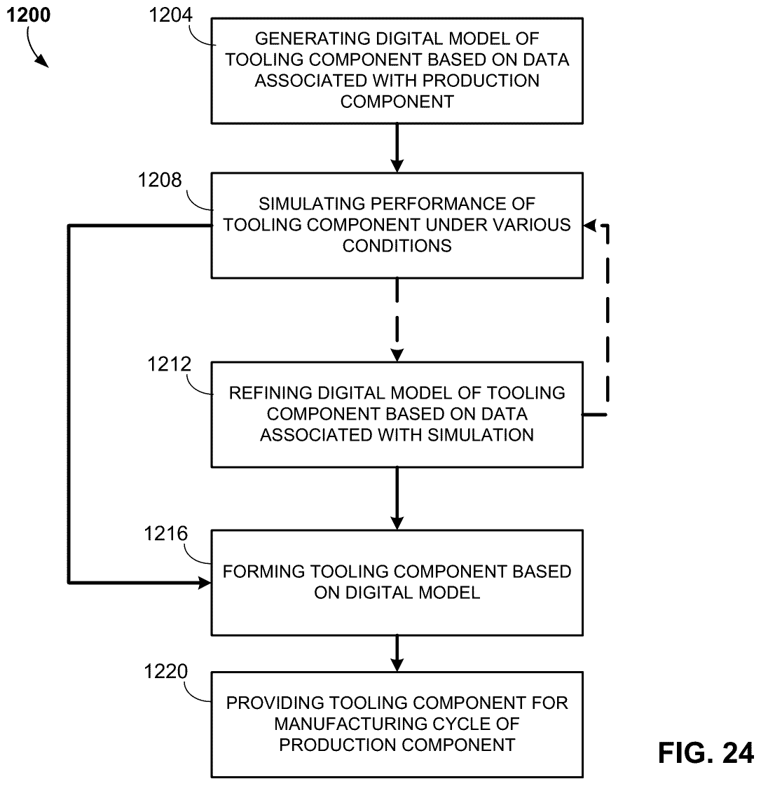

FIG. 24 depicts a flow diagram of an example method 1200 for additively manufacturing a tooling component, such as the support structure 1150 for use in a manufacturing process to form a production component, such as the golf club head 1152. The method 1200 includes fewer or more steps than depicted. Further, the following steps may be performed in any order or sequence and may further include pauses or spans of time in between. The following steps may be performed by a single entity, a single device or system, multiple entities, or multiple devices or systems. In Step 1204, a digital model of a tooling component DMT, or a portion thereof, is generated based on data associated with a production component DMP. As described above, the tooling component may be formed to accommodate certain geometries, angles, shapes, materials, and sizes, as well as to prevent deformation or warping during manufacturing of the production component. Accordingly, the DMT can be generated using any suitable computer-aided design (CAD) software, including software capable of running simulations, e.g., using finite element analysis (FEA). In Step 1208, a simulation is performed to predict how the DMT will behave under various conditions, including mechanical stress, mechanical vibration, fatigue, motion, heat transfer, fluid or air flow, and electrostatics. The simulation may be inclusive of several of the conditions interacting with one another simultaneously, for example, as a test run based on the predicted conditions of the manufacturing cycle. In some instances, the simulation may be performed for each condition in isolation, e.g., to evaluate the heat transfer separately from mechanical stress. Further, the simulation may be performed on discrete or isolated portions of the DMT. Breaking the simulation into discrete or isolated steps, whether by condition isolation or component isolation, may be advantageous in reducing energy consumption and saving time.

In Step 1212, the DMT is refined based on data associated with the simulation data of Step 1208. The data may be inclusive of the DMT behavior with respect to the various conditions, including thermal management data, mechanical stress data, or fluid flow or air flow data. It is also contemplated that a prototype of the DMT may be produced and delivered to a user for feedback as part of Step 1212. After the DMT is refined, another simulation may be performed, as in Step 1208, as part of a trial-and-error process to further improve or fine tune the DMT for certain behaviors. Thus, it is contemplated that Step 1208 and 1212 may be repeated several times until the DMT behaves as desired. In Step 1216, the physical tooling component is formed based on the DMT. That is, the tooling component is manufactured in accordance with the refined, finalized version of the DMT based on the data associated with the production component and the data associated with the simulation test run. The DMT may be received by an additive manufacturing system, such as any of the systems or machines described herein, to manufacture or print the tooling component. In Step 1220, the tooling component is provided for use in a manufacturing cycle with the corresponding production component.

According to some embodiments of the present disclosure, the tooling component may be selected from among an inventory of assorted tooling components. For example, a user may input data associated with the production component, such as, e.g., dimensions, materials, additive manufacturing methods, surface roughness, density, weight, or the like. Such input data can be processed by a computing device, e.g., the provider computer 804 or production computer 806, or a server, e.g., sales server 812 or production server 814, running an inventory management program or industrial automation system to access a database to identify the most suitable tooling component. A variety of filters may be used when accessing the database, such as lead time requirements or production batch quantity or deviations from default templates. For example, the computing device may return a suitability score for tooling components meeting a threshold amount of the input data criteria. In some instance, the input data is divided into weighted averages, such that some aspects of the input data are weighted more heavily than others, when determining the suitability score of the tooling component. It is contemplated that the input data may correspond with particular types of production components, such as golf club heads. For example, the input data may include club head type, club head model or version, club head loft angle, club head lie angle, or any other parameter described above, and the type-specific input data set permits operators to determine whether a suitable tooling component exists in the inventory or if modifications can be made to the tooling component returning the highest suitability score or if a custom tooling component should be manufactured.

Using the systems and methods described herein, users and manufacturers may be offered the ability to customize, select, or adjust particular parameters or variables of a golf club component independently of one another. While typical methods of adjusting or customizing golf club heads are available and widely used, including the removal of material, e.g., grinding or drilling or milling, or deformation of material, e.g., bending or pressing or hammering, these methods often result in the alteration of interrelated parameters. For example, bending a club head to alter a loft angle also relocates the center of gravity and moment of inertia. In another example, adjusting the loft angle of a golf club head causes a corresponding change to the offset and sole bounce. There are a variety of parameters that, if changed, would have a corresponding impact upon the center of gravity in one or more directions, such as, e.g., topline thickness, sole width or camber, club head length or blade length, face thickness, hosel length, face height, loft, and moment of inertia. Further, such conventional adjustment or customization methods often start with a stock or default golf club head. Using the additive manufacturing methods and systems described herein, a golf club head can be produced without being limited to the stock or default golf club head parameters, and further without being limited to the interrelated relationships among the parameters. For example, the golf club head can be additively manufactured to include a particular combination of loft angle, offset, and sole bounce, thereby permitting each parameter to be selected independently of one another. Relatedly, the golf club head can include an internal volume or geometry, such as a lattice structure having a complex geometry, that provides a breadth of weight distribution options for counteracting increases or decreases in material in other regions of the golf club head.

It will be appreciated that the types of additive manufacturing methods described herein have various compatibilities, such that some types of additive manufacturing methods are capable of producing components with characteristics that are more or less compatible with desired outcomes. For example, surface roughness is a characteristic of additive manufacturing techniques which can vary greatly from one type or method to another. Depending on the desired surface roughness, one additive manufacturing method may be preferred over another. For example, a component formed by binder jetting can have an average surface roughness that is about 2 to 2.5 times finer than an average surface roughness of a component formed by DMLS. Some finishing processes require very fine surface roughness values, such as, e.g., conventional hard chrome plating which requires an Ra of about 0.8 μm or finer. Thus, the component formed by binder jetting may require fewer post-processing steps before hard chrome plating than the component made by DMLS. Typical finishing processes include vibrational tumbling, shot blasting, abrasive flow machining, plating, brushing, belt sanding, polishing or electropolishing, and micro machining. The finishing processes can be used in isolation or in combination with one another. For instance, to achieve an average surface roughness of 1 μm or finer, a combination of belt sanding, sand blasting, satin brushing, and Nickel and/or Chrome plating may be used.

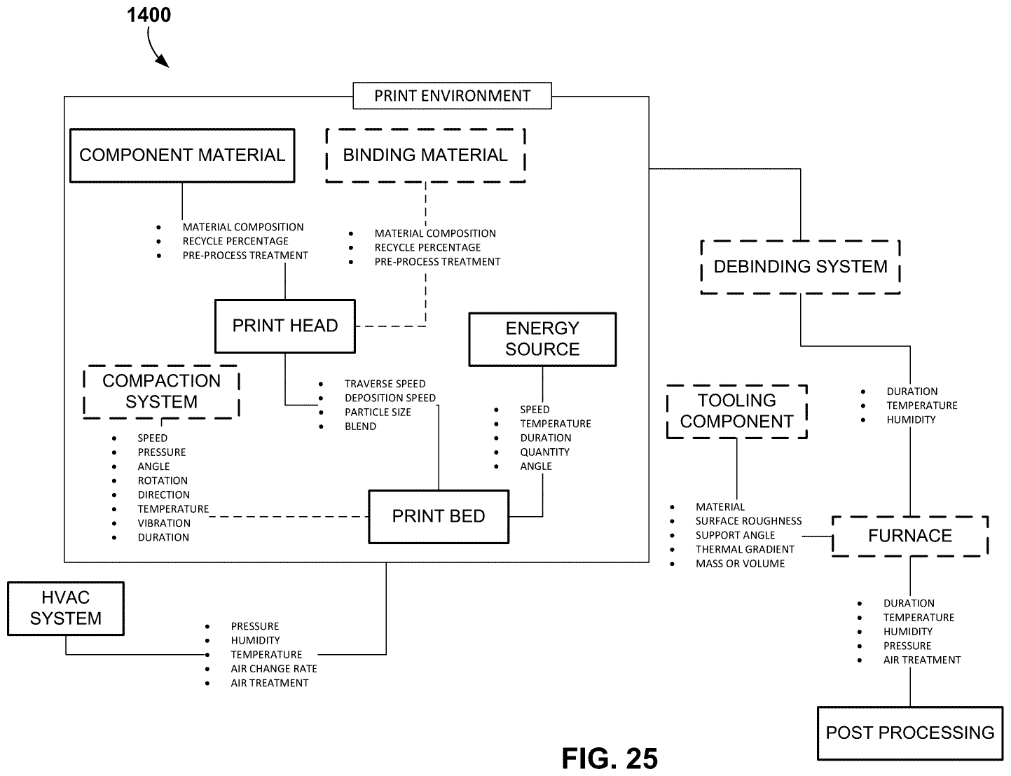

It is also contemplated that some additive manufacturing techniques may be capable of including modifications to produce finer surface roughness measurements, such as an average surface roughness Ra of about 4.5 μm or less. FIG. 25 illustrates a schematic representation of an additive manufacturing system 1400 including various components and parameters suited for modifications. A material composition, mass or volume percentage of recycled material, or pre-process treatment of a component material can be configured or selected to produce the predetermined surface roughness. In some embodiments, multiple component materials may be input to the print head. A material composition, mass or volume percentage of recycled material, or pre-process treatment of a binder material can be configured or selected to produce a predetermined surface roughness. In some embodiments, multiple binding materials are input to a print head. A traverse speed, deposition speed, particle size, or blend of materials, such as, e.g., a ratio of component material to binding material, of the print head can be selected or configured to produce the predetermined surface roughness. In some embodiments, the print head is configured to vary a depth or thickness of the deposited layer, or to vary the blend or material composition in certain regions of the deposited layer. In some embodiments, the system 1400 includes an elongated or extended axis, such as an extended vertical axis, e.g., Z axis, to produce parts of elongated or extended shape. It is contemplated that an increased quantity of such elongated parts can be formed at one time by the system 1400 due to the extended axis.

Still referring to FIG. 25, a speed, pressure, angle of application, rotation direction or speed, direction of application, temperature, vibration rate, or duration of a compaction system may be selected or configured to produce the predetermined surface roughness. A speed, temperature, duration, angle of application, or quantity of an energy source may be selected or configured to produce the predetermined surface roughness. In some embodiments, multiple energy sources are provided. An HVAC system may be configured to achieve or maintain the printing environment at a setpoint for pressure, humidity, temperature, air change rate, or air treatment, such as, e.g., filtering, ionization, or maintaining inert mediums/conditions, to produce the predetermined surface roughness.

With continued reference to FIG. 25, a duration, temperature, or humidity of a debinding system is selected or configured to produce the predetermined surface roughness. In some embodiments, a duration, temperature, pressure, air treatment, or humidity of a furnace may be selected or configured for heat treatment to produce the predetermined surface roughness. For example, inert mediums may be used in the furnace to prevent oxidation, such as Argon (Ar), Helium (He), or Nitrogen (N2) gases, or combinations thereof. In some embodiments, the tooling component can be configured with a material, surface roughness, support angle, thermal gradient, mass, or volume that can be selected or configured for use within the sintering furnace. Further, varying an angle at which the printed, green part is heated or sintered may also influence the surface roughness or finish in select areas thereof. In this way, the printed golf club component can be produced with a surface finish that is aesthetically pleasing, corrosion and weather resistant, aerodynamic, and of a measured roughness capable of being compliant with USGA requirements for impact areas, without the need for additional post-processing or conventional finishing methods, such as sand blasting, brushing, milling, or polishing.

For example, isostatic pressing methods may be used as part of a heat treatment process, in which the sintered part is subjected to high, isostatic pressures in addition to elevated temperatures. Hot isostatic pressing (HIP) can involve pressures of about 200-500 MPa and temperatures of about 1800-200 degrees Celsius; warm isostatic pressing (WIP) can involve pressures of about 300-500 MPa and temperatures of 200-300 degrees Celsius. In some instances, cold isostatic pressing (CIP) is employed on the sintered part at ambient temperatures, without requiring the furnace to heat the component. CIP can involve pressures of about 20 to 400 MPa. The isostatic pressing methods can reduce porosity, increase density, and improve uniformity of the components. Although isostatic pressing typically involves the use of gas as the medium to exert pressure on the component, it is contemplated that a liquid medium may also be used, e.g., oil or water.

In some embodiments, the additive manufacturing systems and methods described herein are part of a decentralized, on-demand-production ecosystem that is accessed by the user and/or manufacturer to fabricate a component, e.g., the golf club components or tooling components. For example, a user may build or customize a golf club component, e.g., a golf club head, using a graphical user interface (GUI), such as the interface 870 of FIG. 19, that is displayed on a computing device, such as the computer 808 of FIG. 18.

After payment and delivery information are received, as in blocks 920 and 922, a production server, such as the server 814, can determine the most suitable additive manufacturing system or machine, or a combination of machines, to fabricate the component as requested. To do so, the production server 814 may consider various inputs and data, including any of the following: proximity of additive manufacturing machine to delivery address, transport and shipping paths, materials required to fabricate component, surface finish of component, quantity of components, production or fabrication time, post-processing steps, availability of materials, availability of additive manufacturing machines, emissions due to shipping, emissions due to production or fabrication, energy consumption due to production or fabrication, energy consumption due to shipping, similarity to inventory, similarity to other orders, or end-use of component (e.g., prototype or finished product). In some instances, the production server 814 may optimize the production cycle to minimize the total emissions generated due to fabrication and shipping. In some instances, the production server 814 may optimize the production cycle to minimize the energy consumption due to fabrication and shipping. In some instances, the production server 814 may optimize the production cycle to achieve the earliest delivery date, which may involve selecting additive manufacturing systems that are relatively farther from the delivery address but have sooner availability to start fabrication and have access to faster shipping paths. In some instances, the production server 814 may utilize the additive manufacturing machine that is closest in proximity to the delivery address, thereby allowing the user to pick-up the finished component to reduce shipping costs.

In some instances, the additive manufacturing system may be carried by a mobile vehicle, such as a truck, that can travel to various locations, such as, e.g., golf courses, retail stores, fitting locations, tournaments, promotional events, and the like. The additive manufacturing systems described herein may be at least partially carried by the mobile vehicle to permit on-demand, walk-up ordering and manufacturing of golf club components as part of the decentralized, on-demand-production ecosystem.

In some instances, the decentralized, on-demand-production ecosystem is operated in connection with a blockchain network, such as the network 1048, to maintain the authenticity of the digital model, to protect intellectual property in the digital model, and to establish a system for generating payments, e.g., royalty payments, between the production systems and the Brand associated with the digital model. For example, the production server 814 may be controlled or operated by the Brand and the digital model may be authenticated by a NFT that is minted on a blockchain network, such as the network 1048. In some embodiments, only authorized additive manufacturing systems are permitted to access the network, such that the production server 814 communicates with a private network of authorized additive manufacturing systems. When the digital model is assigned to an additive manufacturing system on network, a royalty payment is exchanged between the Brand and a third-party operating or controlling the selected additive manufacturing system. Accordingly, the production server 814 may also consider and compare costs associated with each additive manufacturing system when determining which one to select for fabrication of the component.

In some instances, users are able to access an online marketplace in which various digital models are available for purchase or trading, and each of the digital models is authenticated by an NFT. The user may purchase the desired digital model and choose an additive manufacturing system from among an open network for fabrication of the component represented by the digital model. The NFT and underlying smart contract operations can enable the original author, e.g., the Brand, to receive royalty payments from the user and/or the controlling party of the additive manufacturing system, thereby enabling the component represented by the digital model to be produced from among an open network of additive manufacturing systems while the Brand is compensated for the usage thereof. It is further contemplated that the same digital model authenticated by the NFT is capable of being traded or exchanged or sold to another user, thereby triggering royalty payments in compensation to the original author, e.g., the Brand. The online marketplace may further be provided with replaceable lattice structure cartridges, as described above in connection with lattice structure 290 and golf club head 200. In some embodiments, the online marketplace includes specifications associated with particular conditions, such as, e.g., age, height, weight, sex, right-hand or left-hand preference, geographic location. The online marketplace can be used to purchase or trade cartridges among users. The online marketplace may further include a user registered profile with performance data and user data that can be input to an algorithm for recommending cartridges having certain specifications. The algorithm can receive the user data and performance data from the user via the user device 1030, or from smart sensors, e.g., Arccos® sensors, or fitting systems. In this way, the online marketplace may be capable of enabling resale and trading that can allow a greater variety of users, e.g., users with lower budgets or only light customization needs, access to custom or semi-custom golf club heads. It is contemplated that the online marketplace may also be used to purchase or trade club heads, grips, shafts, individual golf clubs, full or partial sets of golf clubs, golf bags, headcovers, or any type of golf equipment.

As part of the production cycle, a recording device, e.g., a camera or webcam, may capture a timelapse or video recording of various stages of the additive manufacturing process. For example, the recording can capture the layer-by-layer build of the green part, the shrinkage of the green part and support structure in the sintering furnace, and any post-processing steps. Then, the recording can be provided to the user along with the finished component. The recording can be provided as a link, e.g., a URL, and delivered to a user via text message, email, push notification, or the like. The recording may be authenticated by a NFT that is minted on a blockchain, e.g., blockchain network 1048. The recording may be separately transferrable from the digital model that represents the finished part, such that recordings may be sold and purchased on an online marketplace.

As described above, the additive manufacturing systems and methods described herein may be used to customize a golf club component, e.g., a golf club head, based on data associated with the user and data associated with the performance of the user, including Fit Data and Body Metrics. The Brand or a fitting professional may analyze the user data and/or performance data to identify trends, strengths, weaknesses, and biases, and to provide recommendations. It will be appreciated that the system 800 of FIG. 18 may be utilized by the Brand to analyze the user data and/or performance data. The performance data may be received from a sensor, e.g., the Arccos® Smart Sensor or profile, and analyzed by a computer, e.g., the provider computer 804 or the production computer 806 or the production server 814, to provide the user with recommended modifications to the golf club head 100 or to recommend different products. For example, if the performance data shows that usage of a 4-iron golf club head tends to result in a draw or a slice, a recommendation may be provided to modify the 4-iron golf club head to vary the lie angle to a more upright position. In some instances, the recommendation may provide the user with the option to purchase a new, customized golf club component that is tailored to the user based on the user data and/or performance data. Accordingly, in instances where the golf club head includes a lattice structure, e.g., the lattice structure 290, the system 800 may employ digital modeling software, such as FEA software, and other CAD modeling programs, to tailor aspects of the lattice structure 290 to achieve desired performance outcomes. For example, the system 800 may provide a menu of options including Maximum Distance, Maximum Forgiveness, Maximum Control, and Minimum Weight, such that the user may select one of the options via a user interface displayed on a smartphone, e.g., 1030, or a computing device, e.g., computer 808. Based on the selected option and the performance data and the user data, the system 800 may operate the FEA software to produce a field data-driven lattice from which the lattice structure 290 can be customized to achieve the desired performance outcome. To that end, the lattice structure 290 can be arranged in repeated geometric configurations or patterns, or in a non-ordered or non-uniform configuration, or with varying beam thickness, or varying unit cell density, shape, size, location, or the like, to achieve the desired performance outcome.

The sintering furnaces can reach temperatures of between 500 and 1600 degrees Celsius. This could cause any ferromagnetic materials to reach their Curie temperature, which would weaken the magnetic behavior or scramble the arrangement. Further, ultra-high temperature electronic tags, like NFC and RFID tags, are rated to withstand temperatures of up to 400 degrees Celsius, but these tags tend to be comparatively expensive. Further, some NFC tags and RFID tags are susceptible to communication interference when placed directly in contact with a metal surface. Thus, there is a need for a integrating a smart tag in a way that can mitigate the negative effects of the process parameters, e.g., temperatures, associated with fabricating a component using additive manufacturing, while also ensuring reliable and accurate communication and operation during use.

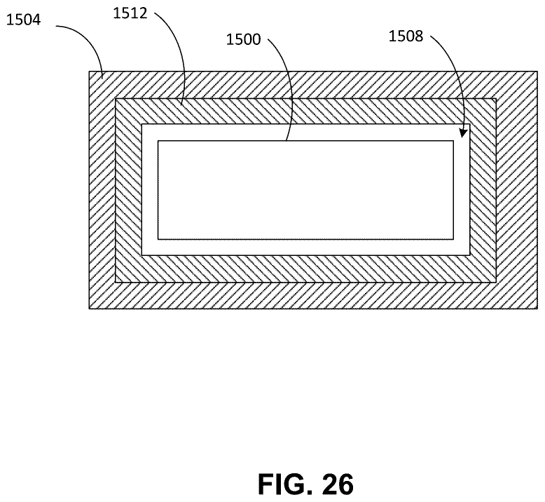

To that end, a smart tag 1500 can be provided within a sheath or housing 1504 that defines an internal cavity 1508 in which an insulation layer 1512 can be disposed, as illustrated in FIG. 26. The smart tag 1500 is configured to be received within the internal cavity 1508 and at least partially surrounded by the insulation layer 1512. The housing 1504 can be formed of metal or a metal alloy, depending on the additive manufacturing process to be used and the construction of the component to be fabricated. The insulation layer 1512 can be another metal or non-metal material that provides thermal, electrical, moisture or moisture vapor, and kinetic insulation for the smart tag 1500 within the housing 1504. In some instances, the insulation layer 1512 includes a ferrite material. In some embodiments, the insulation layer 1512 includes magnesium oxide (MgO). In some embodiments, the insulation layer 1512 includes a ceramic material. In some embodiments, the insulation layer 1512 includes a natural or organic element. In some embodiments, the insulation layer 1512 includes synthetic materials or combinations of synthetic and natural materials. In some embodiments, the insulation layer 1512 is provided as a solid layer of material. In some embodiments, the insulation layer 1512 is provided as a material in liquid state, or gas state, or combinations of solid, liquid, or gas. In some embodiments, there a multiple insulation layers 1512 within the housing 1504. The smart tag 1500 can be attached to the insulation layer 1512 or to the housing 1504 via an adhesive, an interference fit, molding, welding, or fastening. The smart tag 1500, insulation layer 1512, or housing 1504 may be provided with a coating layer (not shown) that further promotes thermal, electrical, moisture or moisture vapor, or kinetic insulation. The housing 1504 can be provided with markings or indicia (not shown), which may include a unique identifier, information pertaining to attachment or integration details, directional arrows to indicate operative or preferred orientations, or the like.

By providing the smart tag 1500 within the insulation layer 1512 in the housing 1504, the smart tag 1500 can be integrated or embedded into an additive manufacturing process and protected from the process parameters or conditions. In some embodiments, the housing 1504 is deposited onto the print bed prior to commencing the additive manufacturing or printing process. In some embodiments, the housing 1504 is installed or inserted within a green part in an unfinished, partially printed state. In this case, the housing 1504 can be placed within a pocket or receptacle formed in the partially printed component and, after being installed, the additive manufacturing process or printing can be resumed. In some embodiments, the housing 1504 is attached to the partially printed part or to the print bed by, e.g., welding or adhesive. In some embodiments, the smart tag 1500 is located within the housing 1504 prior to integrating the housing 1504 into the additive manufacturing process. In some embodiments, the housing 1504 is integrated into the additive manufacturing process prior to receiving the smart tag 1500. In some embodiments, the housing 1504 and/or smart tag 1500 is attached or assembled after sintering but before post-processing steps of the additive manufacturing process.

According to embodiments of the present disclosure, the smart tag 1500 and/or housing 1504 can be removably attached to the golf club component for providing expedited and automatic transfer of specifications to the operator or machine while staying proximate to the golf club component throughout the various stages of the additive manufacturing process. For instance, the smart tag 1500 and/or housing 1504 can be provided as part of a medallion, e.g., the medallion 276A, 276A of the present disclosure, which can be attached to a club head during assembly thereof. In some embodiments, the smart tag 1500 and/or housing 1504 can be provided as part of a panel, e.g., crown 324, or insert, e.g., insert 370, which can be attached to a club head during assembly thereof.

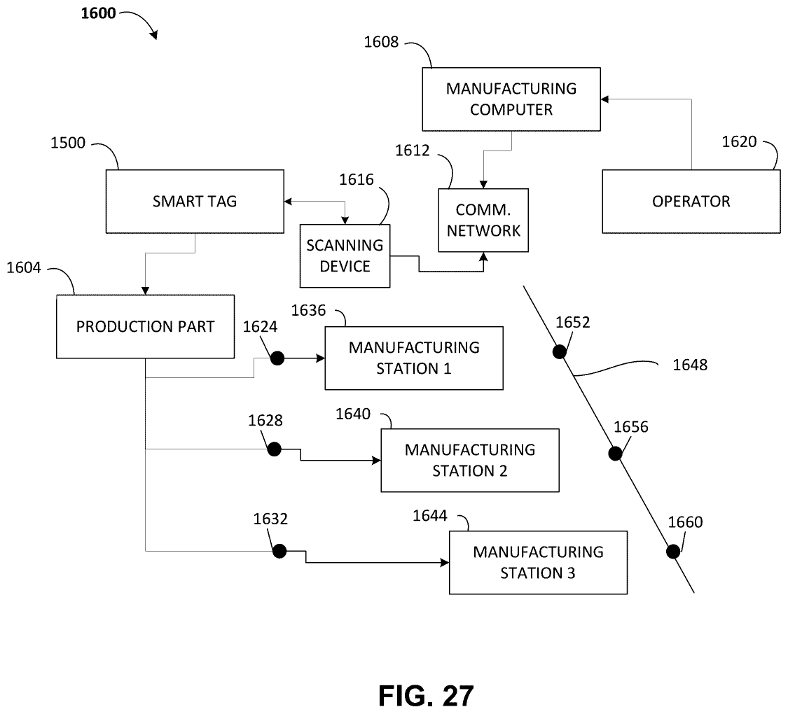

FIG. 27 illustrates a diagrammatic representation of a manufacturing system 1600 including the smart tag 1500 in connection with a production part 1604 and a manufacturing computer 1608 in communication with a communication network 1612. The smart tag 1500 can be integrated into or attached to the production part 1604. In some embodiments, the smart tag 1500 is located within the housing 1504 of FIG. 26. The smart tag 1500 is configured to be detected by and to transmit or exchange data with a reader or scanning device 1616 that communicates with the manufacturing computer 1608 via the communication network 1612. The scanning device 1616 can be a special purpose computer or a device that is hand-held for use by an operator 1620, including a smartphone. In some embodiments, the scanning device 1616 is a fixture of the system 1600 and is located to automatically detect the smart tag 1500 within a detection area (not shown). The scanning device 1616 is configured to detect and relay information from the smart tag 1500 to the manufacturing computer 1608 and, ultimately, to the operator 1620 via an interface (not shown). The interface (not shown) can be a display screen or indictor light for visual communication or a speaker for audible communication.

The smart tag 1500 contains, at least, a unique identifier (UID) and data associated with the production part 1604. The smart tag 1500 can include manufacturing specifications, modifications, customizations, or other information that can be used to perform the manufacturing process. The scanning device 1616 can be provided at various checkpoints or stations within the manufacturing system 1600 to monitor the production part 1604 during the manufacturing process. To that end, the system 1600 includes a plurality of line checkpoints 1624, 1628, 1632 and a plurality of stations 1636, 1640, 1644. The scanning device 1616 can include a plurality of scanning devices, such that a scanning device is provided at each of the line checkpoints 1624, 1628, 1632 or stations 1636, 1640, 1644. In some embodiments, the scanning device 1616 is carried by the operator 1620 and activated to detect the smart tag 1500 at the various line checkpoints 1624, 1628, 1632 or stations 1636, 1640, 1644. In some instances, the scanning device 1616 is used to automatically read specifications or parameters associated with the particular manufacturing process occurring at the stations 1636, 1640, 1644, such that the manufacturing machines or operator 1620 can complete the manufacturing process according to those parameters quickly and accurately. In some instances, the smart tag 1500 can be adapted to follow the production part 1604 through the manufacturing process of the system 1600. In some embodiments, the smart tag 1500 can follow the production part 1604 by travelling along a track 1648 that is arranged adjacent or proximate to each station 1636, 1640, 1644. The track 1648 can be provided as a conveyor belt system that functions as a production queue, which automatically advances the smart tag 1500 and/or housing 1504 to queue checkpoints 1652, 1656, 1660 that are positioned to correspond with the position of the production part 1604 among the stations 1636, 1640, 1644. In some embodiments, each of the queue checkpoints 1652, 1656, 1660 include the scanning device 1616 for detecting the smart tag 1500 to communicate stored information, e.g., manufacturing process specifications or club head specifications, to the manufacturing computer 1608 and/or the operator 1620.

For example, the first station 1636 can include assembling the production part 1604 with other components by operation of several robotic arms (not shown). The scanning device 1616 can detect the smart tag 1500 and convey the information to the manufacturing computer 1608 to compare the unique identifier UID with a database or data in a lookup table stored in memory, such that the manufacturing computer 1608 can identify the correct assembly instructions to provide to the robotic arms at the first station 1636. The second station 1640 can include a furnace or heating element for treating the production part, or assembly. The scanning device 1616 can detect the smart tag 1500 and convey the information to the manufacturing computer 1608 to instruct the operator 1620 or furnace to operate at the proper temperature based on the information associated with the production part. The third station 1644 can be a finishing or polishing station including devices or machines for achieving certain surface finishes. The scanning device 1616 can detect the smart tag 1500 and convey surface finish specifications to the manufacturing computer 1608 to instruct the machines or operator to treat the production part 1604 according to the surface finish specifications for achieving the desired surface finishes. By providing the smart tag 1500 with the production part 1604, the system 1600 is capable of handling batches or groups of different production parts 1604 each having their own smart tag 1500 and differing with respect to one or more specifications. Since batch processing or manufacturing is more efficient than individually crafting each production part, the smart tag 1500 can enable the system 1600 to more quickly and accurately account for modifications or differences among the plurality of production parts 1604 in the batch. Further, the batches of production parts 1604 can be pre-arranged in accordance with select parameters or specifications to optimize the manufacturing process using the system 1600. For instance, the batch may be arranged with production parts 1604 each having the same surface finish requirements, or being associated with the same registered or identified user, or customized with the same personalization indicia.

It is further contemplated that the smart tag 1500 can be used to alert the manufacturing computer 1608 and/or operator 1620 to any interruptions, defects, or deviations from the expected progress of the manufacturing system 1600. For instance, the production part 1604 may include the unique identifier UID thereon that can be scanned or identified by the operator 1620 or scanning device 1616, and that UID may be pre-populated or stored within the corresponding smart tag 1500. The manufacturing computer 1608 can be configured to validate the location of each production part 1604, via the UID, and each corresponding smart tag 1500 so that when the production part 1604 is misplaced or separated from the smart tag 1500, the operator 1620 is alerted to the specific misplaced production part 1604. The UID may be provided on the production part 1604 in the form of a computer-readable code, such as a QR code or barcode or a cipher, or as a serial number of alphanumeric symbols, or emoji symbols, or other symbols, which may be printed or applied using visible ink, such as solvent in, or invisible ink, such as ultraviolet (UV) ink. In some instances, the UID may be represented on the production part 1604 as a M×N matrix of dots, which may be machined into or integrally formed with the production part 1604. The dot matrix may be a square matrix of any suitable size, such as, e.g., 3×3, 4×4, 5×5, 6×6, 7×7, 8×8, 9×9, 10×10, or more. Further, the dot matrix may be another shape, such that M and N are not equal to one another. The dot matrix is sized and shaped to produce a code based on a desired combination of permutations, and each dot is configured to have a binary state, e.g., full or empty. The code of each dot matrix is configured to be unique, such that each code corresponds with a single permutation of the dot matrix and a single production part 1604 (or a finished golf club component). The dots represented as being full may be filled with a coating, paint, or resin material. The dots represented as being empty may be formed as a recess or hole, e.g., a pinhole. The dot matrix and code may become erased or unreadable after surface treatment, such as polishing or sand blasting. In some instances, the dot matrix is concealed or covered during assembly of a golf club head, such as with a medallion, a crown, a face insert, a weight member, or any other component. In some embodiments, the dot matrix is provided on a golf club shaft.

Using the system 1600, the smart tag 1500 can be provided to the user along with an assembled or finished version of the production part 1604. In some embodiments, the smart tag 1500 is configured to be detected by a user device, e.g., the user device 1030, to allow the user to view the information stored thereon. For example, the user device 1030 can detect the smart tag 1500 and access the specifications of the finished version of the production part 1604, e.g., a golf club, prior to making a purchase. The user device 1030 may display the specifications on a graphical user interface (GUI), e.g., the interface 870 of FIG. 19, in a configuration that allows the user to compare aspects of multiple golf clubs each having a dedicated smart tag in a side-by-side fashion. In this way, the user can more easily compare and determine which golf club to purchase in a retail setting. Similarly, a golf club fitting professional or user may scan or read the smart tag 1500 for automatically populating the specifications thereof into a launch monitor or fitting system, as described in U.S. patent application Ser. No. 18/116,157, filed on Mar. 1, 2023, which is incorporated by reference in its entirety herein. It is further contemplated that the smart tag 1500 can be edited or re-written during the manufacturing process, such as by the scanning device 1616 or manufacturing computer 1608. The smart tag 1500 may be populated with a unique identifier (UID) associated with the production part 1604, and the UID can be updated to reflect assembly with other components or to reflect modifications made during the manufacturing process. For instance, smart tag 1500 may be provided on a medallion, e.g., the medallion 276 or 276A, that is capable of being attached to club head for a 4 iron, a 5 iron, or a 6 iron. The smart tag 1500 may be updated during the assembly process so that the UID, among other information, reflects the particular specifications of the club head to which it is ultimately attached. The smart tag 1500 can also store a registration code RC that corresponds with a registered user, such that the smart tag 1500 can include customized specifications for a club head that has been pre-selected and designed with inputs from the registered user.

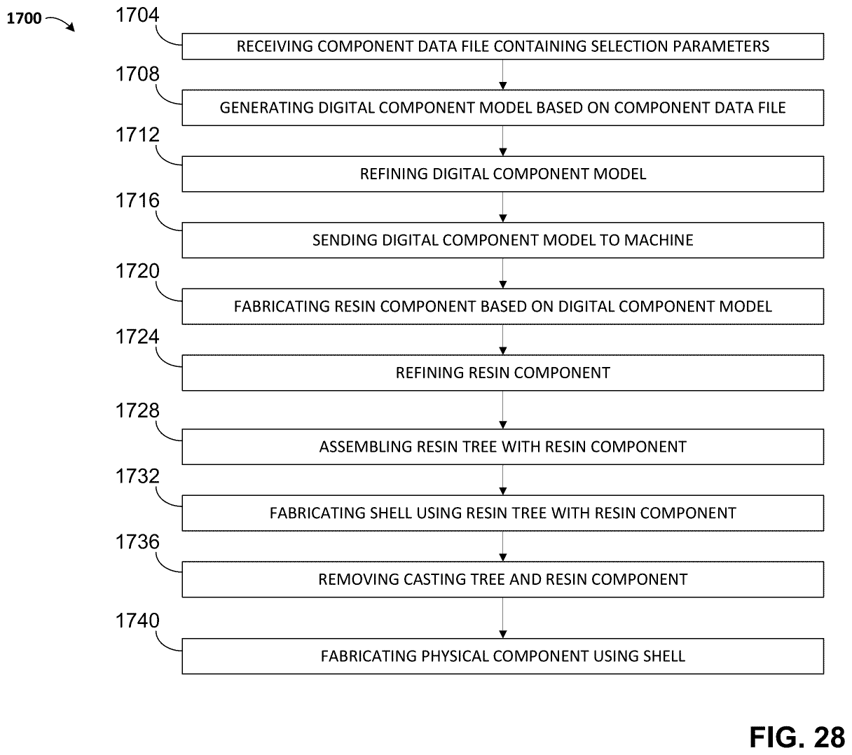

Referring to FIG. 28, an example method 1700 is illustrated for investment casting a golf club component, which includes fewer or more steps than depicted. Further, the following steps may be performed in any order or sequence and may further include pauses or spans of time in between. The following steps may be performed by a single entity, a single device or system, multiple entities, or multiple devices or systems. The method 1700 may be performed using a variety of the additive manufacturing methods and systems described herein to produce any of the components described herein, such as the golf club heads 100, 200, 300, 1152 or portions thereof.

The method 1700 includes a step 1704 of receiving a component data file containing selection parameters. In some embodiments, the component data file is generated using system 800 and interface 870, or the user device 1030 and digital platform 1016. The selection parameters can include any of the following: club type, club shaft type, club shaft length, club shaft stiffness, club shaft material (e.g., steel, graphite, composite, or combinations thereof), club shaft shape (e.g., cylindrical, elliptical or ovular, tapered, single bend, double bend, etc.), club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head center of gravity location, club head moment of inertia value, club head product of inertia values, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto (e.g., number of weight receptacles, arrangement of weight receptacles, size of weight receptacles and corresponding weight members, weight member material, weight member density, etc.), club head weight members, club head finish type (e.g., anodized, painted, plated, physical vapor deposition (PVD), etc.), club head insignia, club head medallion design, club price, number of clubs of the golf club set, and manufacturing information.

The method 1700 includes a step 1708 of generating a digital component model based on the component data file. The digital component model may be a golf club head, such as the golf club head 100, 200, 300, or 1152, or portions thereof. The digital component may further include a golf club head having a lattice structure, such as the golf club head 200 and lattice structure 290. In some embodiments, the component data file is generated by a CAD operator based on the selection parameters. In some embodiments, the selection parameters are compared with a library of stock component data files to identify a closest match, e.g., having a similarity above a pre-determined threshold, and the stock component data file may be paired with the selection parameters for delivery to a CAD operator to complete generation of the component data file, thereby saving time and effort. In some embodiments, the component data file is generated automatically by an algorithm based on the selection parameters. In some embodiments, the selection parameters correspond with one of the stock component data files and no further modifications are needed. The method 1700 includes a step 1712 of refining the digital component model. In some embodiments, the digital component model is analyzed using FEA or other simulation programs to assess the performance. Upon identifying performance weaknesses or deviations from a standard, e.g., USGA Rules, the digital component model can be refined or further modified for improving the performance weaknesses or for compliance with the standard. In some embodiments, the user is notified of the performance weaknesses or non-compliance details, such as via a test message or in-app message or email on the user device 1030. The user can be provided the opportunity to approve or reject the further refinement steps or modifications. In some embodiments, the digital component model is refined without notifying the user, such as for manufacturing purposes, e.g., including chamfers of increased radius to promote material flow for investment casting or adding vents to improve airflow for burnout.

The method 1700 includes a step 1716 of sending the digital component model to an additive manufacturing machine or system. The digital component model can be packaged or output as any suitable file format, such as, e.g., an .stl file or the like. In some embodiments, the digital component model is encrypted and/or authenticated as a digital asset, such as with a non-fungible token minted on a blockchain. In this way, the digital component may be provided to an additive manufacturing system or machine within a decentralized ecosystem or supply chain. The digital component model may be provided with a digital watermark or passcode that prevents unauthorized copying or prevents operation of unauthorized additive manufacturing machines to produce the digital component model.

The method 1700 includes a step 1720 of fabricating a tooling component or resin component based on the digital component model. The resin component can fabricated of any suitable material for additive manufacturing and use in investment casting. In some embodiments, the resin component has liquid-state material properties including a viscosity of about 130 cps at 30 degrees Celsius, a liquid density of about 1.13 grams/cm³ at 25 degrees Celsius, a clear or transparent appearance or color, a critical exposure value of about 12.8 mJ/cm³, and is free of antimony. The step 1720 includes curing the resin component. In some embodiments, the resin component has solid-state, post-cured material properties including a Tensile Strength of between about 47 MPa and about 65 MPa, a Tensile Modulus of between about 2400 MPa and about 2790 MPa, an Elongation at Break of between about 3% and about 11%, a Flexural Strength of between about 97 MPa and about 12 MPa, a Flexural Modulus of between about 2400 MPa and about 2500 MPa, an Notched Izod Impact Strength of between about 11 and 39 J/m, an Ash Content of less than 0.010%, a Hardness of between about 80 and 85 Shore D, a Heat Deflection Temperature at 0.455 MPa of between about 60 degrees Celsius and 65 degrees Celsius, a Heat Deflection Temperature at 1.82 MPa of between about 53 degrees Celsius and about 57 degrees Celsius, a Coefficient of Thermal Expansion of between about 62 μm/m-Celsius and about 166 μm/m-Celsius at respective temperatures ranging from −40 degrees Celsius to 140 degrees Celsius, a Glass Transition temperature of about 61 degrees Celsius, a Solid Density of about 1.19 g/cm³ at 25 degrees Celsius, an Antimony Content of less than 0.1 ppm, and a Water Absorption at Saturation value of between about 0.18% and about 0.38%. It will be appreciated that the Tensile Strength, Tensile Modulus, and Elongation at Break properties were measured according to ASTM D638, or similar. The Flexural Strength and Flexural Modulus properties were measured according to ASTM D790, or similar. The Notched Izod Impact Strength property was measured according to ASTM D256, or similar. The Ash Content properties were measured using Thermogravimetric Analysis (TGA), or similar. The Hardness properties were measured according to ASTM D2240, or similar. The Heat Deflection Temperature properties were measured according to ASTM D648, or similar. The Coefficient of Thermal Expansion properties were measured according to ASTM E831 or ASTM D570, or similar. The Glass Transition temperature properties were measured according to Dynamic Mechanical Analysis (DMA), or similar. The Antimony Content properties were measured according to ASTM 6020B, or similar.

The Water Absorption properties were measured according to ASTM D570-98, or similar. Accordingly, the resin component is configured for reducing or eliminating burnout and ash content, simplified post-processing and cleaning by eliminating the need for solvents and thermal curing, eliminating bubble formation, and improved humidity and moisture resistance. Further, the resin component can be used for investment casting with a variety of metals or metal alloys, such as, e.g., titanium alloy.

The method 1700 includes a step 1724 of refining the resin component. The resin component may be further refined after being cured, which may include cleaning, heat treating, or removing surface defects. In addition, the resin component can be formed with vents for use during the investment casting process of method 1700. The method 1700 includes a step 1728 of assembling a resin tree with the resin component. In some embodiments, the resin tree and resin component are additively manufactured as a unitary structure. In some embodiments, the resin tree and resin component are attached to one another by any suitable method, such as, e.g., fusing, melting, fastening, adhering, or the like. The resin tree and resin component may be formed of different materials. For instance, the resin tree may be formed of a wax material, rather than the resin material of the resin component. The resin tree can include a sprue, a runner, a well, a basin, a gate, and multiple resin components or patterns. The resin tree may also be formed with vents for use during the investment casting process. The method 1700 includes a step 1732 of fabricating a shell using the resin tree and resin component. The shell takes the form of the resin tree and resin component to produce a casting tree. The shell can be formed by a repetitive process of dipping or inserting the resin tree and resin component into a slurry or bath of shell material, which may include a ceramic, metal, or metal alloy material, and applying a powder material, such as, fine sand or stucco. The step 1732 includes curing the shell based on the material properties, configuration, and dimensions of the casting tree.

The method 1700 includes a step 1736 of removing the resin tree and resin component. Further, flash firing and burning steps can be performed to remove portions of the resin component and resin tree. The resin tree and resin component can be removed using an autoclave or a furnace. In some embodiments, the resin tree and resin component are removed using a FlashFire De-Wax System, or a pre-heat furnace, or a burnout furnace, or an induced oxygen chamber oven. Where an autoclave is used, it may be necessary to open or form vents within the shell to expose the resin component, as this can reduce the amount of black smoke that is produced. It will be appreciated that the resin material is preferably recycled and re-used for fabricating further resin components and resin trees. Where a furnace is used to perform burnout operations, it may be necessary to supplement a supply of oxygen into the furnace to ensure there is adequate fuel for combusting the resin tree and resin component within the shell. This may further require supplying oxygen directly toward or into a volume immediately surrounding the shell and, preferably, beneath the shell. This can also be accomplished by placing the shell on a perforated grate or using blocks to create an open volume beneath and around the shell in the furnace. In some embodiments, the burnout operations include multi-temperature cycles during which the furnace or oven heats up to various temperature setpoints, such as a first temperature, e.g., 900 degrees C. and a second temperature, e.g., 1400 degrees C. The furnace may be operated at the first temperature for a first time interval and the second temperature for a second time interval. The first and second time intervals may be different from one another. In some embodiments, the first time interval is about equal to the second time interval. In some embodiments, the first temperature is about equal to the second temperature. The multi-temperature cycle can yield a greater percentage of burnout of the resin, thereby reducing additional steps of removing residual resin after burnout. In addition, the multi-temperature cycle can promote integrity of the shell system by reducing impurities as a result of partially or evenly heating the material. After removing the resin component and resin tree from the shell, it may be necessary to clean the shell by passing water or pressurized air through and over the shell surfaces to remove any residual ash content or resin material. It will be appreciated that any vents formed in the shell for removal of the resin material are patched using foundry mud or a plug, or both.

The method 1700 includes a step 1740 of fabricating a physical component using the shell. The physical component can be fabricated by heating a metal or metal alloy to a high, molten temperature, e.g., above a melting point, of the particular metal or metal alloy that will form the cast component. The shell can be maintained at a shell temperature that is about 400 degrees Celsius to 800 degrees Celsius below the melting point of the metal or metal alloy. At these temperatures, the molten metal or metal alloy can be poured into the shell. The shell and material are allowed to cool down to a predetermined temperature and, subsequently, the shell is destructively removed or knocked off of the cast component. The shell material can be removed by a hammer, a high-pressure water blast or jet, a vibratory table or platform, or the application of chemicals. After the shell is completely removed, the cast components are cut off of the casting tree by a chop saw, a torch, or a laser. Further, the step 1740 can include finishing and assembly steps. For example, the cast component can be finished using various mediums, such as sand blasting, or belt grinding, or hand grinding, or polishing techniques. The cast component can be a component of a golf club, such as the body, which may require assembly with other components, such as a face insert.

The method 1700 can be used to produce custom or semi-custom golf club components. In some embodiments, the resin tree is assembled with multiple resin components that together form an entire golf club head, such as a body, a face insert, a weight insert, a lattice structure, a hosel adapter, and a ferrule. Accordingly, the method 1700 can be used to produce the entire golf club head at one time, thereby avoiding delays and labor associated with combining and assembling multiple components from disparate suppliers or sources. Further, the method 1700 can be used to cast golf club components with different metals or metal alloys, which affords for a variety of customization across golf club heads within a set or within a single order or across multiple models. The method 1700 can be used to mitigate costs associated with additively manufacturing certain metal materials, such as titanium or titanium alloys. In addition, the method 1700 is capable of producing golf club components of metal or metal alloy material with thin walls or segments, e.g., less than 1 mm in thickness, or hollow structures, or complex geometries. Additionally, golf club components fabricated using the method 1700 can be produced with high levels of surface finish as compared with current versions of some additive manufacturing methods, e.g., DMLS. It is contemplated that the systems and methods described herein can be used in combination for producing golf equipment with high levels of customization and modification in a cost effective and expedited fashion.

In some embodiments, any suitable computer readable media can be used for storing instructions for performing the functions and/or processes described herein. For example, in some embodiments, computer readable media can be non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media.

It should be appreciated that certain operations of methods or processes of the present disclosure, or of systems executing those methods or processes, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the present disclosure. Further, in some embodiments, certain operations can be executed substantially simultaneously or in parallel (such as, e.g., by dedicated parallel processing devices or separate computing devices configured to interoperate as part of a large system) to reduce latency and processing times.

In some embodiments, aspects of the present disclosure, including computerized implementations of methods or processes disclosed herein can be implemented as a system, method, apparatus, or article of manufacture using standard programming or engineering techniques to produce software, firmware, hardware, or any combination thereof to control a processor device (e.g., a serial or parallel general purpose or specialized processor chip, a single-or multi-core chip, a microprocessor, a field programmable gate array, or any variety of combinations of a control unit, arithmetic logic unit, and processor register), a computer (e.g., a processor device operatively coupled to a memory), or another electronically operated controller to implement aspects detailed herein. Accordingly, for example, embodiments of the present disclosure can be implemented as a set of instructions, tangibly embodied on a non-transitory computer-readable media, such that a processor device can implement the instructions based upon reading the instructions from the computer-readable media.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

As used herein in the context of computer implementation, unless otherwise specified or limited, the terms “component,” “system,” “module,” “block,” “device,” and the like are intended to encompass part or all of computer-related systems that include hardware, software, a combination of hardware and software, or software in execution. For example, a component may be, but is not limited to being, a processor device, a process being executed by a processor device, an object, an executable, a thread of execution, a computer program, or a computer. By way of illustration, both an application running on a computer and the computer can be a component. One or more components (or system, module, etc.) may reside within a process or thread of execution, may be localized on one computer, may be distributed between two or more computers or other processor devices, or may be included within another component (or system, module, etc.).

Table 1 illustrates the elemental composition of various materials configured for use in manufacturing a golf component according to the present disclosure. In particular, the various materials include Titanium 8-1-1 (Ti 811), Titanium 6-4 (Ti 64), a titanium alloy with niobium and zirconium (Material 1), and two titanium alloys with vanadium and aluminum (Material 2, Material 3). All elemental values in Table 1 are provided as a mass percentage and represent the maximum percentage of each element in each material.

TABLE 1
Elemental Composition of Materials

| | Ti 811 | Ti 64 | Material | Material | Material |
|---|---|---|---|---|---|
| | (Mass | (Mass | 1 (Mass | 2 (Mass | 3 (Mass |
| Element | %) | %) | %) | %) | %) |
| Titanium, Ti | Balance | Balance | Balance | Balance | Balance |
| Molybdenum, | 1.25 | — | — | — | — |
| Mo | | | | | |
| Vanadium, V | 1.25 | 4.50 | — | 3.98 | 4.14 |
| Zirconium, Zr | — | — | 21.46 | 0.27 | 1.66 |
| Niobium, Nb | — | — | 27.12 | — | — |
| Aluminum, | 8.35 | 6.50 | — | 6.79 | 7.20 |
| Al | | | | | |
| Yttrium, Y | — | 0.005 | — | 0.01 | 0.09 |
| Iron, Fe | 0.30 | 0.25 | — | 0.22 | 0.25 |
| Oxygen, O | 0.12 | 0.13 | 0.15 | 0.19 | 0.6 |
| Carbon, C | 0.08 | 0.08 | 0.039 | 0.07 | 0.08 |
| Nitrogen, N | 0.05 | 0.05 | 0.018 | 0.03 | 0.03 |
| Hydrogen, H | 0.015 | 0.012 | 0.0008 | 0.01 | 0.0125 |
| Additional | 0.40 | 0.40 | | | |
| Elements | | | | | |
| (Total) | | | | | |

The elemental composition of the materials of Table 1 and materials according to the present disclosure may be determined through Wavelength Dispersive X-Ray Fluorescence Spectrometry or Direct Current Plasma and Inductively Coupled Plasma Atomic Emission Spectrometry. In one embodiment, the elemental composition values provided in Table 1 are the maximum mean values of each element of each material.

The elemental composition of each material is measured according to at least one of ASTM E2371-13, GB/T-4698.14-2011, GB/T-4698.15-2011, GB/T4-698.7-2011, and GB/T-4701.1-2009.

The mass percentage of carbon in each material is determined in accordance with the testing methods of ASTM E1941-10. The mass percentage of hydrogen in each material is determined in accordance with the testing methods of ASTM E1447-22. The mass percentage of oxygen and nitrogen in each material is determined in accordance with the testing methods of ASTM E1409-13.

In some embodiments, the materials of Table 1 may include an amount of one or more additional elements. Such additional elements are determined in accordance with one or more of ASTM E539-19 and ASTM E2371-21a. In some embodiments, such additional elements include one or more of aluminum, chromium, copper, iron, manganese, molybdenum, nickel, niobium, palladium, ruthenium, silicon, tin, vanadium, yttrium, and zirconium. In some embodiments, the one or more additional elements include one or more of aluminum, boron, cobalt, chromium, copper, iron, manganese, molybdenum, nickel, niobium, palladium, ruthenium, silicon, tantalum, tin, tungsten, vanadium, yttrium, and zirconium.

A material according to the present disclosure comprises the following elemental composition.

TABLE 2

| Element | Material (Mass %) |
|---|---|
| Titanium, Ti | Balance |
| Vanadium, V | 0.0-4.5 |
| Zirconium, Zr | 0.2-22.0 |
| Niobium, Nb | 0.0-28.0 |
| Aluminum, Al | 0.0-8.0 |
| Yttrium, Y | 0.0-0.1 |
| Iron, Fe | 0.0-0.3 |
| Oxygen, O | 0.10-0.60 |
| Carbon, C | 0.03-0.09 |
| Nitrogen, N | 0.01-0.05 |
| Hydrogen, H | 0.0005-0.1300 |

The elemental composition of each material herein is configured to influence the mechanical properties of each material. Tables 3-7 show the mechanical properties of the five materials described in Table 1. All values provided in Tables 3-7 are mean values unless stated otherwise. Standard deviation values, if provided, are denoted with “+”.

TABLE 3
Mechanical Properties of Materials

| | Tensile | Yield | | | | |
|---|---|---|---|---|---|---|
| | Strength | Strength | Young's | | | |
| | (MPa | (0.2%) (MPa | Modulus | Elongation | Density | Hardness |
| Material | Average) | average) | (GPa) | (%) | (g/cm3) | (HV) |
| Ti 811 | 896.0 | 758.0 | 120 | 7 | 4.37 | 349 |
| Ti 64 | 860 | 795 | 113 | 10 | 4.43 | 340 |
| Material 1 | 752.0 ± 6 | 710 ± 4 | 42 ± 1 | 15 ± 1.5 | 5.56 | 320 |
| Material 2 | 1135.0 | 910 | 110 | 11 | 4.45 | 410 |
| Material 3 | 1403.0 | 1124 | 120 | 7 | 4.45 | 540 |

The values provided for Ti 811 in Table 3-7 correspond to cast Ti 811. The values provided for Ti 64, Material 1, Material 2, and Material 3 in Table 3-7 correspond to alloys formed through powder bed fusion.

The mechanical data of Ti 811 in Tables 3-7 corresponds to a Ti 811 material that has an elemental composition as disclosed in Table 1.

The mechanical data of Ti 64 in Tables X-X corresponds to a Ti 64 material that has an elemental composition according to ASTM-F3001-14.

The mechanical data of Material 1 in Tables 3-7 corresponds to a material that has an elemental composition as disclosed in Table 1.

The mechanical data of Material 2 in Tables 3-7 corresponds to a material that has an elemental composition as disclosed in Table 1.

The mechanical data of Material 3 in Tables 3-7 corresponds to a material that has an elemental composition as disclosed in Table 1.

The tensile testing of each material is determined in accordance with ASTM-E8. In some embodiments, the tensile testing encompasses tensile strength, yield strength, elongation, and modulus.

The density of each material is determined in accordance with ASTM-B962 and ASTM-B923. The density values are subject to minor changes within the range of possible chemical compositions.

The hardness of each material is determined in accordance with ASTM-E384.

In some embodiments, the yield strength of a material according to the present disclosure is about 700 MPa to about 1200 MPa. In some embodiments, the yield strength of a material according to the present disclosure is about 700 MPa to about 750 MPa. In some embodiments, the yield strength of a material according to the present disclosure is about 750 MPa to about 800 MPa. In some embodiments, the yield strength of a material according to the present disclosure is about 800 MPa to about 900 MPa. In some embodiments, the yield strength of a material according to the present disclosure is about 900 MPa to about 1000 MPa. In some embodiments, the yield strength of a material according to the present disclosure is about 1000 MPa to about 1100 MPa. In some embodiments, the yield strength of a material according to the present disclosure is about 1100 MPa to about 1200 MPa.

In some embodiments, the Young's modulus of a material according to the present disclosure is about 30 GPa to about 130 GPa. In some embodiments, the Young's modulus of a material according to the present disclosure is about 30 GPa to about 100 GPa. In some embodiments, the Young's modulus of a material according to the present disclosure is about 100 GPa to about 110 GPa. In some embodiments, the Young's modulus of a material according to the present disclosure is about 110 GPa to about 120 GPa.

Determining a ratio between the yield strength (MPa) and the Young's modulus (GPa) of a material according to the present disclosure may provide additional insight into the performance capabilities of that material. A megapascal is 1×10⁶ Pascals (Pa) and a gigapascal is 1×10⁹ Pa. Therefore, the ratios discussed herein will be disclosed as a value multiplied by 10-3.

In some embodiments, the ratio between the yield strength and the Young's modulus of a material according to the present disclosure is about 6×10⁻³ to about 20×10⁻³. In some embodiments, the ratio between the yield strength and the Young's modulus of a material according to the present disclosure is about 6×10⁻³ to about 7×10⁻³. In some embodiments, the ratio between the yield strength and the Young's modulus of a material according to the present disclosure is greater than or equal to about 7×10⁻³. In some embodiments, the ratio between the yield strength and the Young's modulus of a material according to the present disclosure is about 7×10⁻³ to about 20×10⁻³. In some embodiments, the ratio between the yield strength and the Young's modulus of a material according to the present disclosure is greater than or equal to about 7×10⁻³. In some embodiments, the ratio between the yield strength and the Young's modulus of a material according to the present disclosure is about 8×10⁻³ to about 20×10⁻³.

Table 4 shows additional properties of the materials of Table 1.

TABLE 4
Additional Properties of Materials

| | | | | Average | Mean | |
|---|---|---|---|---|---|---|
| | Melting | Particle | | Roughness | Roughness | Component |
| | Point | Size | Particle | Rₐ | Depth R_{z} | Density |
| Material | (° C.) | (μm) | Shape | (μm) | (μm) | (%) |
| Material 1 | 1614 | 25-45-63-100 | Spherical | 6 ± 2 | — | >99.9 |
| Material 2 | 1690-1772 | 10-53 | Spherical | 7 ± 2 | 88 ± 17 | >98.5 |
| Material 3 | 1690-1772 | 50-150 | Spherical | 7 ± 2 | 88 ± 17 | >98.5 |

The roughness of each material is determined in accordance with DIN EN ISO 4288 (Ac=2.4 mm). The roughness values provided for Material 1, Material 2, and Material 3 above correspond to alloys formed through powder bed fusion.

The method of manufacturing and particle size for each material may impact the average and mean roughness of a component formed out of the material. Generally, as particle size becomes larger, the average roughness and mean roughness values of the component will increase.

In some embodiments, the average particle size of a material according to the present invention is about 5 μm to about 150 μm. In some embodiments, the average particle size of a material according to the present invention is about 5 μm to about 50 μm. In some embodiments, the average particle size of a material according to the present invention is about 50 μm to about 100 μm. In some embodiments, the average particle size of a material according to the present invention is about 100 μm to about 150 μm.

In some embodiments, the average particle size of a material according to the present invention is about 5 μm to about 25 μm. In some embodiments, the average particle size of a material according to the present invention is about 15 μm to about 45 μm. In some embodiments, the average particle size of a material according to the present invention is about 15 μm to about 53 μm. In some embodiments, the average particle size of a material according to the present invention is about 15 μm to about 106 μm. In some embodiments, the average particle size of a material according to the present invention is about 45 μm to about 106 μm. In some embodiments, the average particle size of a material according to the present invention is about 45 μm to about 150 μm.

In some embodiments, a component formed out of a material according to the present disclosure may be formed out of one or more of the materials. In some embodiments, the one or more materials used to form the component have different average particle sizes.

Table 5 shows the compressive strength and strain of the materials of Table 1 at 25° C.

TABLE 5
Compressive Strength and Strain of Materials at 25° C.

| | Compressive | Compressive |
|---|---|---|
| Material | Strength Rₘ (MPa) | Strain (%) |
| Material 2 | 1806 ± 12 | 15 ± 3 |
| Material 3 | 2208 ± 25 | 21 ± 2 |

The compressive strength and strain of each material at 25° C. is determined in accordance with ASTM-E9.

Table 6 shows fatigue endurance data of the materials of Table 1 at 25° C. The fatigue and endurance values assume a layer thickness of 30 μm, with 10⁶ fatigue cycles.

TABLE 6
Fatigue Endurance Data of Materials

| | Stress at 10⁷ cycle | Stress at 10⁷ cycle, |
|---|---|---|
| Material | (MPa) | (after HIP) (MPa) |
| Ti 64 | 430 | 600 |
| Material 2 | 620 ± 12 | 850 ± 7 |

Table 7 shows the compressive strength and strain of the materials of Table 1 at 850° C.

TABLE 7
Compressive Strength and Strain of Materials at 850° C.

| | | Compressive | Compressive |
|---|---|---|---|
| | | strength | yield strength |
| Material | Speed | (MPa) | (MPa) |
| Ti 64 | 0.1 | 167 | 133 |
| | 0.01 | 142 | 93 |
| | 0.001 | 55 | 49 |
| Material 2 | 0.1 | 230 ± 11 | 143 ± 7 |
| | 0.01 | 190 ± 2 | 105 ± 4 |
| | 0.001 | 105 ± 4 | 72 ± 3 |
| Material 3 | 0.1 | 381 ± 11 | 191 ± 7 |
| | 0.01 | 216 ± 2 | 129 ± 4 |
| | 0.001 | 127 ± 4 | 83 ± 73 |

The compressive strength and strain of each material at 850° C. is determined in accordance with ASTM-E9. Tested parts were held for 3 minutes at 850° C. before starting hot deformation. All experiments were performed in a high vacuum environment. In some embodiments, the pressure range of a high vacuum environment is between about 10-7 mbar and 10-3 mbar.

Compared to Ti 811, Material 1 has a lower tensile strength, lower yield strength, lower modulus, higher elongation percentage, and lower hardness.

The tensile strength of Material 1 is about 16.07% lower than the tensile strength of Ti 811. The yield strength of Material 1 is about 6.33% lower than the yield strength of Ti 811. The Young's modulus of Material 1 is about 65% lower than the Young's modulus of Ti 811. The elongation percentage of Material 1 is about 114.28% greater than the elongation percentage of Ti 811. The density of Material 1 is about 27.23% greater than the density of Ti 811. The hardness of Material 1 is about 8.30% less than the hardness of Ti 811.

Compared to Ti 64, Material 1 has a lower tensile strength, lower yield strength, lower modulus, higher elongation percentage, higher density, and lower hardness.

The tensile strength of Material 1 is about 12.55% lower than the tensile strength of Ti 64. The yield strength of Material 1 is about 10.69% lower than the yield strength of Ti 64. The Young's modulus of Material 1 is about 62.83% lower than the Young's modulus of Ti 64. The elongation percentage of Material 1 is about 50% greater than the elongation percentage of Ti 64. The density of Material 1 is about 25.50% greater than the density of Ti 64. The hardness of Material 1 is about 5.88% less than the hardness of Ti 64.

Compared to Ti 811, Material 2 has a higher tensile strength, higher yield strength, lower modulus, higher elongation percentage, higher density, and higher hardness.

The tensile strength of Material 2 is about 26.67% higher than the tensile strength of Ti 811. The yield strength of Material 2 is about 20.05% higher than the yield strength of Ti 811. The Young's modulus of Material 2 is about 8.33% lower than the Young's modulus of Ti 811. The elongation percentage of Material 2 is about 57.14% greater than the elongation percentage of Ti 811. The density of Material 2 is about 1.83% greater than the density of Ti 811. The hardness of Material 2 is about 17.47% greater than the hardness of Ti 811.

Compared to Ti 64, Material 2 has a higher tensile strength, higher yield strength, lower modulus, higher elongation percentage, higher density, and higher hardness.

The tensile strength of Material 2 is about 31.96% higher than the tensile strength of Ti 64. The yield strength of Material 2 is about 14.46% higher than the yield strength of Ti 64. The Young's modulus of Material 2 is about 2.65% lower than the Young's modulus of Ti 64. The elongation percentage of Material 2 is about 10% greater than the elongation percentage of Ti 64. The density of Material 2 is about 0.45% greater than the density of Ti 64. The hardness of Material 2 is about 20.58% higher than the hardness of Ti 64.

Compared to Ti 811, Material 3 has a higher tensile strength, higher yield strength, similar modulus, similar elongation percentage, higher density, and higher hardness.

The tensile strength of Material 3 is about 56.58% higher than the tensile strength of Ti 811. The yield strength of Material 3 is about 48.28% higher than the yield strength of Ti 811. The Young's modulus of Material 3 is equal to the Young's modulus of Ti 811. The elongation percentage of Material 3 is equal to the elongation percentage of Ti 811. The density of Material 3 is about 1.83% greater than the density of Ti 811. The hardness of Material 3 is about 56.72% higher than the hardness of Ti 811.

Compared to Ti 64, Material 3 has a higher tensile strength, higher yield strength, higher modulus, lower elongation percentage, higher density, and higher hardness.

The tensile strength of Material 3 is about 63.13% higher than the tensile strength of Ti 64. The yield strength of Material 3 is about 41.38% higher than the yield strength of Ti 64. The Young's modulus of Material 3 is about 6.19% higher than the Young's modulus of Ti 64. The elongation percentage of Material 3 is about 30% lower than the elongation percentage of Ti 64. The density of Material 3 is about 0.45% greater than the density of Ti 64. The hardness of Material 3 is about 58.82% higher than the hardness of Ti 64.

In some embodiments, a material according to the present disclosure has a tensile strength which is about 16.07% less to about 56.58% greater than the tensile strength of Ti 811. In some embodiments, a material according to the present disclosure has a yield strength which is about 6.33% less to about 48.28% greater than the yield strength of Ti 811. In some embodiments, a material according to the present disclosure has a Young's modulus which is about 65% less to about equivalent to the Young's modulus of Ti 811. In some embodiments, a material according to the present disclosure has an elongation percentage which is about 114.28% greater to about equivalent to the elongation percentage of Ti 811. In some embodiments, a material according to the present disclosure has a density which is about 1.83% to about 27.23% greater than the density of Ti 811. In some embodiments, a material according to the present invention has a hardness value which is about 8.3% less to about 54.72% greater than the hardness value of Ti 811.

In some embodiments, a material according to the present disclosure has a tensile strength which is about 12.55% less to about 63.13% greater than the tensile strength of Ti 64. In some embodiments, a material according to the present disclosure has a yield strength which is about 10.69% less to about 41.38% greater than the yield strength of Ti 64. In some embodiments, a material according to the present disclosure has a Young's modulus which is about 62.83 less to about 6.19% greater than the Young's modulus of Ti 64. In some embodiments, a material according to the present disclosure has an elongation percentage which is about 30% less to about 50% greater than the elongation percentage of Ti 64. In some embodiments, a material according to the present disclosure has a density which is about 25.50% to about 0.45% greater than the density of Ti 64. In some embodiments, a material according to the present disclosure has a hardness value which is about 5.88% less to about 58.82% greater than the hardness value of Ti 64.

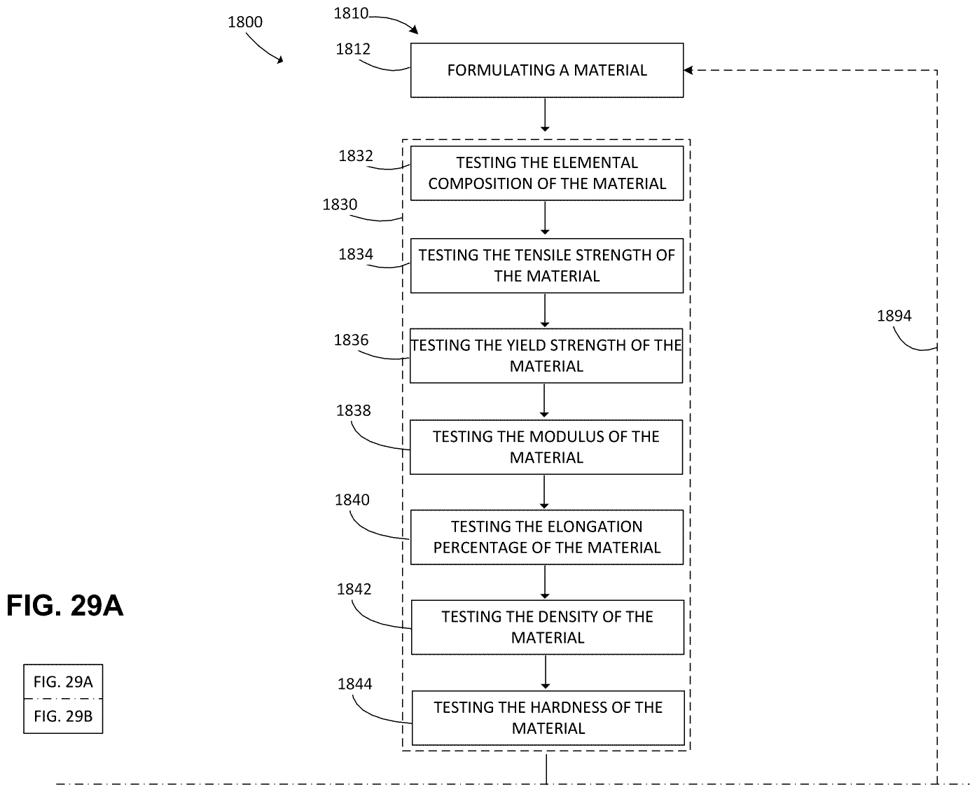

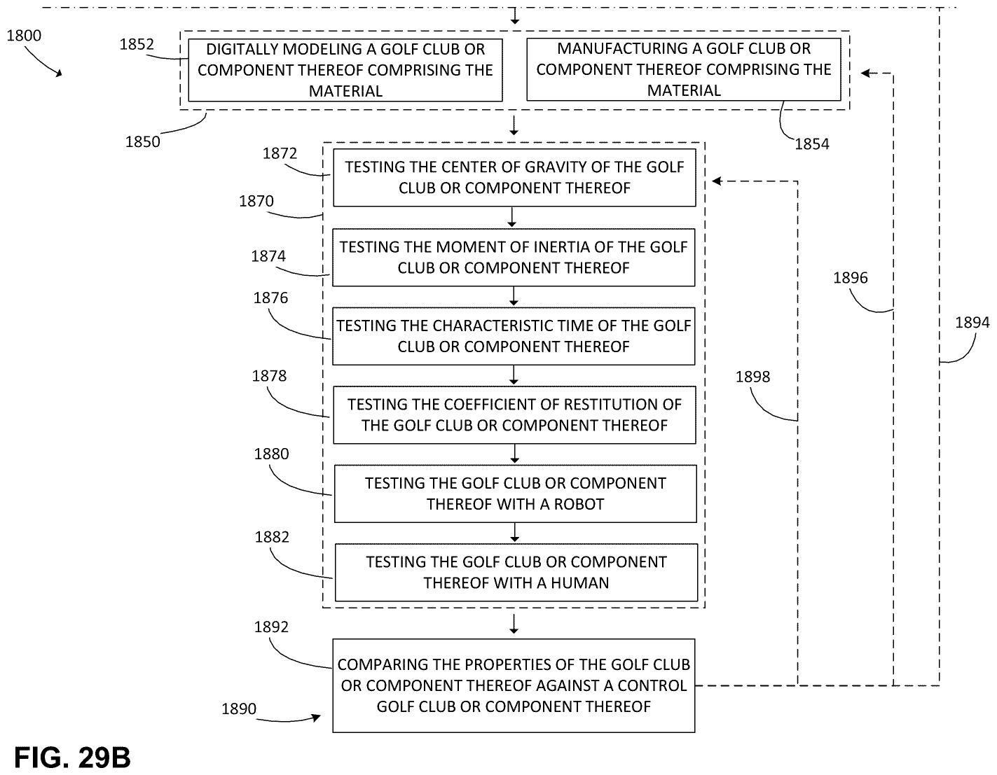

FIGS. 29A and 29B illustrate a method 1800 for analyzing a golf club that includes a component made of a material according to the present disclosure. While the method 1800 is described below with reference to various steps, it is appreciated that not all steps may be required. Further, the steps of FIGS. 29A and 29B may not be carried out in the order presented below and some steps may be performed simultaneously or may be omitted.

Method 1800 can include five phases, a material formulation phase 1810, a material testing phase 1830, a modeling phase 1850, a testing phase 1870, and an analysis phase 1890. In the material formulation phase 1810, a material according to the present disclosure is formulated. In the material testing phase 1830, the properties of the material are tested. In the modeling phase 1850, a golf club or component thereof that comprises a material according to the present disclosure is manufactured or digitally modeled. In some embodiments, the manufactured or modeled golf club or component thereof can include a physical test sample, a portion of a component, or a detailed replica of a finished component. In the testing phase 1870, the properties of the golf club or component thereof from the modeling phase are evaluated by a variety of tests or simulations. In the analysis phase 1890, the golf club or component thereof and its corresponding data are compared against a control golf club or a component thereof.

Method 1800 may begin at the material formulation phase 1810 with a step 1812. At step 1812 a material according to the present disclosure is formulated. In some embodiments, the material is an alloy. In some embodiments, the alloy is a titanium alloy containing niobium and zirconium. In some embodiments, the alloy may be manufactured according to the methods disclosed herein. In some embodiments, the alloy may be digitally modeled according to the methods disclosed.

After the material formulation phase 1810, the material testing phase 1830 may begin at a step 1832. In some embodiments, the properties tested during phase 1830 are chemical properties. In some embodiments, the properties tested during phase 1830 are physical properties. In some embodiments, the tests include elemental composition, tensile strength, yield strength, modulus, elongation, density, hardness, melting point, particle size, particle shape, roughness, average roughness, mean roughness, component density, compressive strength, compressive strain, fatigue, and endurance, as disclosed herein. In some embodiments, the tests are collected on a physical sample of the material according to the present disclosure. In some embodiments, the tests are collected on a digitally simulated material according to the present disclosure.

At step 1832, the elemental composition of the formulated material is tested. In some embodiments, the elemental composition of the formulated material is tested according to at least one of ASTM E2371-13, GB/T-4698.14-2011, GB/T-4698.15-2011, GB/T4-698.7-2011, and GB/T-4701.1-2009.

At step 1834, the tensile strength of the formulated material is tested. In some embodiments, the tensile strength of the formulated material is tested according to ASTM-E8.

At step 1836, the yield strength of the formulated material is tested. In some embodiments, the yield strength of the formulated material is tested according to ASTM-E8.

At step 1838, the modulus of the formulated material is tested. In some embodiments, the modulus of the formulated material is tested according to ASTM-E8.

At step 1840, the elongation of the formulated material is tested. In some embodiments, the elongation of the formulated material is tested according to ASTM-E8.

At step 1842, the density of the formulated material is tested. In some embodiments, the density of the formulated material is tested according to ASTM-B962 and ASTM-B923.

At step 1844, the hardness of the formulated material is tested. In some embodiments, the hardness of the formulated material is tested according to ASTM-E384.

The list of tests provided in phase 1830 and discussed herein are non-exhaustive and can be performed in any order. Additionally, not all of the tests described herein need to be performed. In some embodiments, method 1800 may proceed from phase 1810 to phase 1850 without the acquisition of any material testing data.

The modeling phase 1850 may begin after the material testing phase 1830. Phase 1850 may include steps 1852 and 1854. At step 1852, a golf club or component thereof comprising the material of step 1812 is manufactured. In some embodiments, the component includes one or more of a golf club head, a golf club shaft, a golf club grip, or one or more sub-components thereof. Various manufacturing processes, such as those described herein, can be used to manufacture the golf club of step 1852. At step 1854, a golf club or component thereof comprising the material of step 1812 is digitally modeled. In some embodiments, the component includes one or more of a golf club head, a golf club shaft, a golf club grip, or one or more sub-components thereof. Various digital modeling processes, such as those described herein, can be used to model the golf club of step 1854. As part of method 1800, step 1852 and step 1854 can be performed together or in the alternative. All of the steps following steps 1852 and 1854 can be either physically or digitally measured.

In some embodiments, the golf club of phase 1850 includes a golf club head comprising a material according to the present disclosure. In some embodiments the golf club of phase 1850 includes a golf club head with a face member or face insert that comprises a material according to the present disclosure. In some embodiments the golf club of phase 1850 includes a golf club shaft or component thereof comprising a material according to the present disclosure. In some embodiments the golf club of phase 1850 includes a golf club grip or component thereof comprising a material according to the present disclosure.

After the golf club of phase 1850 is manufactured, modeled, or both, its properties may be evaluated by one or more tests in phase 1870. These tests can include a center of gravity test (“CG”), moment of inertia test (“MOI”), characteristic time test (“CT”), and coefficient of restitution test (“COR”). Additional tests which evaluate golf ball hit data can be performed to gather information on ball backspin, speed, carry, curve, descent or landing angle, flight time, launch angle, offline, peak height, roll distance, shot dispersion, side carry, side angle, side spin or spin axis, total distance, and total spin can also be recorded by robot and human testing of the golf club. In some embodiments, the tests of phase 1870 are run on a manufactured golf club or component thereof. In some embodiments, the tests of phase 1870 are simulated for a digitally modeled golf club or component thereof.

The list of tests provided in phase 1870 and discussed herein are non-exhaustive and can be performed in any order. Additionally, not all of the tests described herein need to be performed. In some embodiments, method 1800 may proceed from phase 1850 to phase 1890 without the acquisition of any golf club or component testing data.

At step 1872, the CG data for the golf club of method 1800 is collected. CG data can be collected using a balance point, balance beam, or other balance measuring device. A golf club can include a vertical center of gravity, a horizontal center of gravity, and a depth center of gravity. The determination of and location of each center of gravity on a golf club's can impact its performance characteristics, as discussed herein. In some embodiments, the CG of the golf club or component thereof can be collected through digital modeling or CAD.

At step 1874, the MOI data for the golf club of method 1800 is collected. MOI data can be collected according to the United States Golf Association Procedure for Measuring the Moment of Inertia of Colf Clubheads, Revision 2.0. In some embodiments, the MOI of the golf club or component thereof can be collected through digital modeling or CAD.

At step 1876, the CT data for the golf club of method 1800 is collected. CT data can be collected according to the United States Golf Association Protocol for Measuring the Flexibility of a Golf Clubhead, Revision 2.0. In some embodiments, the CT of the golf club or component thereof can be collected through digital modeling or CAD.

At step 1878, the COR data for the golf club of method 1800 is collected. COR data can be collected according to the United States Golf Association Procedure for Measuring the Coefficient of Restitution of a Clubhead Relative to a Baseline Plate, Revision 2.0. In some embodiments, the COR of the golf club or component thereof can be collected through digital modeling or CAD.

At step 1880, robotic swing and hit data for the golf club of method 1800 is collected. Robotic swing instruments or machines use an arm or other element to retain and repeatedly swing a golf club or component thereof in a controlled manner. These instruments are often used in a controlled environment where cameras, sensors, or other monitoring devices can record and collect data on each element of a golf club swing or golf ball hit. In some embodiments, the monitoring devices are incorporated into the robotic swing instrument. In other embodiments, the monitoring devices are placed in the environment of the robotic swing instrument. In some embodiments, the monitoring devices are placed in the environment of the robotic swing instrument and are also present in or on the robotic swing instrument. In some embodiments, the conditions of the environment can be controlled. In some embodiments, the controllable conditions of the environment are weather conditions such as wind, rain, humidity, temperature, and barometric pressure.

Robotic testing of golf clubs allows for each individual element of a golf club swing or golf ball hit to be adjusted and recorded. As such, robotic testing provides an advantage over human testing because humans are generally unable to precisely vary individual elements of a swing or hit while keeping the other elements constant. The golf club swing elements which can be adjusted and recorded by a robotic swing instrument include lie, address loft, angle of attack, closure rate, club acceleration profile, club head speed, club path, club speed profile, dynamic lie, dynamic loft, efficiency, face angle relative to target, face center loft, face difference, face to path, grip roll, grip speed, horizontal swing plane, impact location, lie difference, loft difference, low point, path deflection, path deflection droop, path deflection ratio, ratio to grip, shaft kick, shaft lean address, shaft lean difference, shaft lean impact, spin loft, static lie, static loft, swing direction, swing plane, torque, and vertical swing plane. The golf ball hit elements which can be adjusted and recorded by a robotic swing instrument include ball backspin, speed, carry, curve, descent or landing angle, flight time, launch angle, offline, peak height, roll distance, shot dispersion, side carry, side angle, side spin or spin axis, total distance, and total spin.

At step 1882, human swing and hit data for the golf club of method 1800 or a component thereof is collected. Human testing can include one or more human subjects swinging the golf club of method 1800 or hitting one or more golf balls with the golf club of method 1800 in a controlled environment. In the controlled environment, cameras, sensors, or other monitoring devices can record and collect data on each element of the golf club swing or golf ball hit. In some embodiments, the monitoring devices are attached to the human subject or the golf club. In other embodiments, the monitoring devices are placed in the environment of the human subject. In some embodiments, the monitoring devices are placed in the environment of the human subject and are also attached to the human subject or the golf club. In some embodiments, the conditions of the environment can be controlled. In some embodiments, the controllable conditions of the environment are weather conditions such as wind, rain, humidity, temperature, and barometric pressure.

Human testing of golf clubs is advantageous because it can provide insight into the overall feel of the golf club swing and golf ball hit experiences. This holistic data is often difficult to analyze with a robotic swing instrument, and therefore a combination of human and robotic testing can provide a more comprehensive data set for the golf club of method 1800. The golf club swing elements which can be recorded during a human test include lie, address loft, angle of attack, closure rate, club acceleration profile, club head speed, club path, club speed profile, dynamic lie, dynamic loft, efficiency, face angle relative to target, face center loft, face difference, face to path, grip roll, grip speed, horizontal swing plane, impact location, lie difference, loft difference, low point, path deflection, path deflection droop, path deflection ratio, ratio to grip, shaft kick, shaft lean address, shaft lean difference, shaft lean impact, spin loft, static lie, static loft, swing direction, swing plane, torque, and vertical swing plane. The golf ball hit elements which can be recorded during a human test include ball backspin, speed, carry, curve, descent or landing angle, flight time, launch angle, offline, peak height, roll distance, shot dispersion, side carry, side angle, side spin or spin axis, total distance, and total spin.

The analysis phase 1890 may begin after the testing phase 1870 at a step 1892. At step 1892, the golf club of method 1800 is compared against one or more control golf clubs or the components thereof. In some embodiments, the control golf club is one or more golf clubs available to the public. In some embodiments, the control golf club is one or more golf clubs available on the market.

In some embodiments, if the results of phase 1890 are not desirable, method 1800 can return to phase 1810 by connector 1894 and a new material can be formulated and tested to determine if it exhibits desirable properties. In some embodiments, if the results of phase 1890 are not desirable, method 1800 can return to phase 1850 by connector 1896 and a new golf club or component thereof can be manufactured or digitally modeled and tested to be re-compared against the control club. In embodiments where the golf club or component thereof of method 1800 was digitally modeled and tested through simulations, returning to phase 1850 allows for the modeled club to be physically manufactured and tested according to the testing phase 1870. In embodiments where the golf club was physically manufactured, returning to phase 1850 allows the golf club to be redesigned or remodeled and tested according to the testing phase 1870. In some embodiments, if there is insufficient data to compare the golf club of method 1800 with a control golf club or component thereof, method 1800 can return to the testing phase 1870 by connector 1898. After returning to testing phase 1870, additional data can be collected, or preexisting data can be recollected to support a reevaluation of the golf clubs or components thereof at phase 1890.

Although the present disclosure has been described and illustrated in the foregoing illustrative embodiments, it is understood that the present disclosure has been made only by way of example, and that numerous changes in the details of implementation of the present disclosure can be made without departing from the spirit and scope of the present disclosure, which is limited only by the claims that follow. Features of the disclosed embodiments can be combined and rearranged in various ways.

### INDUSTRIAL APPLICABILITY

Numerous modifications to the present disclosure will be apparent to those skilled in the art in view of the foregoing description. Accordingly, this description is to be construed as illustrative only and is presented for the purpose of enabling those skilled in the art to make and use the same. The exclusive rights to all modifications which come within the scope of the appended claims are reserved.

What is claimed is:

1. A method for producing a golf club component, comprising:
generating a design model of the golf club component;
providing the design model of the golf club component to an additive manufacturing system;
providing a first powdered material; and
fabricating, via the additive manufacturing system, the golf club component with the first powdered material, wherein the first powdered material is a titanium alloy,
wherein the titanium alloy comprises zirconium.

2. The method of claim 1, wherein the additive manufacturing system is selected from the group consisting of, computer numerical control machining, fused filament fabrication, direct metal laser sintering, atomic diffusion additive manufacturing, cold spray additive manufacturing, metal injection molding, binder jetting, multi jet fusion, powder bed fusion, material extrusion, directed energy deposition, sheet lamination, selective laser melting, electron beam melting, sintering, and combinations thereof.

3. The method of claim 1, wherein the additive manufacturing system is selected from the group consisting of direct metal laser sintering, binder jetting, and metal injection molding.

4. The method of claim 1, wherein the additive manufacturing system is direct metal laser sintering.

5. The method of claim 1, wherein the first material is a titanium alloy further comprising aluminum and vanadium.

6. The method of claim 1, wherein the first material is a titanium alloy further comprising niobium.

7. The method of claim 1, wherein the first material is a titanium alloy comprising:
about 0.0% to about 4.5% by weight of the composition vanadium;
about 0.2% to about 22.0% by weight of the composition zirconium;
about 0.0% to about 28.0% by weight of the composition niobium;
about 0.0% to about 8.0% by weight of the composition aluminum; and
titanium.

8. The method of claim 1, wherein the first material is a titanium alloy comprising:
about 20.0% to about 23.0% by weight of the composition zirconium;
about 25.0% to about 29.0% by weight of the composition niobium; and
titanium.

9. The method of claim 1, wherein the golf club component is selected from the group consisting of a club head, a face member, a face insert, a body, a weight member, a medallion, a fastener, a ferrule, a hosel, a hosel adapter, a crown plate, a sole plate, a shaft, a grip, one or more portions of the foregoing, and combinations thereof.

10. The method of claim 1, wherein the golf club component is a golf club head.

11. The method of claim 1, wherein the golf club component is a face insert.

12. A golf club component, comprising a first material, wherein the first material is a titanium alloy comprising titanium, zirconium, and one or more additional elements selected from the group consisting of molybdenum, vanadium, niobium, aluminum, and combinations thereof.

13. The golf club component of claim 12, wherein the titanium alloy further comprises aluminum and vanadium.

14. The golf club component of claim 12, wherein the titanium alloy further comprises niobium.

15. The golf club component of claim 12, wherein the titanium alloy comprises:
about 0.0% to about 4.5% by weight of the composition vanadium;
about 0.2% to about 22.0% by weight of the composition zirconium;
about 0.0% to about 28.0% by weight of the composition niobium;
about 0.0% to about 8.0% by weight of the composition aluminum; and
titanium.

16. The golf club component of claim 12, wherein the titanium alloy comprises:
about 20.0% to about 23.0% by weight of the composition zirconium;
about 25.0% to about 29.0% by weight of the composition niobium; and
titanium.

17. The golf club component of claim 12, wherein the first material has a Young's modulus which is about 65% lower than the Young's modulus of a titanium 811 alloy.

18. The golf club component of claim 12, wherein the golf club component is selected from the group consisting of a club head, a face member, a face insert, a body, a weight member, a medallion, a fastener, a ferrule, a hosel, a hosel adapter, a crown plate, a sole plate, a shaft, a grip, one or more portions of the foregoing, and combinations thereof.

19. The golf club component of claim 12, wherein the golf club component is a golf club head.

20. The golf club component of claim 12, wherein the golf club component is a face insert.
